(19) United States
(12) Patent Application Publication
(10) Pub. No.: US 2022/0092519 A1
(43) Pub. Date: Mar. 24, 2022

(54) DELIVERY MANAGEMENT SYSTEM WITH INTEGRATED WORKER MANAGEMENT AND SCHEDULING

(71) Applicant: GetSwift, Inc., New York, NY (US)

(72) Inventors: Bane Hunter, New York, NY (US); Joel Macdonald, New York, NY (US); Robert Bardunias, Whitefish Bay, WI (US)

(21) Appl. No.: 17/482,030

(22) Filed: Sep. 22, 2021

Related U.S. Application Data
(60) Provisional application No. 63/082,258, filed on Sep. 23, 2020.
(60) Provisional application No. 63/118,364, filed on Nov. 25, 2020.
(60) Provisional application No. 63/131,064, filed on Dec. 28, 2020.
(60) Provisional application No. 63/216,830, filed on Jun. 30, 2021.

(51) Int. Cl. G06Q 10/06; G06Q 10/10; G06Q 40/00; G06Q 30/02; G06F 9/54; G06N 3/08; G06F 3/0484; G06F 3/0482; G08B 5/22

(52) U.S. Cl. CPC G06Q 10/063116; G06Q 10/105; G06Q 10/103; G06Q 10/063112; G06Q 40/125; G06Q 50/28; G06F 9/541; G06N 3/084; G06F 3/0484; G06F 3/0482; G08B 5/22; G06Q 30/0201

(57) ABSTRACT

A method including receiving a digital schedule associated with an entity, the digital schedule including one or more shifts, each of the one or more shifts including at least one opening having an assigned individual with a specific role, retrieving context information associated with a location of the entity, executing a machine learning model using the context information to generate a predicted demand associated with the entity during a time period corresponding to the one or more shifts, updating the digital schedule based on the predicted demand, monitoring completion of the at least one shift to measure an actual demand associated with the entity, and updating the machine learning model based on the actual demand.

### CROSS-REFERENCE TO RELATED PATENT APPLICATIONS

The present application claims the benefit of and priority to (i) U.S. Provisional Application No. 63/216,830 filed on Jun. 30, 2021, (ii) U.S. Provisional Application No. 63/131,064 filed on Dec. 28, 2020, (iii) U.S. Provisional Application No. 63/118,364 filed on Nov. 25, 2020, and (iv) U.S. Provisional Application No. 63/082,258 filed on Sep. 23, 2020, the entire disclosures of each of which are incorporated by reference herein.

### BACKGROUND

Current delivery management approaches typically employ an incongruent arrangement of delivery request, communications, scheduling, driver and vehicle dispatching, route planning, regulatory compliance, delivery tracking, accounting, payment, performance monitoring, and business analysis systems and networks. Existing computer implemented methods for management of logistics and delivery of items to the final delivery destination typically lack integration, transparency, responsiveness to users, and scalability. Even with automation of some steps in the process, presently available delivery management systems are often limited by the capacity of human dispatchers to concurrently receive delivery tasks, determine delivery platform capabilities and availability across a range of platform fleets, select routes, document regulatory compliance, monitor delivery progress, record and analyze delivery performance, and process delivery related transactions using multiple platforms. It is therefore desirable to have a delivery management system that integrates delivery management functions into a single platform that provides near real-time cross correlation of delivery management data and automatically optimizes a delivery solution.

### SUMMARY

One implementation of the present disclosure is a method of generating a schedule for a company including obtaining profile data for one or more workers associated with the company, wherein the profile data includes attributes indicating a skill set of the one or more workers; receiving a first user input from a first user defining one or more positions within the company; assigning at least one position to each of the one or more workers, wherein the at least one position is determined for the at least one of the one or more workers based on the attributes of the one or more workers; receiving a second user input from the first user defining one or more availability periods; assigning at least one of the one or more availability periods to each of the one or more workers; automatically generating the schedule for the company based on the profile data, the at least one assigned position, and the availability period of the one or more workers.

In some embodiments, the attributes for each of the one or more workers include at least one of an employee identifier, contact information, a meal break length, a compensation type, a skill set, previously approved tasks, and previously approved positions for a worker.

In some embodiments, at least one of the one or more positions is a delivery driver, and wherein at least one of the one or more workers is assigned as the delivery driver.

In some embodiments, the method further includes presenting, via a user interface of a user device, a graphical representation of the schedule.

In some embodiments, the method further includes transmitting the schedule to a mobile device of the second user, thereby causing the mobile device to present the schedule via an application executed by the mobile device.

In some embodiments, the third user input is received via the application executed by the second user's mobile device.

In some embodiments, each of the one or more positions includes a position title, a description, and one or more additional attributes of the position.

In some embodiments, each of the one or more availability periods includes a start time, an end time, and a day of the week.

In some embodiments, the method further includes receiving a third user input from a second user indicating a change to at least one of the profile data or an availability period for a worker.

In some embodiments, automatically generating the schedule for the company is further based on a vehicle capacity associated with each of the one or more workers.

Another implementation of the present disclosure is a method for a delivery management system including obtaining a plurality of driver profiles, wherein each driver profile indicates at least one capability of a corresponding driver and an availability of the corresponding driver; generating, based on the plurality of driver profiles, a schedule assigning each of the drivers to a time period; receiving a first delivery task from a first customer of a first merchant, wherein the first delivery task defines a set of delivery task requirements; determining an availability status of each driver in the plurality of drivers based on the schedule; determining a plurality of available drivers in the plurality of drivers; identifying at least one driver from the plurality of available drivers whose driver profile satisfies the set of delivery task requirements; allocating the first delivery task to a first driver from the plurality of available deliverers based on either a first input from a user or an output of a delivery management engine; receive an acceptance of the first delivery task from the first driver; monitor an execution of the first delivery task; and generate a delivery management report providing an assessment of at least one of the delivery task or the first driver.

In some embodiments, obtaining a merchant profile for the first merchant defining one or more attributes including a merchant location and a delivery boundary area.

In some embodiments, the plurality of driver profiles further indicate, for each driver, a means of transportation, a deliverer boundary area, a job match code, a deliverer rating, and a deliverer declaration identifier.

In some embodiments, the deliverer declaration identifier includes a health status declaration for a human functioning as a driver.

In some embodiments, the set of delivery task requirements include a delivery address, and wherein the profile data of the first delivery driver includes at least one attribute that corresponds to the delivery address.

In some embodiments, the set of delivery task attributes includes a quantification of a deliverable and a delivery location.

In some embodiments, the method further includes receiving a plurality of additional delivery tasks from a second merchant, wherein the plurality of additional delivery tasks includes a group of preplanned deliveries for execution within a time period and generating one or more scheduled delivery routes for execution of the plurality of delivery tasks by one or more drivers.

In some embodiments, a first user associated with the merchant reviews a delivery route prior to execution of the delivery task by the first driver, wherein the delivery route is a predetermined route including a primary route and an alternate route.

Yet another implementation of the present disclosure is a deliverer declaration system including a computing system including a network interface coupled to a processing circuit, the network interface structured to facilitate data communication with a user device via a network, the processing circuit including a processor coupled to a memory storing instructions that, when executed by the processor, cause the processing circuit to perform operations including assigning a user to at least one fleet; dynamically generating a declaration based on the at least one fleet; transmitting, to the user device, the declaration, wherein the declaration includes a plurality of questions; receiving, from the user device, a plurality of responses to the plurality of questions; storing the plurality of responses to the plurality of questions in a database; and determining, based on the plurality of responses to the plurality of questions, that the user is allowed to begin working.

In some embodiments, the operations further include receiving, from the user device, an indication of a type of vehicle the user will be using and transmitting, to the user device, the declaration, wherein at least one of the plurality of questions is based on the type of vehicle the user will be using.

In some embodiments, the indication of the type of vehicle the user will be using can be a selection from a drop box including car, walker, subway, bicycle, and ridesharing company.

In some embodiments, at least one of the plurality of questions is a yes or no question.

In some embodiments, wherein at least one of the plurality of questions requires a numerical input.

In some embodiments, the operations further include receiving, from the user device, the numerical input and determining that the numerical input is within a predetermined range.

In some embodiments, an organization locks and enables at least one question of the plurality of questions, the operations further including prohibiting a fleet manager from editing or deleting the at least one question.

In some embodiments, an organization locks and enables at least one question of the plurality of questions, causing the processing circuit to perform operations including enabling a fleet manager to add the at least one question.

In some embodiments, the operations further include receiving, from an organization or a fleet, a frequency at which the declaration must be completed.

In some embodiments, the received plurality of responses to the plurality of questions are received from a second user device of a dispatcher.

Yet another implementation of the present disclosure is a method of acquiring a declaration of a user. The method includes assigning the user to at least one fleet; dynamically generating the declaration based on the at least one fleet; transmitting, to a user device, the declaration, wherein the declaration includes a plurality of questions; receiving, from the user device, a plurality of responses to the plurality of questions; storing the plurality of responses to the plurality of questions in a database; and determining, based on the plurality of responses to the plurality of questions, that the user is allowed to begin working.

In some embodiments, the method further includes receiving, from the user device, an indication of a type of vehicle the user will be using and transmitting, to the user device, the declaration, wherein at least one of the plurality of questions is based on the type of vehicle the user will be using.

In some embodiments, the indication of the type of vehicle the user will be using can be a selection from a drop box including car, walker, subway, bicycle, and ridesharing company.

In some embodiments, at least one of the plurality of questions is a yes or no question.

In some embodiments, at least one of the questions is a question that requires a numerical input.

In some embodiments, the method further includes receiving, from the user device, the numerical input and determining that the numerical input is within a predetermined range.

In some embodiments, an organization locks and enables at least one question of the plurality of questions, the method further including prohibiting a fleet manager from editing or deleting the at least one question.

In some embodiments, an organization locks and enables at least one question of the plurality of questions, the method further including enabling a fleet manager to add the at least one question.

In some embodiments, the method further includes receiving, from an organization or a fleet, a frequency at which the declaration must be completed.

In some embodiments, the received plurality of responses to the plurality of questions are received from a second user device of a dispatcher.

Yet another implementation of the present disclosure is a deliverer declaration system including a computing system including a network interface coupled to a processing circuit, the network interface structured to facilitate data communication with a user device via a network, the processing circuit including a processor coupled to a memory storing instructions that, when executed by the processor, cause the processing circuit to perform operations including assigning a user to at least one fleet; dynamically generating a declaration based on the at least one fleet; transmitting, to the user device, the declaration, wherein the declaration includes a question; receiving, from the user device, a response to the question; storing the response to the question in a database; and determining, based on the response to the question, that the user is allowed to begin working.

In some embodiments, the operations further include receiving, from the user device, an indication of a type of vehicle the user will be using and transmitting, to the user device, the declaration, wherein the question is based on the type of vehicle the user will be using.

In some embodiments, the indication of the type of vehicle the user will be using can be a selection from a drop box including car, walker, subway, bicycle, and ridesharing company.

In some embodiments, the question is a yes or no question.

In some embodiments, the question requires a numerical input.

In some embodiments, the operations further include receiving, from the user device, the numerical input and determining that the numerical input is within a predetermined range.

In some embodiments, an organization locks and enables the question, the operations further including prohibiting a fleet manager from editing or deleting the question.

In some embodiments, an organization locks and enables the question, the operations further including enabling a fleet manager to add the question.

In some embodiments, the operations further include receiving, from an organization or a fleet, a frequency at which the declaration must be completed.

In some embodiments, the received response to the question is received from a second user device of a dispatcher.

Yet another implementation of the present disclosure is a method of acquiring a declaration of a user including assigning the user to at least one fleet; dynamically generating the declaration based on the at least one fleet; transmitting, to a user device, the declaration, wherein the declaration includes a question; receiving, from the user device, a response to the question; storing the response to the question in a database; and determining, based on the response to the question, that the user is allowed to begin working.

In some embodiments, the method further includes receiving, from the user device, an indication of a type of vehicle the user will be using and transmitting, to the user device, the declaration, wherein the question is based on the type of vehicle the user will be using.

In some embodiments, the indication of the type of vehicle the user will be using can be a selection from a drop box including car, walker, subway, bicycle, and ridesharing company.

In some embodiments, the question is a yes or no question.

In some embodiments, the question requires a numerical input.

In some embodiments, the method further includes receiving, from the user device, the numerical input and determining that the numerical input is within a predetermined range.

In some embodiments, an organization locks and enables the question, the method further including prohibiting a fleet manager from editing or deleting the question.

In some embodiments, an organization locks and enables the question, the method further including enabling a fleet manager to add the question.

In some embodiments, the method further includes receiving, from an organization or a fleet, a frequency at which the declaration must be completed.

In some embodiments, the received response to the question is received from a second user device of a dispatcher.

One implementation of the present disclosure includes one or more non-transitory computer-readable storage media having instructions stored thereon that, when executed by one or more processors, cause the one or more processors to generate, in response to a user input, a first data structure representing a digital schedule comprising a plurality of elements, each of the plurality of elements including (i) an element assignment and (ii) an element description, receive, from a user computing device, a selection of an element of the plurality of elements, the selection including a user identifier, retrieve, based on the user identifier, a second data structure digitally representing a user associated with the user identifier, the second data structure including a skillset associated with the user, parse the skillset to determine whether a threshold number of requirements associated with the element description of the selected element are met, and in response to the threshold number of requirements being met, automatically update the element assignment of the selected element of the first data structure to include the user identifier.

In some embodiments, parsing the skillset includes comparing a skill of the skillset to each requirement of the number of requirements. In some embodiments, updating the element of the first data structure includes embedding a link to the second data structure in the selected element of the first data structure. In some embodiments, updating the element of the first data structure includes generating a digital flag associated with the selected element of the first data structure, the digital flag indicating that the selected element is pending approval. In some embodiments, the threshold number of requirements includes a first subset of mandatory requirements and a second subset of optional requirements, and wherein determining whether the threshold number of requirements are met includes satisfying the first subset of mandatory requirements. In some embodiments, the element description includes a position type, a start time, an end time, and a date for the first shift. In some embodiments, the instructions further cause the one or more processors to transmit to the user computing device, in response to automatically updating the element assignment, a subset of the first data structure associated with the selected element. In some embodiments, transmitting the subset of the first data structure includes transmitting at least one of a text message, an email, or a push notification. In some embodiments, the element description includes a link to a third data structure storing one or more requirements associated with a shift type of the selected element, and wherein the instructions further cause the one or more processors to retrieve the one or more requirements. In some embodiments, the instructions further cause the one or more processors to detect a change in the one or more requirements associated with the shift type of the selected element based on monitoring the third data structure and in response to detecting the change, transmit a notification to the user computing device.

Another implementation relates to one or more non-transitory computer-readable storage media having instructions stored thereon that, when executed by one or more processors, cause the one or more processors to receive one or more delivery parameters describing characteristics associated with a task type, wherein the one or more delivery parameters include at least one key parameter, receive task information for a specific task of the task type, wherein the task information includes a location, execute a machine learning model specific to the at least one key parameter using the task information to generate a delivery assignment for the specific task, the delivery assignment including an identifier identifying an individual, monitor completion of the specific task by the individual, wherein monitoring completion of the specific task includes monitoring the at least one key parameter, and update the machine learning model based on monitoring the at least one key parameter.

In some embodiments, updating the machine learning model includes executing an A/B test to analyze the delivery assignment, wherein executing the A/B test includes monitoring the at least one key parameter associated with a second specific task, comparing the at least one key parameter associated with the second specific task to the at least one key parameter associated with specific task to select a preferred delivery assignment, and updating the machine learning model using the preferred delivery assignment. In some embodiments, the instructions further cause the one or more processors to receive, from at least one of (i) a vibration sensor associated with the individual or (ii) a timer function associated with the specific task, a measurement associated with completion of the specific task by the individual and assign a value to at least one of the at least one key parameter based on the measurement. In some embodiments, generating the delivery assignment includes retrieving a plurality of deliverer characteristics associated with a plurality of deliverers, weighting one or more of the plurality of deliverer characteristics based on the one or more delivery parameters to generate a deliverer description, generating a plurality of scores based on the deliverer description associated with each of the plurality of deliverers, and selecting the identifier based on the plurality of scores. In some embodiments, receiving the task information for the specific task includes retrieving information associated with the location from a third party application programming interface (API), and updating the task information based on the information retrieved from the third party API. In some embodiments, the plurality of deliverer characteristics include at least one of (i) a vehicle type associated with a deliverer, (ii) a delivery history of the deliverer, (iii) a compensation rate of the deliverer, (iv) an availability of the deliverer, or (v) a skill-set of the deliverer.

Another implementation relates to one or more non-transitory computer-readable storage media having instructions stored thereon that, when executed by one or more processors, cause the one or more processors to receive a digital schedule, the digital schedule including one or more shifts, each of the one or more shifts including at least one opening, execute a machine learning model using the digital schedule to generate demand characteristics associated with the digital schedule, the demand characteristics including (i) a number of drivers and (ii) driver characteristics associated with the number of drivers, parse a database including a plurality of digital representations of drivers to identify a selection of drivers having the driver characteristics associated with the number of drivers, automatically assign the selection of drivers to the one or more shifts of the digital schedule according to the demand characteristics generated by the machine learning model, monitor completion of at least one shift of the one or more shifts to measure a key delivery parameter associated with each delivery within the at least one shift, and update the machine learning model based on monitoring the at least one key delivery parameter.

In some embodiments updating the machine learning model includes executing an A/B test to analyze the demand characteristics, wherein executing the A/B test includes monitoring a key delivery parameter associated with completion of at least one other shift of a second digital schedule that is different than the first digital schedule, comparing the key delivery parameter associated with completion of the at least one other shift of the second digital schedule to the key delivery parameter associated with each delivery to select one or more preferred demand characteristics from the demand characteristics, and updating the machine learning model using the one or more preferred demand characteristics.

Another implementation relates to one or more non-transitory computer-readable storage media having instructions stored thereon that, when executed by one or more processors, cause the one or more processors to receive a digital task assignment including a user identifier and an indication of one or more required declarations associated with the task assignment, wherein the digital task assignment is locked by a digital flag, generate and transmit a digital declaration based on the indication to a user device associated with the user identifier, wherein the digital declaration includes one or more conditions, receive a modified digital declaration from the user device, perform semantic extraction on the digital declaration to validate a user response to the one or more conditions, and in response to validating the user response to the one or more conditions, update the digital task assignment by modifying the digital flag to unlock the digital task assignment.

In some embodiments, validating the user response to the one or more conditions includes receiving, from one or more sensors deployed in a vicinity of the user device, a sensor measurement, and comparing the sensor measurement to a value associated with the one or more conditions to verify compliance with the one or more conditions. In some embodiments, performing semantic extraction on the digital declaration to validate the user response includes parsing the digital declaration to identify a digital signature associated with the one or more conditions and writing to a database to record the digital signature associated with the one or more conditions. In some embodiments, transmitting the digital declaration to the user device includes causing the user device to display a graphical user interface (GUI) configured to display the one or more conditions and receive a user input associated with each of the one or more conditions. In some embodiments, the instructions further cause the one or more processors to update one or more other digital task assignments associated with the user identifier and the one or more declarations to unlock the one or more other digital task assignments in response to modifying the digital flag to unlock the digital task assignment.

Another implementation relates to one or more non-transitory computer-readable storage media having instructions stored thereon that, when executed by one or more processors, cause the one or more processors to receive a digital schedule associated with an entity, the digital schedule including one or more shifts, each of the one or more shifts including at least one opening having an assigned individual with a specific role, retrieve, from one or more application programming interfaces (API), context information associated with a location of the entity, execute a machine learning model using the context information to generate a predicted demand associated with the entity during a time period corresponding to the one or more shifts, update the digital schedule based on the predicted demand, wherein updating the digital schedule includes (i) adding or deleting an opening associated with at least one shift of the one or more shifts and (ii) modifying the assigned individual associated with the opening based on (i) the specific role and (ii) a skill-set of an individual associated with the modification, monitor completion of the at least one shift to measure an actual demand associated with the entity, and update the machine learning model based on the actual demand.

In some embodiments, updating the machine learning model includes executing an A/B test to analyze the predicted demand generated by the machine learning model, wherein executing the A/B test includes monitoring actual demand associated with a second predicted demand associated with a different time period corresponding to a different one or more shifts, comparing (i) a first difference between (a) the actual demand corresponding to the different one or more shifts and (b) the second predicted demand to (ii) a second difference between (a) the actual demand corresponding to the completion of the at least one shift and (b) the predicted demand associated with the time period to select a preferred predicted demand, and updating the machine learning model using the preferred predicted demand. In some embodiments, the digital schedule further includes one or more open shifts, each of the one or more open shifts including at least one opening that is unassigned. In some embodiments, updating the digital schedule includes assigning an available individual to the at least one opening that is unassigned according to a specific role associated with the at least one opening this is unassigned and a skill-set of the available individual. In some embodiments, monitoring completion of the at least one shift includes detecting additional workers added to the at least one shift by a user. In some embodiments, modifying the assigned individual associated with the opening includes generating an employee score for the individual associated with the modification based on weighting parameters of the skill-set using characteristics of the specific role, comparing the employee score for the individual associated with the modification to a plurality of employee scores associated with other employees, and selecting the individual associated with the modification for the opening based on the comparison. In some embodiments, the instructions further cause the one or more processors to train the machine learning model using historical context information associated with the entity, the historical context information including point-of-sale (POS) data from the entity. In some embodiments, the predicted demand includes a number of worker-hours associated with each of the one or more shifts and a role of a plurality of roles. In some embodiments, the context information includes at least one of (i) transportation data, (ii) weather data, or (iii) point-of-sale (POS) data from a third party. In some embodiments, updating the machine learning model includes performing backpropagation on a neural network.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a delivery management system, according to some embodiments.

FIG. 2 is a flow diagram of a process for allocating and executing a delivery task, according to some embodiments.

FIG. 3 is an example interface for the delivery management system of FIG. 1, according to some embodiments.

FIG. 4 is an example organizational structure for the delivery management system of FIG. 1, according to some embodiments.

FIG. 5 is an example interface for creating work groups, according to some embodiments.

FIGS. 6-8 are example interfaces for assigning drivers to fleets, according to some embodiments.

FIGS. 9-11 are example interfaces for displaying and modifying worker profiles, according to some embodiments.

FIG. 12 is an example interface for selecting delivery management system functions, according to some embodiments.

FIGS. 13 and 14 are example interfaces for modifying worker attributes, according to some embodiments.

FIG. 15 is an example interface for assigning merchants to a fleet, according to some embodiments.

FIGS. 16 and 17 are example interfaces for visualization of enterprise level implementation of delivery management system route optimization functions, according to some embodiments.

FIG. 18 is a flow diagram of a process for integrated scheduling and delivery management, according to some embodiments.

FIG. 19 is an example interface for a scheduling management tool, according to some embodiments.

FIGS. 20 and 21 are example interfaces for viewing and creating positions, according to some embodiments.

FIG. 22 is an example spreadsheet for managing workers, according to some embodiments.

FIG. 23 is an example interface for a viewing and modifying worker attributes, according to some embodiments.

FIG. 24 is an example interface for viewing and creating availability periods, according to some embodiments.

FIG. 25 is an example interface for assigning predefined availability periods to workers, according to some embodiments.

FIG. 26 is an example interface for manually assigning shifts, according to some embodiments.

FIG. 27 is an example interface for viewing and modifying a schedule, according to some embodiments.

FIGS. 28-31 are example interfaces for a mobile scheduling management application, according to some embodiments.

FIG. 32 is a flow diagram of a process for acquiring a declaration of a user, according to some embodiments.

FIGS. 33-34 are example interfaces for generating questions for a declaration, according to some embodiments.

FIGS. 35-36 are example interfaces for configuring questions of a declaration, according to some embodiments.

FIG. 37 is an example interface for entering responses to questions of a declaration, according to some embodiments.

FIG. 38 is an example interface for tracking a delivery, according to some embodiments.

FIGS. 39 and 40 are example interfaces for generating open shifts, according to some embodiments.

FIGS. 41-46 are example interfaces for viewing and organizing open shifts, according to some embodiments.

FIGS. 47-50B are example interfaces for requesting open shifts, according to some embodiments.

FIGS. 51 and 52 are example interfaces for managing shift requests, according to some embodiments.

FIG. 53 is an example interfaces for establishing acceptance deadlines for open shifts, according to some embodiments.

FIGS. 54 and 55 are example interfaces for generating open shift notifications, according to some embodiments.

FIG. 56 is a flowchart illustrating a method of generating a delivery assignment, according to some embodiments.

FIG. 57 is a flowchart illustrating a method of assigning drivers to one or more shifts, according to some embodiments.

FIG. 58 is a flowchart illustrating a method of generating a digital declaration and unlocking a digital task assignment, according to some embodiments.

FIG. 59 is a flowchart illustrating a method of generating a digital schedule, according to some embodiments.

FIG. 60 is a flowchart illustrating another method of generating a digital schedule, according to some embodiments.

### DETAILED DESCRIPTION

### Overview

The present disclosure relates generally to an integrated delivery and scheduling system. In some embodiments, such a system is implemented as a cloud-based, software-as-a-service (SaaS) delivery management system that integrates delivery and logistic channel management according to the examples provided. In various embodiments, systems and methods of the present disclosure facilitate merging disparate data sources (e.g., data structures, etc.) to generate an integrated data structure such as a digital schedule and/or deriving new information based on the integrated data structure. For example, systems and methods of the present disclosure may ingest a first data structure representing a number of individuals and characteristics associated with each individual, a second data structure representing a number of positions having required characteristics, and a third data structure representing a number of actions having required positions, and may construct an integrated data structure based on the first data structure, the second data structure, and the third data structure and may surface otherwise unknown data (e.g., intersections between elements of the data structures such as an individual having characteristics associated with a position, etc.) based on the integrated data structure. In some embodiments, generating an integrated data structure reduces a search space for deriving new information from disparate data sources. For example, systems and methods of the present disclosure may quickly identify individuals suited for a task based on searching an integrated data structure for individuals having tagged characteristics (e.g., metadata, etc.) associated with the task. As another example, systems and methods of the present disclosure may dynamically identify an individual suitable for a task based on querying an integrated data structure for a driver nearby a location of the task currently having at least a threshold cargo capacity.

In various embodiments, systems and methods of the present disclosure facilitate reducing and/or eliminating a number of manual assignments associated with merging disparate data sources (e.g., worker schedules, etc.). Additionally or alternatively, in some embodiments, systems and methods of the present disclosure facilitate automatically enriching data. For example, systems and methods of the present disclosure may dynamically determine suggested declarations associated with various positions based on characteristics of the position and may automatically update a digital representation of the position to require the suggested declarations. As another example, systems and methods of the present disclosure may perform semantic extraction to automatically populate a digital schedule based on a user response, thereby reducing and/or eliminating an amount of manual data entry required to generate and/or maintain a digital schedule. In some embodiments, systems and methods of the present disclosure provide a technical solution to the technical problem of integrating disparate data sets (e.g., data structures, etc.). For example, systems and methods of the present disclosure may automatically generate an integrated data structure (e.g., a digital schedule, etc.) based on a number of disparate data sets having overlapping and/or non-compatible elements (e.g., timeslots, etc.) by representing each disparate data set as an equation in a system of equations and determining an inflection point for the system of equations that represents an optimized combination of the disparate elements.

In various embodiments, the system disclosed receives, stores, and analyzes data on customer tasks and fixed resources that are poolable and can be assigned to multiple customers, for example drivers or vehicles within a delivery fleet. The system cross-correlates resource specific information, for example driver and delivery vehicle availability, vehicle size and capacity, and preferred locations, with customer task-specific information, for example item size and required time of delivery, and determines an optimal assignment of a task to a resource within a group of correlated customers and resources in near real-time.

For example, a local restaurant chain with multiple locations may offer food delivery and operate a fleet of delivery drivers who deliver food exclusively for that chain. The drivers may be further allocated so that each driver in the fleet is assigned to a single restaurant in the chain. Delivery management systems usually available to merchants like the restaurant chain are commonly structured to manage driver dispatch based on a narrow set of delivery data (e.g. item and destination), typically without regard for optimization of routes, schedules, capacity, or driver or customer preferences. Using conventional delivery management systems, when the restaurant receives an order, a driver in the limited pool of drivers assigned to a particular restaurant location is tasked to take the food order to one location and return to the restaurant for the next delivery task. With some systems, a dispatcher may be able to assign multiple deliveries to a driver operating on a route but such systems usually lack the capability to coordinate delivery of orders originating at different locations within the same restaurant chain or among drivers in restaurant chain's fleet who are assigned to different restaurants even where a driver assigned to one restaurant may be able to more efficiently deliver an order received by a different restaurant in the same chain.

In a further illustration of the limitations of conventional delivery management systems, a flower shop located a block away from the restaurant may operate its own dedicated delivery fleet. The flower shop and restaurant may have similar delivery requirements with similar delivery patterns including overlapping delivery areas, common customers, and similar hours of operation. Although the two merchants could realize significant efficiencies and cost reductions by sharing a common delivery fleet or cooperatively engaging each other's fleets, no conventional delivery management systems are capable of providing services on a common platform to multiple merchants or multiple locations of a single merchant that analyze delivery data with driver data in near real-time to determine an optimum allocation of delivery tasks to a fleet of drivers.

The delivery management system disclosed herein beneficially cross-correlates driver data (e.g. location, preferences, vehicle size, time remaining on shift, etc.) with delivery data (merchant requirements, item parameter, compliance requirements) to optimize delivery tasks in a way that is not possible for a single merchant with multiple locations or multiple merchants who desire to pool delivery resources using conventional delivery management systems. The delivery management system automates delivery dispatch, monitoring, and analysis processes and optimizes selection of a delivery solution for delivery of products to end customers.

The delivery management system can also collect and analyze disparate delivery and driver data in near real-time and determine optimized delivery solutions across multiple merchants and multiple delivery fleets in a manner not possible for human delivery dispatchers. The system may provide real-time tracking and alerts to both the sender and the receiver via mobile devices. In some embodiments, the system chooses the appropriate driver based on the location, mode of transport and distance to drop-off. In some embodiments, the system monitors the driver's service and performance (e.g., captures photos, delivery notes and digital signature as proof of delivery) and/or collects customer feedback concurrent with completion of a delivery.

Additionally, the delivery management system described herein may include integrated scheduling and cash management capabilities. For example, certain users (e.g., supervisors, managers) may be able to view and manage work schedules (e.g., start time, stop time, breaks, etc.) from a single interface. The delivery management system can also incorporate worker schedules when selecting delivery drivers for a delivery task, and/or can automate a significant portion of the scheduling for workers of a company. As an example, a merchant may indicate that they need seven drivers a day, but the individual driver's aren't necessarily important. The delivery management system can analyze worker profiles and schedules to determine workers that are (i) eligible to function as delivery drivers and (ii) are available (e.g., based on their schedule or availability) to work on a given day.

In some embodiments, the delivery management system may include a mobile application (or similar interface that workers can interact with to adjust scheduling preferences, request time off, etc.). For example, rather than calling in sick, a worker may log into a mobile application (e.g., using a mobile device, etc.) and may indicate that they are not available to work a particular time period. The delivery management system may automatically determine other available workers to fill in for the sick worker. As described herein, a worker can be any person that performs some sort of work or service for another person or company. For example, workers can include drivers, employees, independent contractors, etc.

Additionally, the delivery management system can generate and track driver declarations whereby a driver or other worker indicates that a particular statement is true or false, responds to a question, and/or provides another user input requested by the delivery management system. The delivery management system can prohibit a driver from receiving a delivery task until an appropriate declaration has been submitted. The delivery management system can further track the declaration by requiring the driver to respond to the prompts or questions of a particular declaration at a determined frequency (e.g., once per shift, before each delivery). For example, to ensure a driver is wearing a seatbelt while working, the delivery management system can require the driver to indicate that the driver is wearing a seatbelt prior to each delivery. The delivery management system may require the driver to make multiple declarations in response to different prompts or questions.

The delivery management system can further dynamically generate the declaration depending on a number of individual driver factors. For example, the declaration can be dynamically generated based on which fleet or fleets the driver has been assigned to, the type of vehicle the driver is using, etc. By dynamically generating the declaration based on driver information, the delivery management system can limit the number of questions sent to the driver, thus reducing the bandwidth required to transmit the declaration.

### Delivery Management System

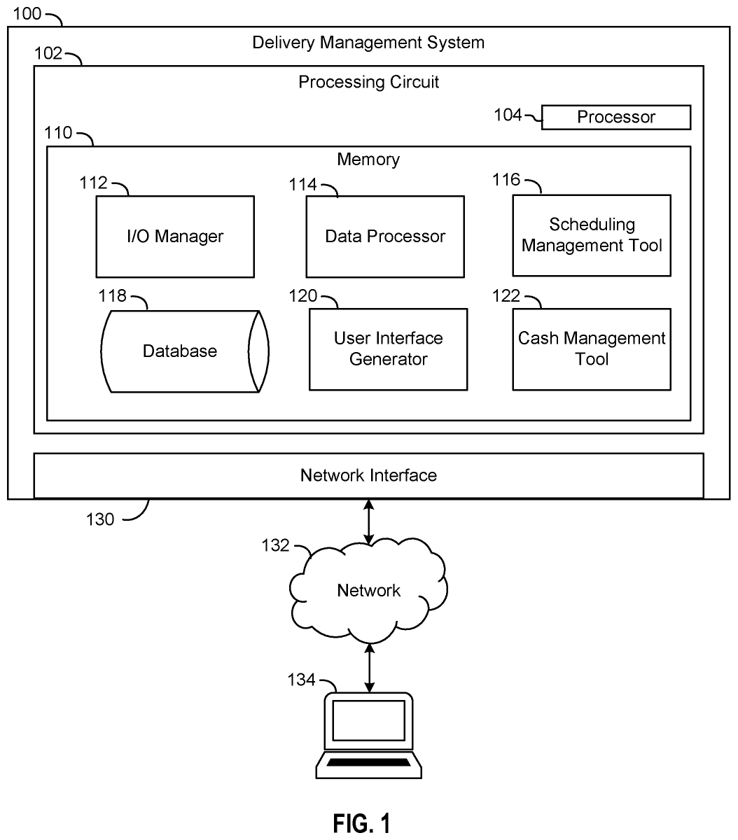

Referring first to FIG. 1, a block diagram of a delivery management system 100 is shown, according to some embodiments. More specifically, system 100 may be an intelligent delivery management configured to collect data sets (e.g., merchant and worker data sets, as described below) defining attributes of and requirements for workers, workgroups, workplaces, tasks, and customers. System 100 can process data from the data sets using a variety of data platform services to optimize allocation of workers and tasks based on worker profiles, user profiles, and assignment of workers and users to workgroups. In at least some examples, when a task is generated by a user, the system can determine a plurality of workers that are capable of fulfilling the task for the user based on a profile of the user, profiles of workers including worker capabilities, and current status and/or location information for the workers.

System 100 is shown to include a processing circuit 102 that includes a processor 104 and memory 110. It will be appreciated that these components can be implemented using a variety of different types and quantities of processors and memory. For example, processor 104 can be a general purpose processor, an application specific integrated circuit (ASIC), one or more field programmable gate arrays (FPGAs), a group of processing components, or other suitable electronic processing components. Processor 104 can be communicatively coupled to memory 110. While processing circuit 102 is shown as including one processor 104 and one memory 110, it should be understood that, as discussed herein, a processing circuit and/or memory may be implemented using multiple processors and/or memories in various embodiments. All such implementations are contemplated within the scope of the present disclosure.

Memory 110 can include one or more devices (e.g., memory units, memory devices, storage devices, etc.) for storing data and/or computer code for completing and/or facilitating the various processes described in the present disclosure. Memory 110 can include random access memory (RAM), read-only memory (ROM), hard drive storage, temporary storage, non-volatile memory, flash memory, optical memory, or any other suitable memory for storing software objects and/or computer instructions. Memory 110 can include database components, object code components, script components, or any other type of information structure for supporting the various activities and information structures described in the present disclosure. Memory 110 can be communicably connected to processor 104 via processing circuit 102 and can include computer code for executing (e.g., by processor 104) one or more processes described herein.

Memory 110 is shown to include an input and output (I/O) manager 112, configured to manage data flow into and out of (i.e., from/to) system 100. In some embodiments, I/O manager 112 receives data from a user device 134. In such embodiments, user device 134 may communicate with system 100 via a network 132. System 100 may include a network interface 130 configured to communicably couple system 100 to network 132. In this manner, I/O manager 112 may receive and process data from user device 134 and may also transmit data to user device 134. It will be appreciated that system 100 may also communicate (i.e., receive data from and/or transmit data to) any number of additional remote devices or systems connected via network 132. For example, system 100 may communicate with a remote server or a remote computing system via network 132.

As described herein, user device 134 may include any sort of device (e.g., computing system that allows a user to interact with system 100. Examples of user device 134 include, but are not limited to, mobile phones, electronic tablets, laptops, desktop computers, workstations, and other types of electronic devices. User device 134 generally includes an interface for presenting information and/or for receiving user inputs. Accordingly, user device 134 can include an input device (e.g., a keyboard) and an output device (e.g., a screen). In some embodiments, user device 134 may be connected to network 132 via an intranet or via the Internet, either via a wired connection or a wireless connection.

Network interface 130 can be, or include, wired or wireless communications interfaces (e.g., jacks, antennas, transmitters, receivers, transceivers, wire terminals, etc.) for conducting data communications between system 100 and other external systems or devices. In various embodiments, communications via network interface 130 may be direct (e.g., local wired or wireless communications) or via network 132 (e.g., a WAN, the Internet, a cellular network, etc.), as described above. For example, network interface 130 can include an Ethernet card and port for sending and receiving data via an Ethernet-based communications link or network. In another example, network interface 130 can include a WiFi transceiver for communicating via a wireless communications network. In another example, one or both of network interface 130 may include cellular or mobile phone communications transceivers.

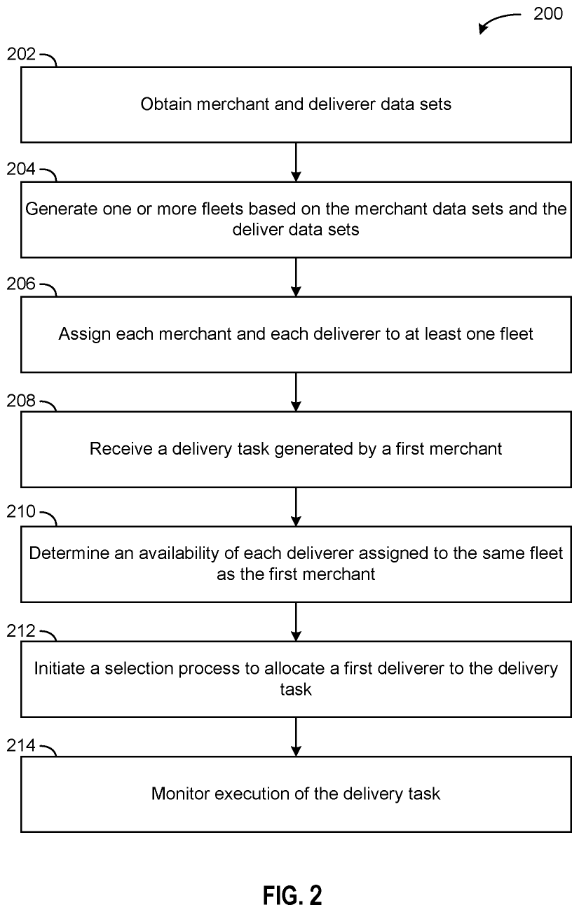

Still referring to FIG. 1, memory 110 is also shown to include a data processor 114. In some embodiments, data processor 114 implements a workforce allocation optimization engine, configured to automatically assign workers (e.g., deliverers) to delivery tasks based on various worker attributes. For example, data processor 114 may analyze worker availability and skill sets to allocate delivery tasks to various deliverers. As another example, data processor 114 may generate a differential equation for each worker describing the worker's attributes and may solve a set of the differential equations (e.g., determine an intersection point, an inflection point, etc.) to allocate delivery tasks. In some embodiments, data processor 114 generates a sequence for performance of tasks by a worker. In some embodiments, data processor 114 may generate an optimized delivery route. In such embodiments, data processor 114 may evaluate, score, and/or identify a delivery route based on efficiency parameters, rules, current deliverer location and status, worker profiles, merchant profiles, etc. Additional functionality of data processor 114 is described in greater detail below, with respect to FIGS. 2-17.

In some embodiments, data processor 114 communicates worker information (e.g., schedules, attributes, etc.) with a scheduling management tool 116. Scheduling management tool 116 may be configured to manage worker scheduling, but more generally may manage an overall worker profile. A worker profile may include one or more attributes of a worker. For example, a worker profile may include a hiring date, a termination date, maximum/minimum working hours per week and/or per day, salaried hours per week, meal break length, compensation or hourly wage, contact information (e.g., address, phone number, email, etc.), tax information, and any other such information relating to a worker. A worker profile may also be updated to reflect particular worker skills. For example, a worker may be trained to operate a cash register, but may not be qualified to drive a delivery vehicle, a distinction that may be identified in the worker's profile.

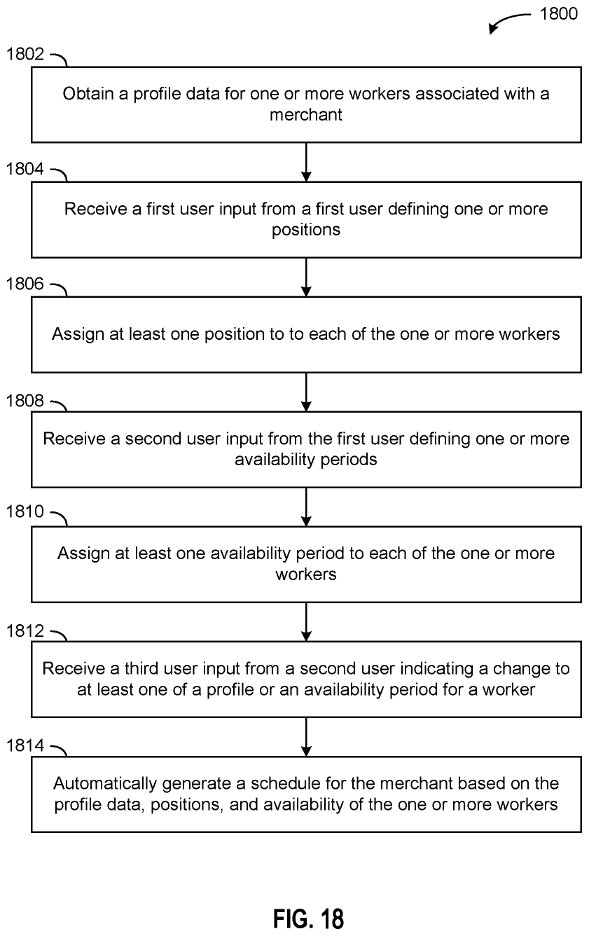

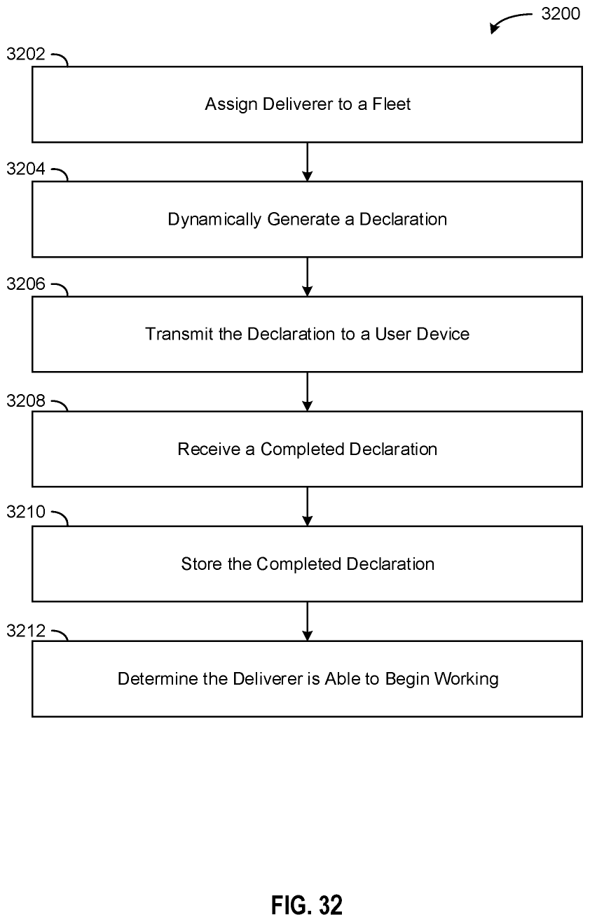

Scheduling management tool 116 can also manage and/or partially automate the process of scheduling workers for shifts or tasks. In some embodiments, a worker or a supervising user (e.g., a manager) may be able to configure availability parameters for a worker, which define when the worker is available to work. For example, a first worker may indicate that they are only available from Monday through Friday, from 9 am to 5 pm each day, while a second worker may indicate that they are available 24/7. Scheduling management tool 116 may be configured to automatically determine a schedule for a merchant or company based on a worker's profile, including the worker's availability. Additional functionality of scheduling management tool 116 is described in greater detail below, with respect to FIGS. 18-29. Scheduling management tool 116 may be configured to generate a declaration for a worker, including deliverers or drivers based on a number of factors (e.g., fleet assignment, vehicle type, job assignment, task assignment). Additional functionality of the scheduling management tool 116 is described in greater detail below, with respect to FIG. 32.

Memory 110 also includes a user interface generator 120, configured to dynamically generate, modify, and/or update graphical user interfaces that present a variety of data. For example, user interface generator 120 may generate user interfaces for entering or modifying information regarding merchants and workers (e.g., deliverers), configuring fleets, processing delivery tasks, scheduling, payment management, configuring organizational and fleet level declaration requirements, etc. In any case, user interface generator 120 may generate dynamic and interactive user interfaces that may be presented on a user device, such as user device 134. Various user interfaces generated by user interface generator 120 are described in detail below.

In some embodiments, memory 110 may also include a cash management tool 122. Cash management tool 122 may be configured to track, float, and/or settle cash payments made to drivers, and/or to track a merchant's money as drivers collect payments and complete delivery tasks. In some embodiments, cash management tool 122 may monitor the amount of money (e.g., cash) carried/collected by a driver, and may also determine whether the amount of money exceeds a threshold. If a driver exceeds the threshold amount of cash on hand, for example, the driver may be instructed (e.g., via a notification sent to the driver's phone or other computing device) to settle (i.e., deposit, transfer, drop-off) the cash at the merchant's location. In some such embodiments, a supervisory user (e.g., a manager, an administrator) may be able to set this “cash-on-hand” threshold. Advantageously, limiting the amount of cash a driver carries can help to lower risk for the drivers, such as lowering the risk of being robbed and/or losing a large amount of cash.

As described herein, any of the I/O manager 112, data processor 114, scheduling management tool 116, user interface generator 120, and/or cash management tool 122 may store and/or retrieve information (i.e., data) from a database 118. Database 118 may, accordingly, be any suitable database. For example, database 118 may be a partition or portion of memory 110, and/or may be a remote or removable database. In some embodiments, database 118 may include multiple databases, and/or may be implemented by multiple systems (e.g., servers). In any case, database 118 may be configured to store a variety of information such as worker profile data, merchant profile data, delivery task data, declaration questions, etc.

FIG. 2 is a flow diagram of a process 200 for allocating and executing a delivery task, according to some embodiments. System 100 may perform process 200. For example, data processor 114 and/or scheduling management tool 116 may perform process 200. As discussed above, process 200 may, advantageously, automate a significant portion of delivery task allocation. In some embodiments, process 200 may also integrate worker profile data (e.g., attributes), such as worker availability and skill sets, for more robust task allocation. It will be appreciated that certain steps of process 200 may be optional and, in some embodiments, process 200 may be implemented using more or less than all of the steps.

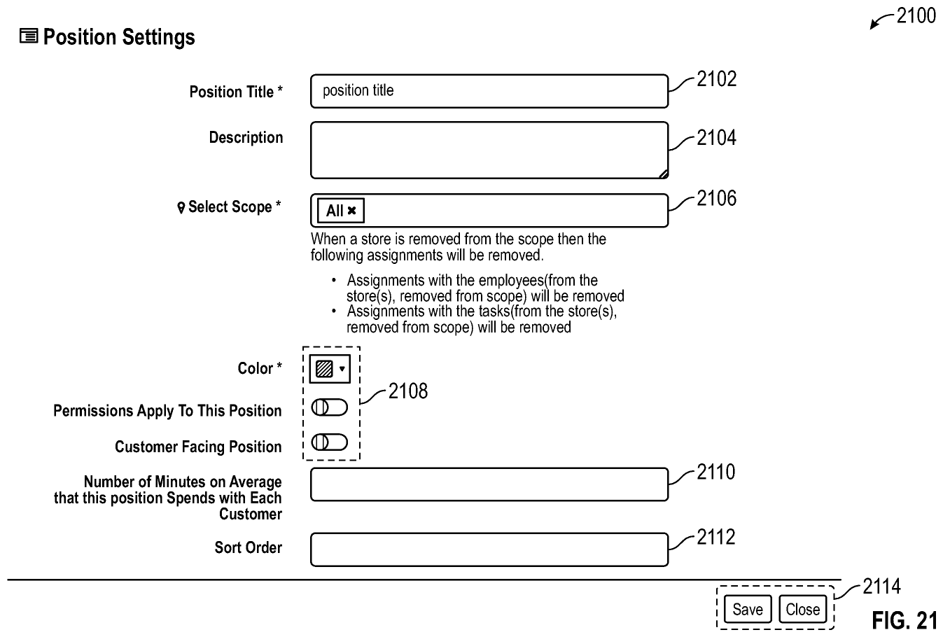

At step 202, merchant and deliverer (i.e., driver, worker) data sets are obtained. Each data set may include a variety of data associated with a merchant and/or a deliverer. In some embodiments, a merchant data set includes a plurality of merchant attributes. Likewise, in some embodiments, a deliverer or worker data set includes a plurality of deliverer attributes. Attributes, or preferences, may be parameters associated with various data points for either a merchant or a deliverer. For example, a merchant data set may include attributes such as delivery radius or area, operating hours, operating capacity, positions associated with the merchant (e.g., driver, customer service, etc.), or any other similar attributes. A deliverer data set may include attributes such as hourly wage or compensation, availability, skills or certifications, transportation identifier, delivery boundary area, job match code, rating, declaration identifier, etc. Deliverer or worker data sets are described in more detail below with respect to FIG. 21, for example.

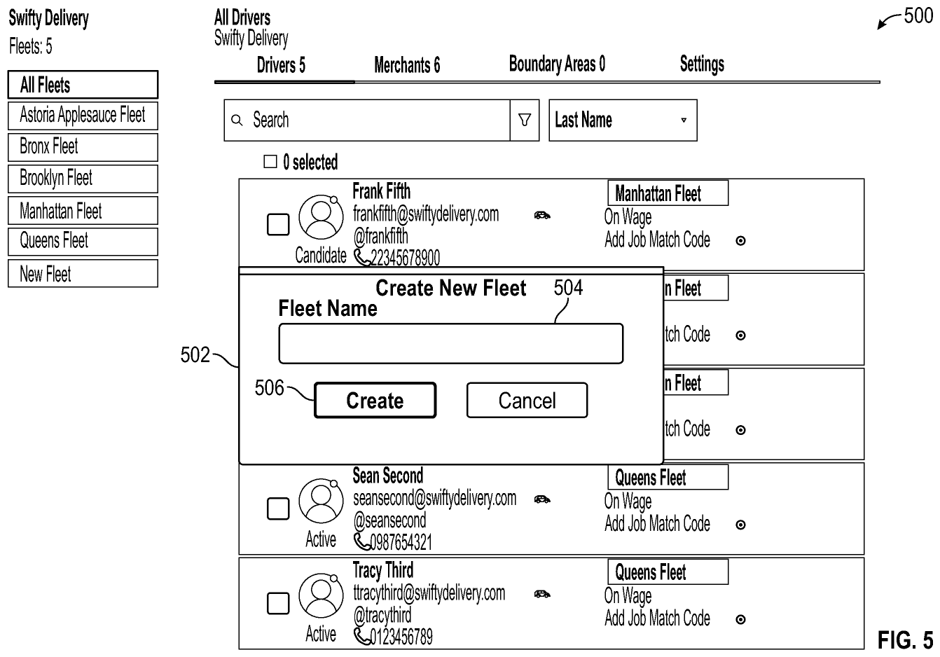

At step 204, one or more fleets are generated based on the merchant data sets and the deliverer data sets. A fleet may organize workers (e.g., deliverers) and/or other users into groups based on attributes, such as position or title. For example, a plurality of workers having the position of “driver” may be organized into a work group, or fleet, for preforming delivery tasks for a particular merchant (e.g., at step 206). Fleets may be automatically determined or may be predetermined, in some embodiments. In other embodiments, a user (e.g., a manager) may define one or more fleets, such as using the interface described below with respect to FIG. 5.

At step 206, each merchant and each driver are assigned to at least one fleet. A fleet, for example, may operate within a given area (e.g., a five-mile radius) from a central location. In this case, multiple merchants may be assigned to the fleet, and multiple drivers may be assigned to the fleet. In some embodiments, merchants and drivers are automatically assigned to a fleet based on corresponding attributes. For example, a merchant may have an attribute indicating the geographical location of a store front, such that the merchant is assigned to a fleet with one or more drivers that are located near, or operate in the vicinity of, the geographical location. It will be appreciated, however, that other attributes may be utilized to assign merchants and drivers to a fleet.

At step 208, a delivery task is generated by a first merchant. The delivery task, for example, can be generated in response to an order. For example, a merchant that sells food (e.g., a restaurant) may generate a delivery task in response to a delivery order and/or once an order (e.g., of food) is ready for delivery. In some embodiments, the delivery task may indicate various attributes for the delivery, such as a location to deliver to, a time of order, a maximum delivery time, a payment amount, etc. The delivery task may include a task code, in some cases.

At step 210, the availability of each deliverer assigned to the same fleet as the first merchant is determined. In some embodiments, the availability of each deliverer in the fleet may be determined based on a schedule generated by scheduling management tool 116. In such embodiments, the schedule may be automatically generated using process 1800, described below. Automatically generating the schedule may account for various worker preferences, merchant preferences, and manager preferences. For example, a worker may set availability periods, when the worker is available or desires to work, and the schedule may automatically be generated to account for these user preferences. Likewise, a manager may manually schedule certain workers, or may set various preferences for the number of workers, positions, etc.

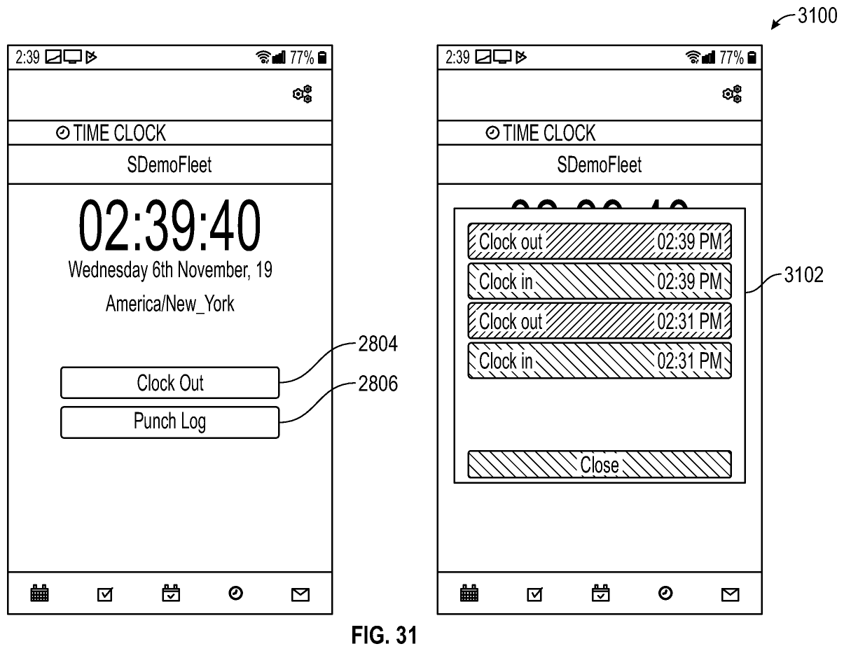

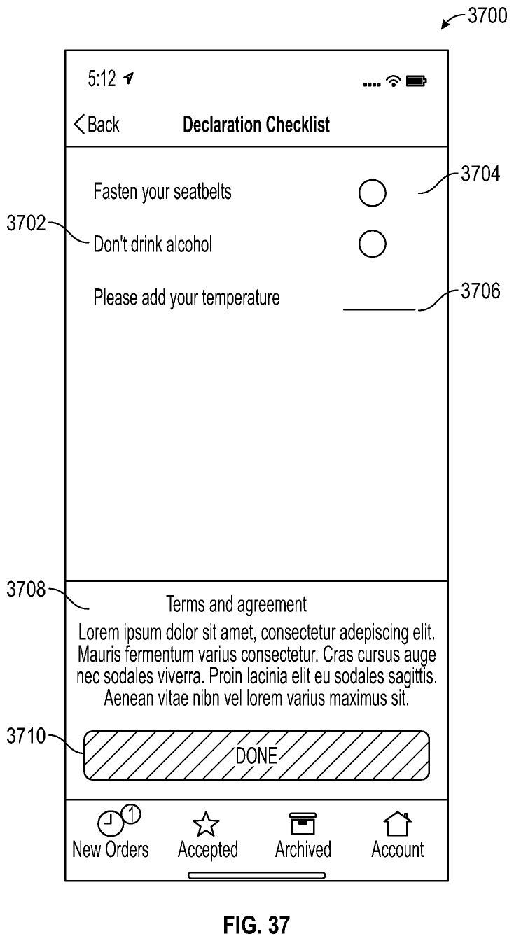

At step 212, a selection process is initiated to allocate a first deliverer to the delivery task. The selection process may include a number of sub-steps, including identifying one or more available deliverers based on the availability determined at step 210, allocating the deliver task to a selected deliverer, and/or determining whether the selected deliverer has accepted the delivery task. In some embodiments, a particular deliverer is identified to execute the delivery task based on one or more attributes of the deliverer's profile data. For example, the deliverer's profile may indicate a current location of the deliverer, and a deliverer that is nearest the merchant's geographical location may be selected to handle the delivery task. In some embodiments, before the deliverer can receive a delivery task, the deliverer must complete a declaration as shown in FIG. 37 based on the method as shown in FIG. 31. The declaration can be generated based on the fleet the deliverer is assigned to at step 206.

As another example, a deliverer with the fewest number of delivery tasks assigned may be selected. For example, in a fleet of four deliverers, where three deliverers have two or more previously assigned tasks and a fourth deliverer has only one assigned task, the deliverer with only one assigned task may be selected to handle the delivery task. In this manner, delivery tasks may be handled in a timely manner. In some embodiments, a delivery task may also be manually or semi-manually assigned by a second user (e.g., a manager).

In some embodiments, after a deliverer is selected, system 100 may automatically generate a route for the deliverer, based on the delivery task. In some embodiments, where the deliverer is allocated multiple delivery tasks, system 100 may generate an optimized route. Optimizing a route may depend on a specific implementation, however, the route may be optimized to minimize the number of left or right turns, minimize gas consumption, minimize mileage, minimize delivery time, etc. It will be appreciated that any number of optimization parameters may be considered. In various embodiments, optimizing a route includes gamifying the route using a machine learning model. For example, system 100 may perform A/B testing across a number of routes to determine an optimal route. As another example, specific areas may lack posted residential addresses, thereby requiring delivery persons to navigate based on their familiarity of the specific area and system 100 may identify which individuals have familiarity in different areas by A/B testing different individuals in different areas and monitoring the delivery times associated with the various tests. System 100 may optimize routes based on who typically delivers in an area, who delivers fastest in an area, what types of vehicle are available (e.g., scooter, car, etc.), the priority of a customer, the size of an order, and/or the like. In various embodiments, optimizing a route includes monitoring key parameters. For example, system 100 may monitor a recipient parameter (e.g., fastest delivery, etc.) and/or a package factor (e.g., least amount of travel time, etc.). In various embodiments, system 100 feeds external inputs into a machine learning model to generate an optimized route. For example, system 100 may input fuel efficiency, driver efficiency (e.g., how many packages can a driver's vehicle hold, etc.), business rules (e.g., a pizza must be delivered within 30 minutes of being made, etc.), and/or customer rules (e.g., not mixing gluten-free orders with gluten orders, etc.). In various embodiments, system 100 generates a score for each employee to determine which employee should perform a specific delivery assignment. For example, system 100 may generate a score based on a vehicle, a delivery area, a historical speed of the employee's previous deliveries, and/or the like. For example, for a food delivery, system 100 may determine (e.g., based on business rules, etc.) that a pizza can be delivered more slowly than ice cream and may route an ice cream delivery before a pizza delivery (e.g., where both deliveries are performed in a single trip by a single deliverer, etc.). As another example, for sushi delivery, system 100 may determine that a single vehicle may take many orders because sushi has a relatively long shelf life. In some embodiments, system 100 monitors delivery using one or more sensors (e.g., vibration sensors, temperature sensors, etc.) and uses the sensor measurements to feed back into the machine learning model to update the machine learning model. For example, system 100 may receive a complaint that fresh produce is arriving with bruises and may determine, based on vibration measurements, GPS data, and/or DoT data, that a delivery route is going through bumpy construction and system 100 may update the machine learning model to avoid the bumpy construction in future routes. In some embodiments, system 100 tracks a latency of various input sources and adjusts based on the latency. For example, system 100 may stop using a high-latency data source (e.g., a slow API, etc.) as it is too unreliable to produce useful information. In various embodiments, system 100 performs automated A/B testing (e.g., as described below, etc.). In some embodiments, route optimization includes generating a vehicle capacity coefficient (e.g., weighted score based on the type of vehicle and/or product being delivered, etc.). In various embodiments, system 100 trains the machine learning system using key customer parameter (e.g., delivery time, etc.) as the objective function.

At step 214, execution of the delivery task is monitored. In some embodiments, execution of the delivery task is monitored after receiving an indication that the assigned or selected deliverer has accepted the delivery task. For example, the deliverer may accept the task through a personal computing device, such as by confirming acceptance of the task via a smartphone application. The progress of the deliverer may be monitored over time, such as by tracking the deliverer's position (e.g., using GPS, etc.) or status, determining when the delivery task was completed and/or started, etc.

In some embodiments, after the delivery task is completed, an assessment of the delivery task may be obtained. The assessment may indicate any sort of data regarding the task, such as time of completion, payment amount, deliverer rating, etc. In some embodiments, the assessment includes information from one or more of the deliverer, the merchant, and/or the recipient of the delivery. For example, a recipient or the merchant may submit a review or a rating of the deliverer. This assessment information, along with any information regarding the allocation and execution of the delivery task, may be stored in a database (e.g., database 118, etc.).

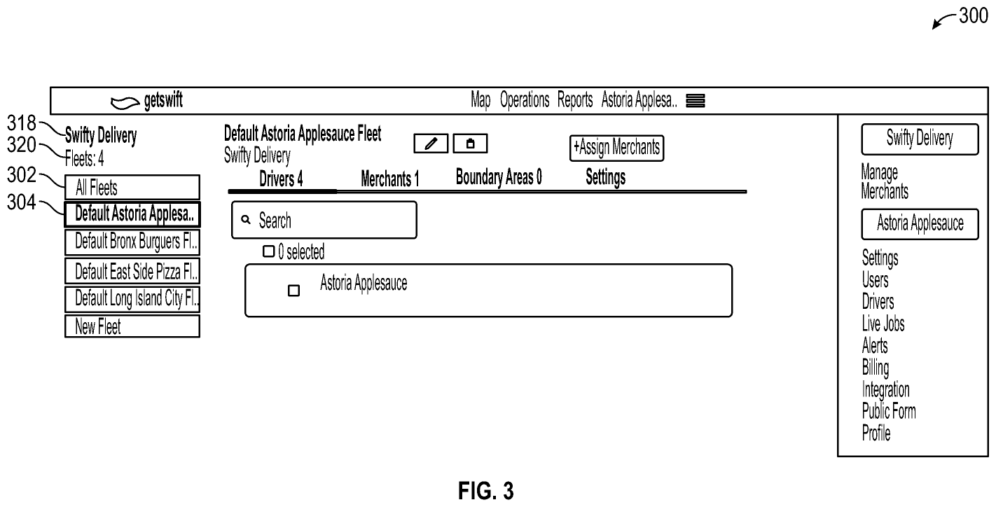

Referring now to FIG. 3, an example interface 300 for delivery management system 100 is shown, according to some embodiments. System 100 may use data stored in profiles to optimize task allocations within work groups. Work groups may include various fleets 320. Specific fleets 304 and 306 are designated 314 by a user to organize workers 308 and users 310 (e.g., merchants) into groups based on attributes 312 and 316 stored in profiles and selected by the user. Workers 308 in a delivery process may include, for example, drivers. Users 310 in a delivery process may include, for example, merchants. Attributes 312 may include, for example, boundary areas or scheduled routing, locations, skills, limitations, licenses, and cost basis.

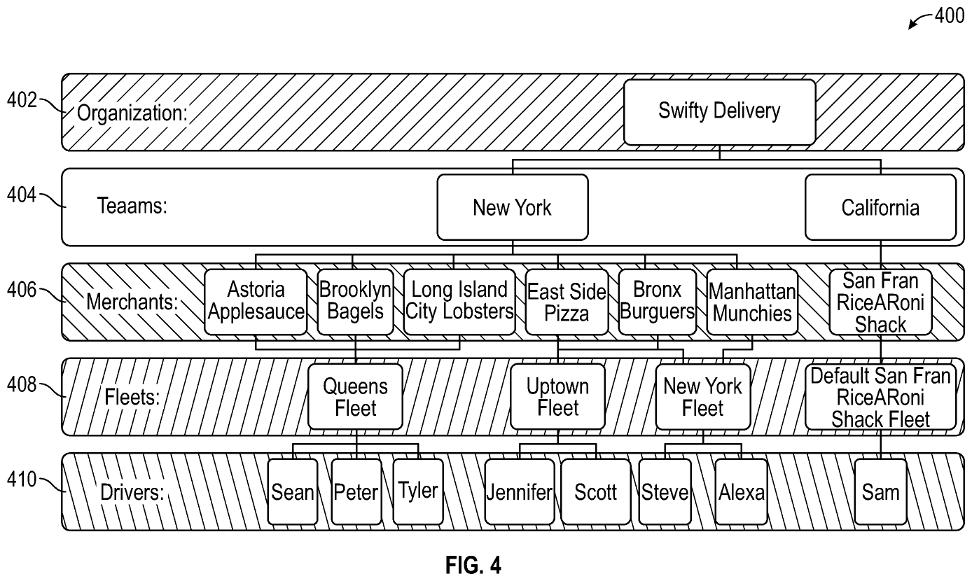

Referring to FIG. 4, an example organization structure 400 of delivery management system 100 is shown, according to some embodiments. The relationships between merchant fleet and driver levels within the organization structure 400 provide the basis for interaction between levels. Interactions between levels of the organization structure 400 within the delivery system are governed by relational rules stored as instructions in a rules database (e.g., database 118) within system memory 110. An organization 402 is an overarching business of a multi-branch institution. A team 404 is way to group a set of users (e.g. merchants) 406 together. A plurality of users (e.g. merchants) 406 can be in one team 404. Users (e.g., merchants 406) may include a single business or a single location of an organization 402. A work group (e.g. fleet) 408 is a grouping of both users (e.g. merchants) 406 and workers (e.g. drivers) 410. Workers (e.g. drivers) 410 perform tasks allocated by the delivery management system 100. For example, within a delivery system, a merchant 406 can be in one or multiple fleets 408. A driver 410, however, 410 only be in one fleet 408. This allows for the sharing of drivers 410 between multiple merchants 406.

Referring to FIG. 5, an example interface 500 for creating work groups is shown, according to some embodiments. In the example shown, the work group comprises a fleet. Interface 500 can present a child window 506 for a new fleet creation step 502 to the user. The user may create a new fleet 504 by entering a unique designation for the fleet and activating the create command.

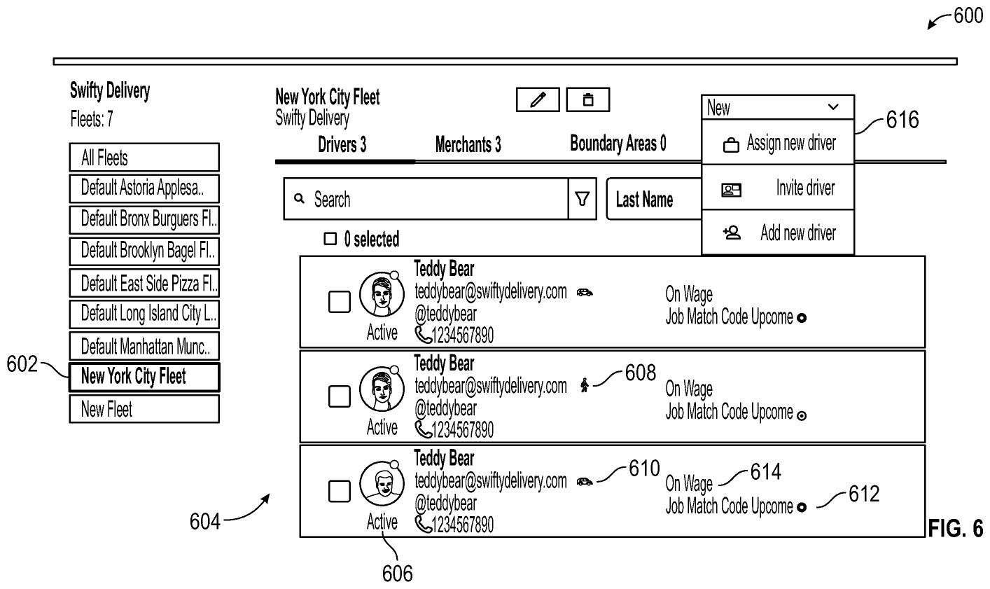

Referring now to FIGS. 6-8, example interfaces for assigning drivers to fleets are shown, according to some embodiments. Referring particularly to FIG. 6, an example interface 600 is shown. Interface 600 includes, for a selected work group 602 from the plurality of work groups, a list of workers assigned to the work group with associated worker profile information 604. Worker profile information includes, for example, contact data, status 606, capabilities 608 and 610, task matching codes 612, and cost designators 614. Worker profile information may be presented using text, images, icons, or other graphical depictions. Worker status information is presented and users may enter commands to modify a worker status 616. Worker status indications may include, for example, active, inactive, deactivated, awaiting approval, online, and offline. Users may also, through the interface, invite new workers to join a work group 416.

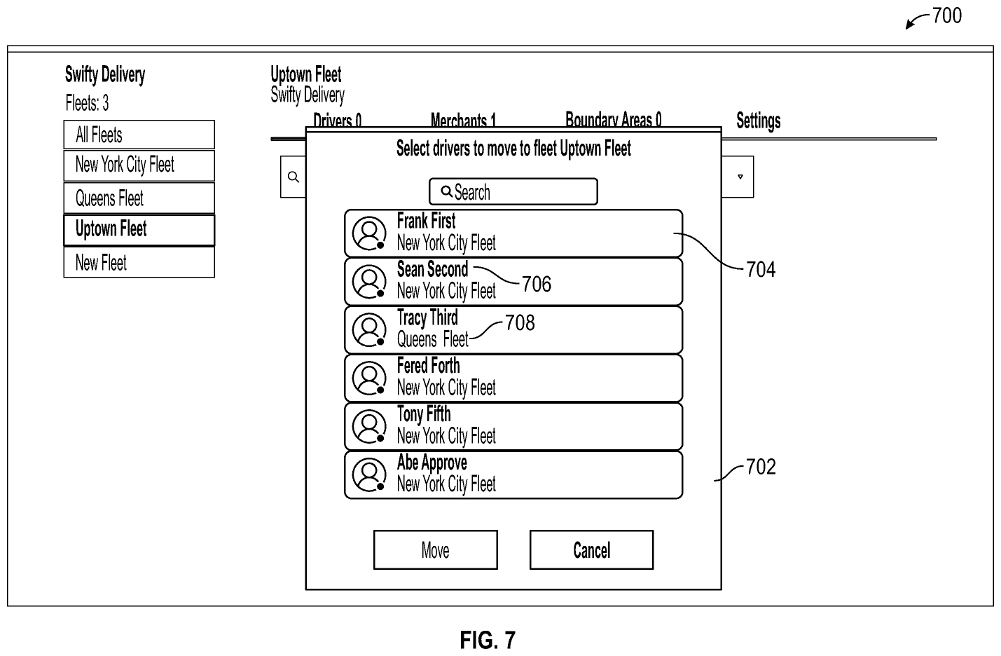

FIG. 7 is shown to include an example interface 700, according to some embodiments. Interface 700 can present a child window 702 to a user for workforce selection for who is eligible to receive deliveries from the corresponding merchants. Drivers 706 and current fleet assignments 708 are presented and the user may select drivers to move to a different fleet. The system allows the user to assign each driver to only one fleet according to relational rules stored as instructions in a rules database.

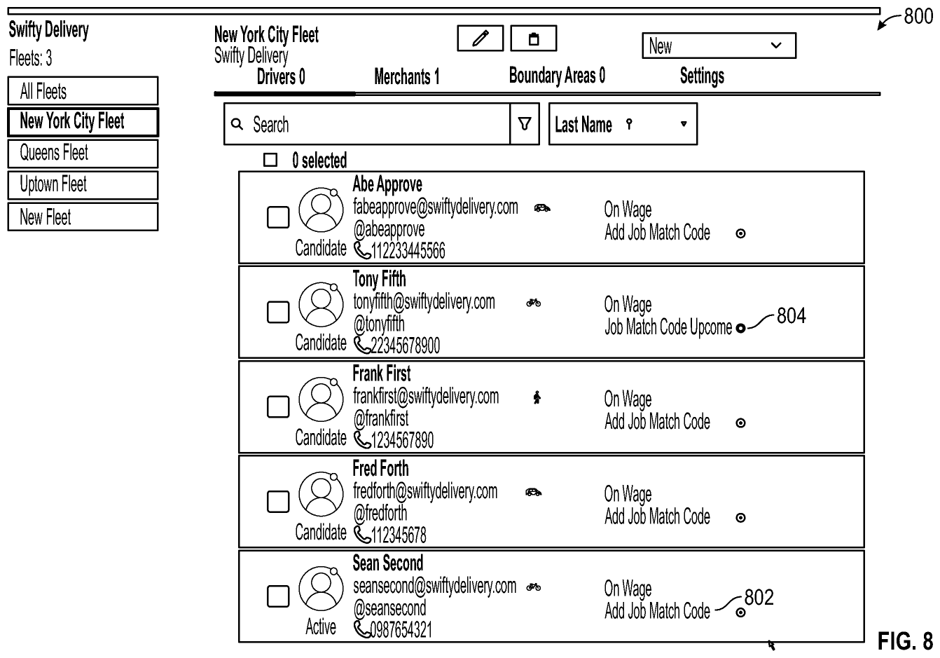

FIG. 8 is shown to include an example interface 800, according to some embodiments. Job match codes enable users to assign specific workers to specific tasks. For example, if a user has a list of daily tasks for performance by specific workers, the user may upload the daily task list into the system 100 with workers pre-selected in the task list by the job match code 802. Upon loading of the list of daily task to the system 100, all worker matched by job match code are assigned immediately to their tasks and then smart routing provided by the system 100 directs the workers to assigned tasks or locations. Job match codes are used by the system 100 when tasks are entered through an application programming interface or batch uploader. In an example shown in FIG. 8, interface 800 provides an option to assign a job match code 802 to a driver 706. Once assigned, the job match code 804 is stored in a worker profile and may be used by the system to automatically assign a driver to a task.

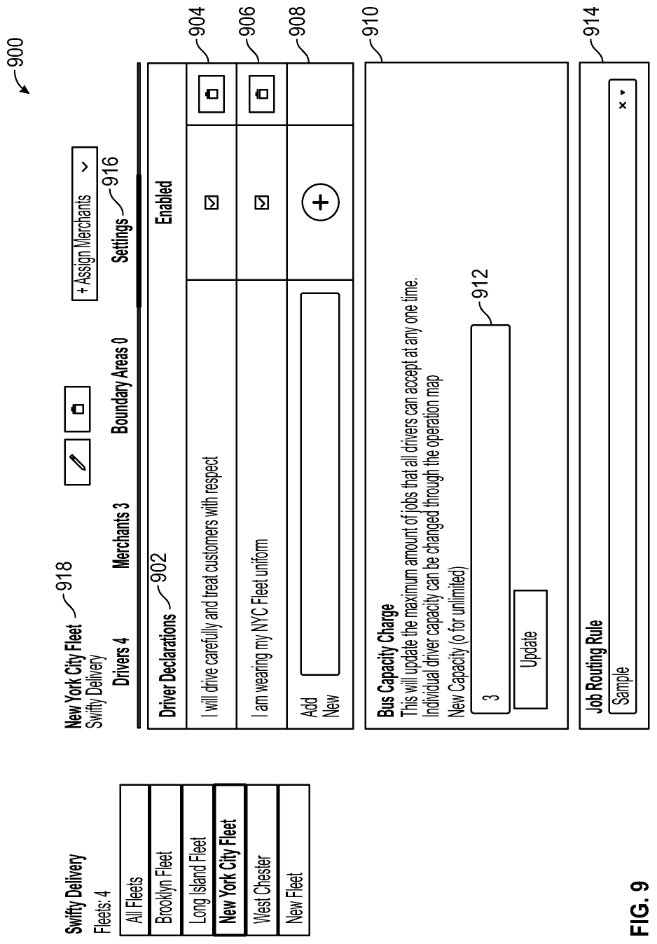

Referring now to FIG. 9-11, example interfaces for displaying and modifying worker profiles are shown, according to some embodiments. FIG. 9 illustrates an exemplary individual work group (e.g. fleet) interface 900. In the individual work group (e.g. fleet) view of interface 900, users may view and/or modify work group settings 916 for a given work group 918 (e.g., fleet). Work group settings 916 include, for example, worker declarations 902, work group capacity settings 910, a routing type setting 914, and other parameters. Individual worker capacity and routing preferences may be set by a user through an additional user interface, for example a map interface configured to display worker location and provide drop down menus to enable a user to input worker profile information. Worker declarations 902 may provide a customizable checklist that workers must agree to before they can go “online” at the beginning of each shift to start receiving tasks. Worker declarations 902 may relate to policy compliance 904, safety notices, dress code 906, health status, and/or any other user entered declaration. In the example interface 900 shown, a user may input work group settings 916 for work group 918 such as worker declarations 902, driver capacity settings 912, and driver route preferences (e.g., routing type setting 914).

Work group capacity settings 910 are used to limit the number of tasks any given worker in a work group can accept at any one time. In the example interface 900 shown (e.g., for system 100) configured to manage deliveries, all drivers in a given work group 918 (e.g., fleet) are limited to accepting up to three delivery tasks at a time based on the current bulk driver capacity settings 912. Driver capacity settings 912 are also used to set capacities for specific workers. For example, in a system configured to manage deliveries, a user may set an individual driver capacity based on the capacity of the driver's vehicle or the driver's current status, location, and/or number of tasks currently accepted.

The routing type setting 914 is used to automatically optimize worker routing to perform tasks in a sequence of tasks involving worker movement and/or between performances of individual tasks. The routing type setting 914 may include a rule input to a workforce allocation optimization engine provided in a data processor 114. In system 100 configured as a delivery management system, the workforce allocation optimization engine may be configured as a delivery management engine. The routing type setting 914 enables a user to prioritize parameters for planning routes, to save planning time, task performance time, and resource required to complete tasks. Routing type settings may include, for example, none, simple, and delivery time. A routing setting of none sequences a worker's performance of tasks in the order of notification. A routing setting of simple sequences tasks based on the shortest distance between all of tasks in a series of tasks. A routing setting of delivery time sequences tasks based on a task completion time window for accomplishment of all tasks in a series of tasks. Weighting factors and parameters for each type of routing type setting are configurable by a user.

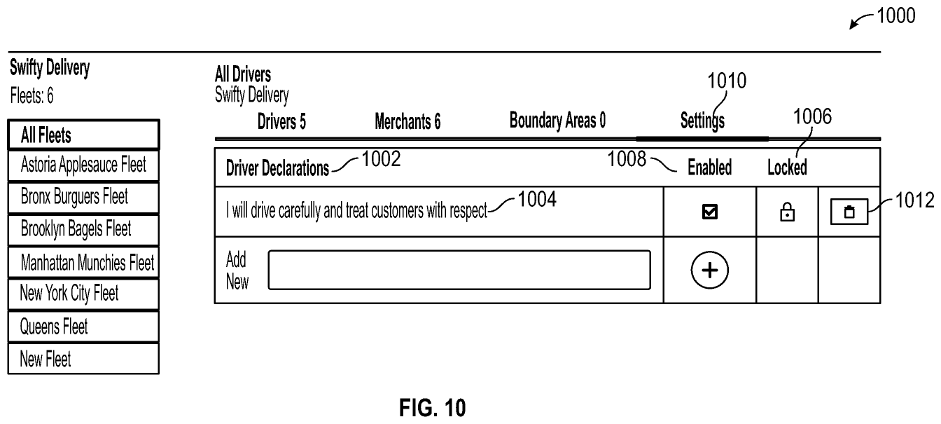

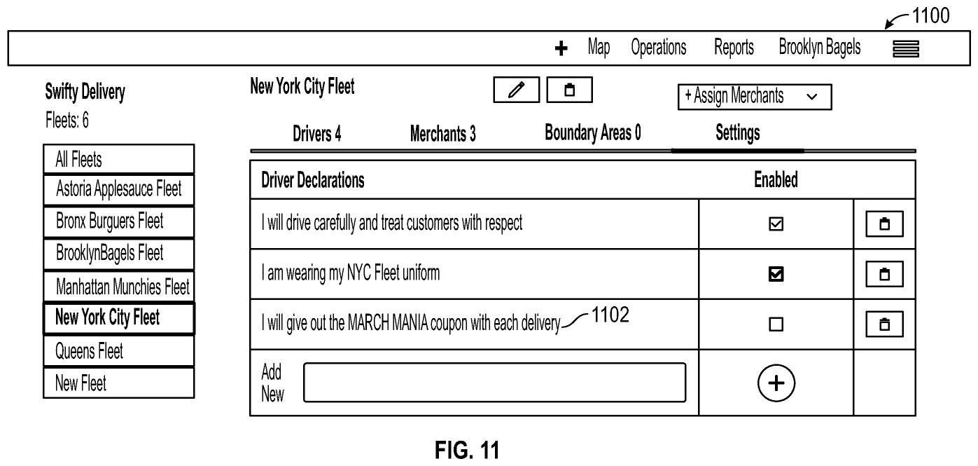

Referring now to FIG. 10, an example interface 1000 is shown for creating and managing work group settings 1010 across work groups. The work group management user interface views provide the user with options to enable 1008, lock 1006, and/or delete 1012 work group settings including driver declarations 1002 and declaration content 1004. Work group settings 916 and 1010, including declarations 1102, shown in FIG. 11, may be entered but not enabled so that a worker will not see the setting upon going online. In the example of interface 1000 shown, a user may input setting that apply to all fleets in an organization. For example, a driver declaration setting can be set as enabled (e.g., via enable 1008) or deleted (e.g., via delete 1012) for all fleets to require all drivers to agree to a declarations regardless of what fleet they are in. Driver declarations 1002 can be locked (e.g., via lock 1006) so that individual fleets cannot turn off a locked declaration. Driver declarations 1002 can also be set individually at the fleet level.

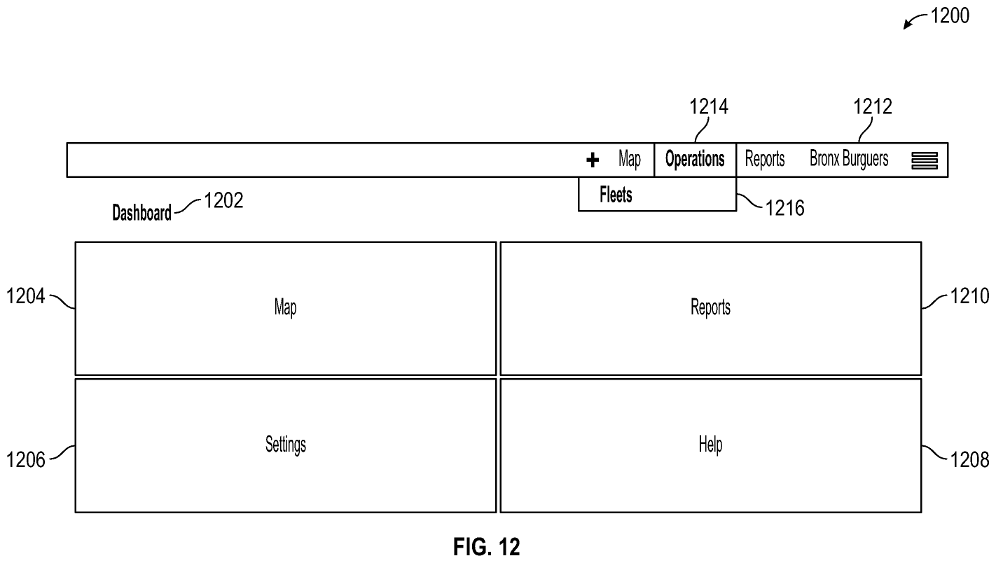

Referring now to FIG. 12, an example interface 1200 for an overview (e.g. dashboard) 1202 of system 100 is shown, according to some embodiments. System 100 services and functions include, for example, maps 1204, settings, 1206, help 1208, and/or reports 1210. Management functions for organizational elements, including teams and work groups (e.g. fleets) 1216 may be accessed. Users may access specific system 100 functions and user interface view for their organization 402 depending on permissions. Permissions may include, for example, manager, work group manager, user, and worker.

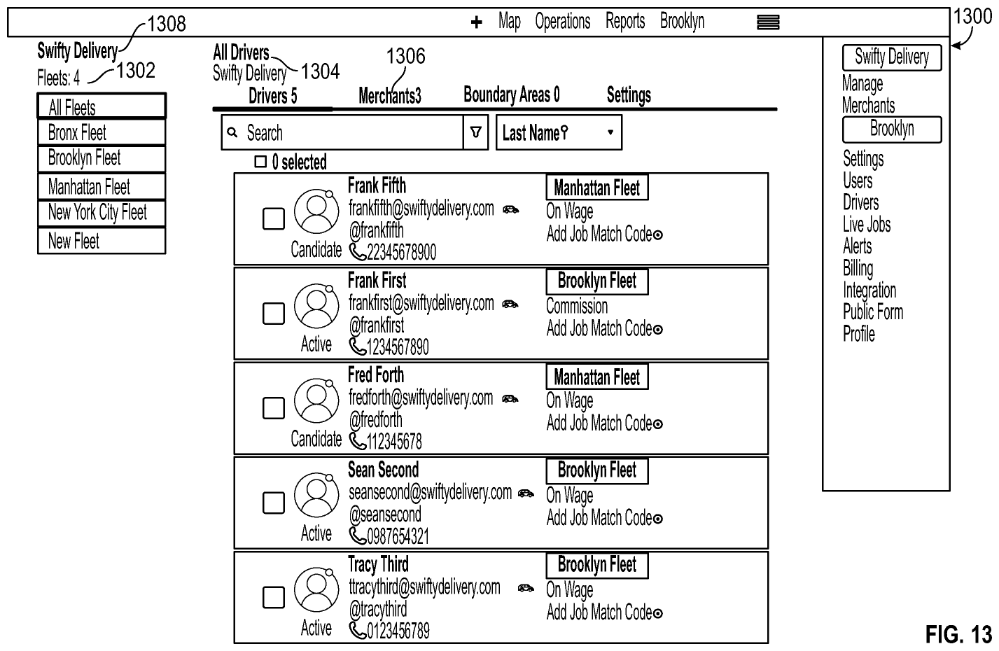

Referring to FIG. 13, an example interface 1300 for a manager of an organization 1308 is shown, according to some embodiments. A manager has full access to the system 100 and has complete control over the system functions and services for the organization 1308 including permission to maintain teams, users 1306, work groups 1302, and/or workers 1304 for an organization 1308.

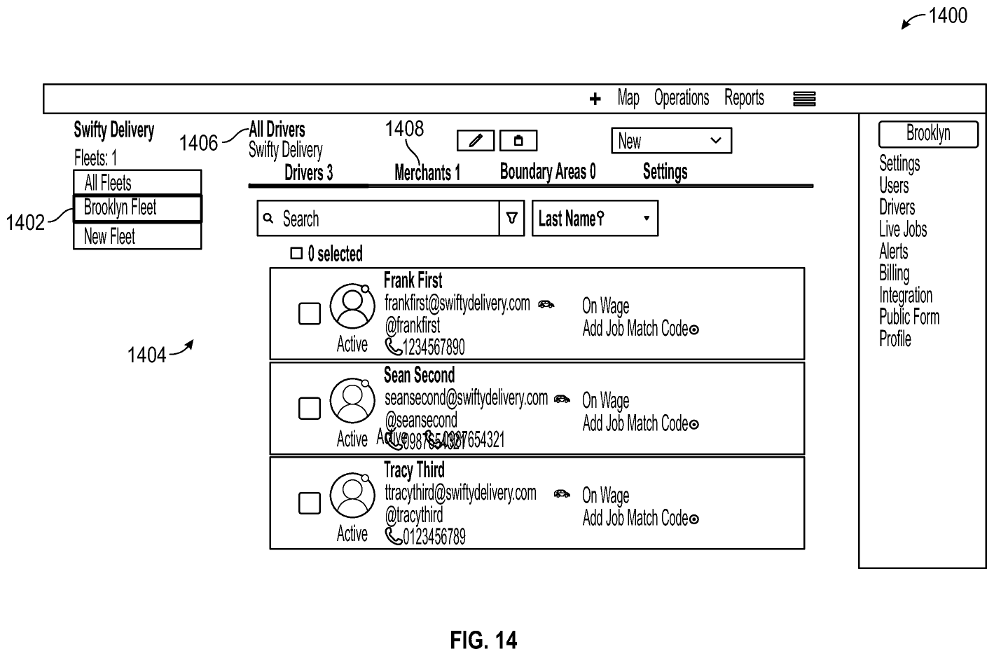

Referring to FIG. 14, an example interface 1400 for a user of the system 100 with permission to access an assigned work group 1402 is shown, according to some embodiments. Through interface1400, the work group manager may be able to see and access the users 1408, teams, and corresponding work group 1402 and 1406, and workers 1404 associated with their work group. For a system 100 configured to manage deliveries, work group 1402, 1406 may include fleets and workers 1404 may include drivers.

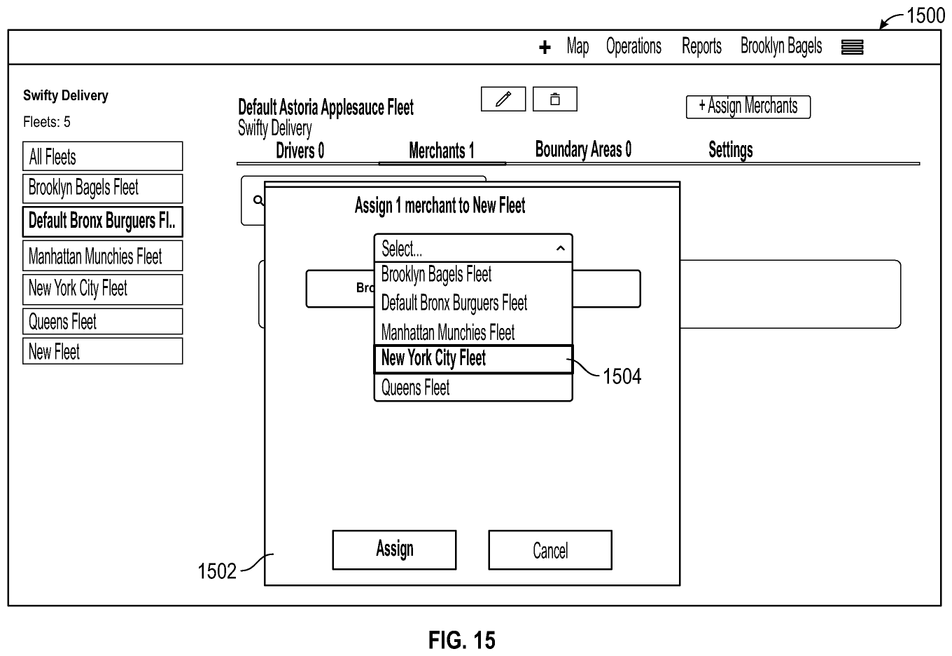

Referring to FIG. 15, an example interface 1500 for a user to assign work groups is shown, according to some embodiments. In a system 100 configured to manage deliveries, a child window 1502 is presented to a manager or fleet manager based on permissions. A manager or fleet manager may provide an input to the system 100 assigning a merchant to a fleet 1504 by selecting from a list of existing fleets.

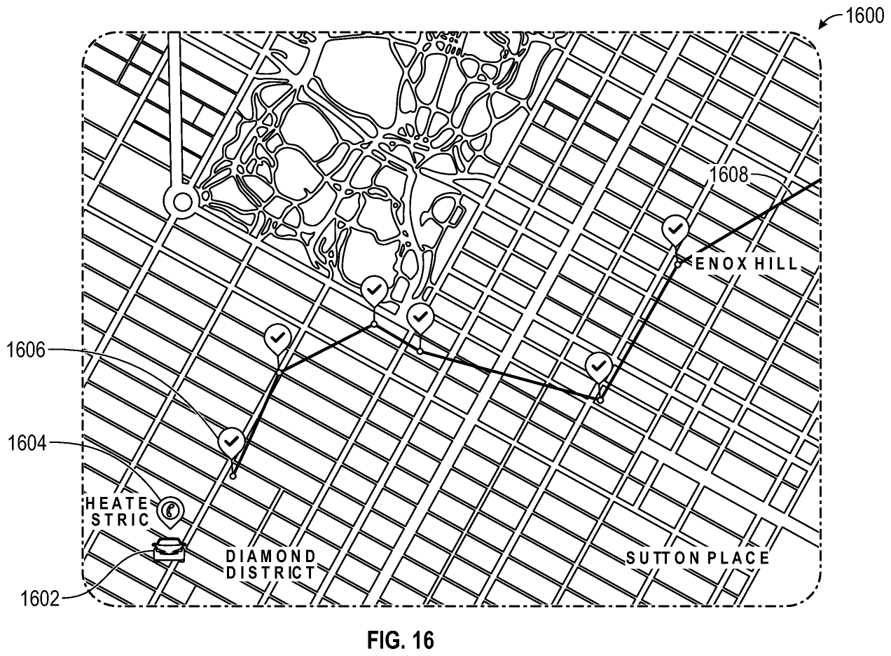

Referring particularly to FIG. 16, a drawing depicting a visualization of enterprise level implementation of route optimization functions 1600 is shown according to some embodiments. In system 100 configured to manage deliveries, a delivery management engine provided in the data processor 114 evaluates, scores, and/or selects 1606 an optimized route 1608 based on efficiency parameters, rules, driver location 1602 and status 1604, driver profile, merchant profile, other data stored in database 118, and/or user inputs. A delivery management system user interface can present route optimization information via text, graphics, or a combination of text and graphics to a user via an output device.

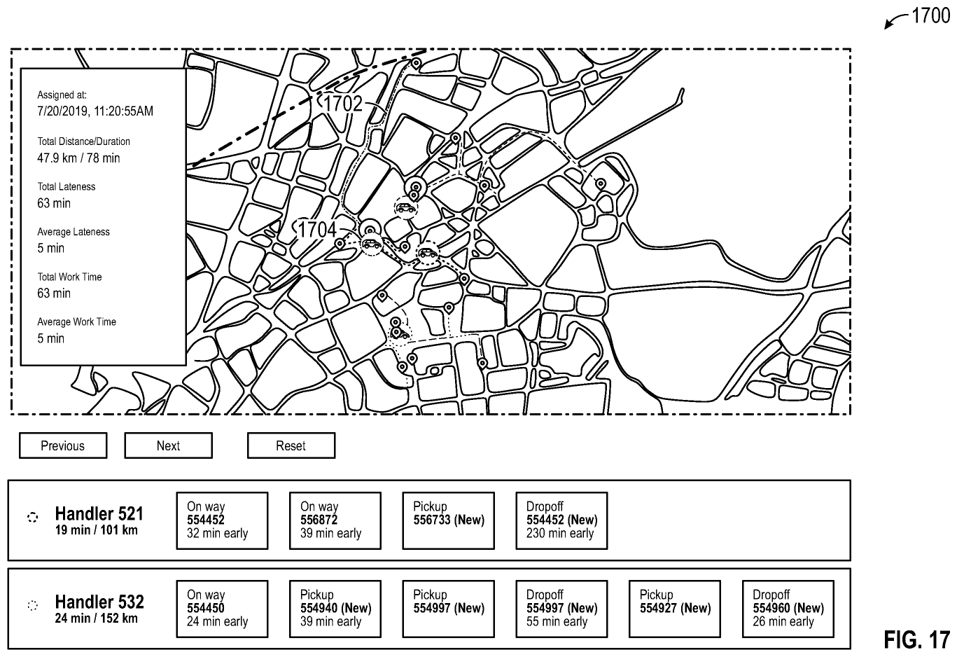

Referring particularly to FIG. 17, a drawing depicting a visualization of and enterprise implementation of advanced dispatching functions 1700 is shown, according to some embodiments. In a system 100 configured for delivery management for example, advanced dispatching functions are performed by algorithms based on inputs including, for example, user inputs, profiles, and relations rules. Advance dispatching functions may include scheduled routing and predetermined directions features. In one advanced dispatching embodiment, a user uploads preplanned tasks into the system 100 and the workforce and the task allocation optimization engine provided in data processor 114 creates an optimal sequence for performance of those tasks by a worker within a designated time window. The scheduled routing feature may be used to pre-plan tasks for allocation at a future time.

In another embodiment of advanced dispatching functions in a system 100 configured to manage deliveries, a user may provide inputs to a delivery management engine provided in data processor 114 to pre-determine directions for a delivery and/or output turn-by-turn directions for a driver's route 1702 (e.g., via a user interface before the driver 1704 that is assigned to a delivery, etc.). The turn-by-turn directions can be saved by the system 100 and pasted into a manifest for documentation of compliance or other regulatory reasons. The system 100 can monitor the progress of a driver 1704 on a pre-determined route 1702 to ensure a driver is not deviating from the pre-determined route 1702 and can alert a user, through a user interface, to any deviations from the pre-determined route 1702.

### Integrated Scheduling Management

As described above, certain aspects of delivery management provided by system 100 may be integrated with scheduling management tool 116, in order to provide more robust and efficient worker (e.g., deliverer) scheduling and delivery task allocation. For example, integrated schedule management may allow users (e.g., managers) to view delivery driver's schedules, breaks, etc., from a single interface. Additionally, data processor 114 may be provided with more holistic data regarding a worker or workers, to generate more efficient routes and to more accurately allocate delivery tasks.

Referring now to FIG. 18, a flow diagram of a process 1800 for integrated scheduling and delivery management is shown, according to some embodiments. System 100 may implement process 1800. For example, scheduling management tool 116 may implement process 1800. In various embodiments, process 1800 generates a schedule for a merchant (i.e., a company) that incorporates various worker attributes such as skill set, availability, position, etc. Advantageously, process 1800 may significantly reduce the amount of manual scheduling and/or manipulation required by a user, such as a manager. For example, process 1800 may automatically account for workers that are unavailable due to sickness or time-off when generating a schedule, and may automatically determine appropriate users to fill out a shift.

Additionally, the automatically generated schedule produced from process 1800 may be integrated with the various delivery management features of system 100 described above. For example, a generated schedule may identify workers that are certified or available as drivers (i.e., deliverers), and may populate a merchant schedule with a sufficient number of drivers to meet the merchant's needs. The delivery management processes described above may also reference the automatically generated schedule for optimized delivery task scheduling and route planning, in some cases. It will be appreciated that certain steps of process 1800 may be optional and, in some embodiments, process 1800 may be implemented using less than or more than all of the steps.

At step 1802, profile data for one or more workers associated with a merchant (i.e., company) is obtained. Worker profile data, in this case, may be obtained as a data set, similar to step 202 of process 200, described above. A worker profile may include a variety of data and/or attributes regarding a worker, such as first and last name, worker or employee identifier, time clock identifier, contact information (e.g., address, phone number, email, etc.), meal break length, compensation (e.g., salary) and/or compensation type, wage, tax information, etc. More specifically, a worker profile includes worker attributes indicating skills or abilities of the worker (e.g., training, a degree or certificate, etc.), previously approved positions for the worker (e.g., cashier, stocking, delivery, etc.), and/or previously approved tasks for the worker. For example, a first worker profile may indicate that the worker holds a valid forklift license and is therefore qualified to operate a forklift, which may be required for certain positions (e.g., stocking or warehouse). In this example, the worker profile may also indicate that the worker was previously approved to work as both a cashier and a stocker, and/or that the worker is approved to handle delivery tasks. A worker profile may also indicate skills or abilities that the user does not have or tasks for which the worker is not approved. For example, a worker may be approved for stocking but not to work as a cashier.

In some embodiments, worker profile data may indicate a capacity of a vehicle associated with a worker. Vehicle or driver capacity, as described briefly above with respect to FIG. 9, may define an individual worker's (i.e., driver's) capacity based on the capacity of the worker's vehicle or the worker's current status, location, and/or the number of tasks currently accepted. For example, a worker that drives a vehicle with only 25 cubic feet of cargo volume may not be able to accept or handle the same number and/or type of delivery tasks as a worker with a vehicle having 75 cubic feet of cargo volume. As another example, the worker with a smaller vehicle may not be able to handle large delivery tasks (e.g., those requiring more than 25 cubic feet of cargo volume, etc.). In some embodiments, vehicle capacity for each worker may also be updated or tracked in real-time, or near real-time, to determine what tasks (e.g., delivery tasks) that worker may be best suited to handle by tracking not only overall vehicle capacity but also the amount of vehicle capacity in use (e.g., 75 cubic feet of possible cargo volume with 40 cubic feet of cargo volume in use).

In some embodiments, worker profile data is stored in a graph structure (e.g., in database 118). Similarly, in some embodiments worker profile data may be obtained as a graph or a spreadsheet, as described below with respect to FIG. 21. In any case, worker profile data may include a number of pre-filled or prepopulated fields and may also include a number of unpopulated fields. For example, only a portion of information included in a worker's profile may be required (e.g., when establishing the worker's profile). Accordingly, any unpopulated fields may be populated (i.e., filled in) after establishing the worker's profile.

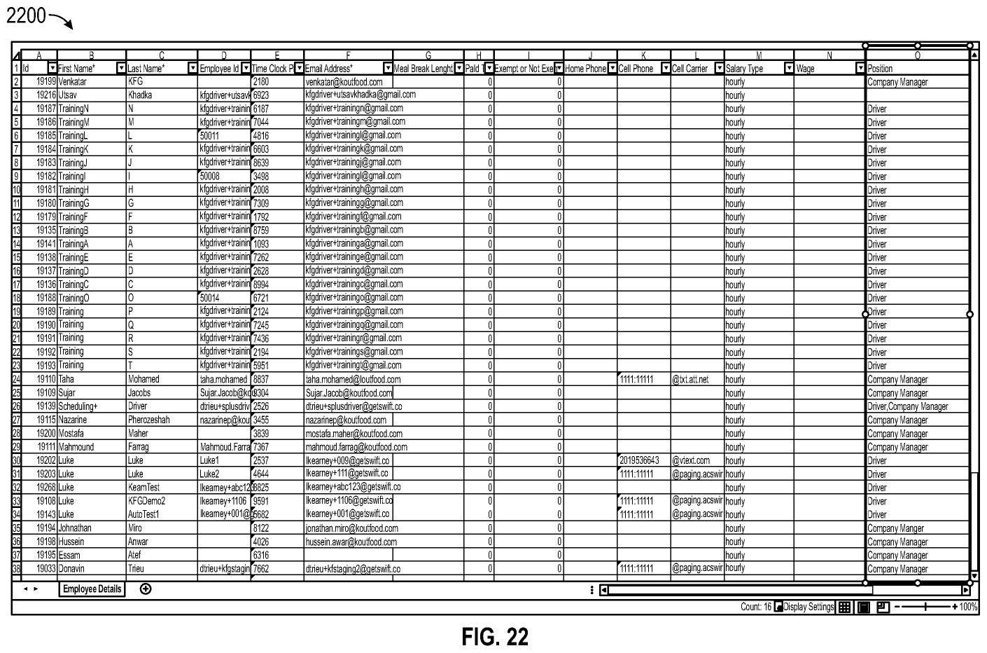

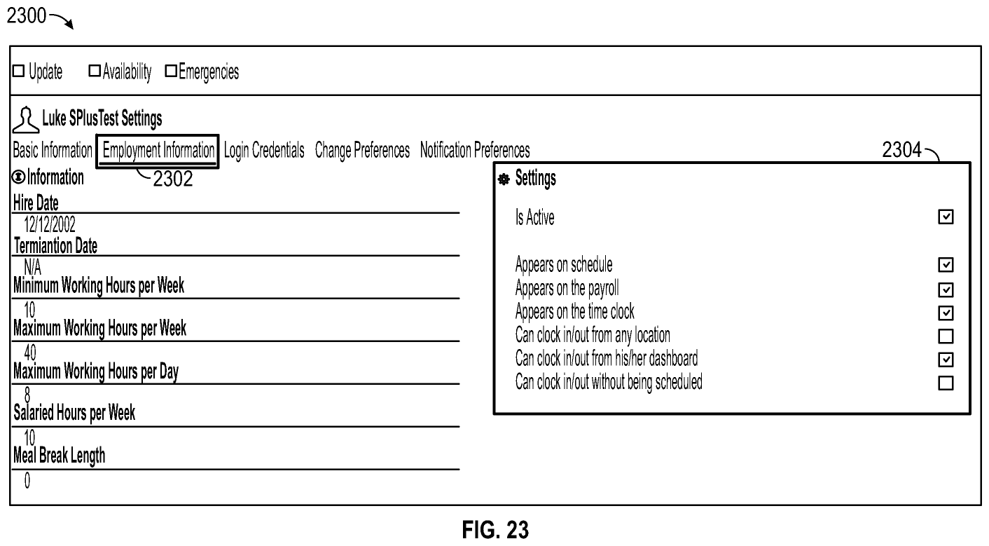

At step 1804, a first user input defining one or more positions for the merchant is received from a first user (e.g., a supervisor, a manager, an administrator). In some embodiments, the first user input is received via a user interface of a device associated with a first user, such as a manager associated with the merchant. The first user may enter information relating to one or more positions, in order to establish the positions in system 100. A position may be defined by a number of data points, such as a position title, a description of the position, a scope, etc., and the first user may also define additional parameters such as permissions to apply to the position, an indication whether the position faces customers, etc. In some embodiments, defining the one or more positions may include indicating one or more tasks that are associated with one of the positions. As an example, positions can include manager, driver, customer service, cashier, assembler, etc. Defining positions is described in greater detail below, with respect to FIGS. 22 and 23.

At step 1806, at least one position is assigned to each of the one or more workers. In some embodiments, positions are automatically assigned based on attributes of the one or more workers. For example, a worker that is of legal driving age, has a reliable mode of transportation, and has a clean driving record, may be automatically assigned to the position of “driver.” In other embodiments, positions may be manually assigned, such as by a manager or a supervisor. The manager or supervisor may indicate one or more positions via a user interface, such as by viewing the profile data of a worker and/or editing the profile data. In some embodiments, the manager or supervisor may update a graph or spreadsheet including multiple workers, to list one or more positions for each worker. The graph or spreadsheet can then be uploaded (e.g., to system 100) and multiple worker profiles may be updated at once.

It will also be appreciated that each worker may be assigned more than one position. For example, a worker may be assigned both the position of “driver” and the position of “cashier.” Assigning multiple positions to a worker can provide additional flexibility when scheduling workers. Additionally, in some cases, a worker's position may be ranked. In some embodiments, workers are assigned additional positions (e.g., a primary and a secondary position, etc.). For example, a worker may be primarily a cashier, but may also function as a driver if need be.

At step 1808, a second user input defining one or more availability periods is received from the first user. As with step 1804, the second user input may be received from the user device associated with the first user (e.g., a supervisor, a manager, an administrator). The first user may establish a variety of availability periods, where each availability period is defined by one or more days of the week, and a start and end time for each day. In some embodiments, multiple availability periods may be established for a single day. In any case, the second user input may also indicate a name and/or comments for a particular availability period.

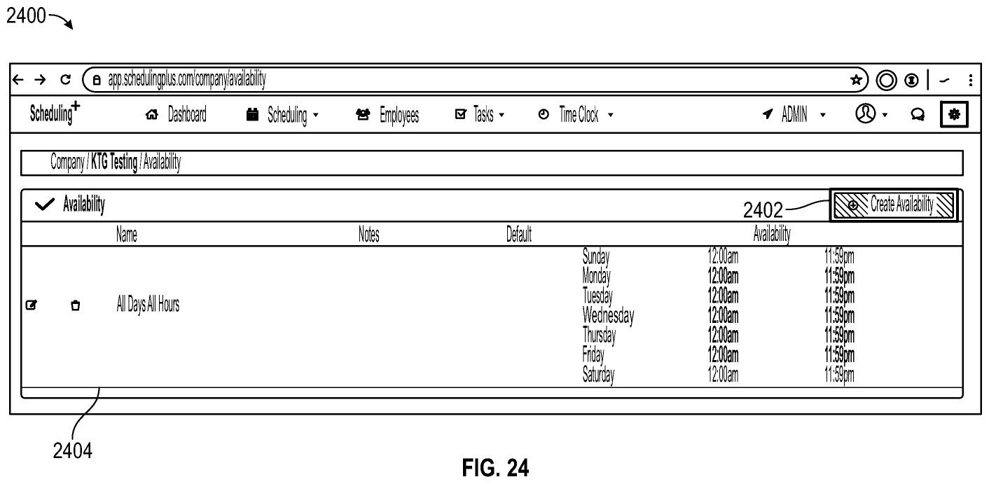

As an example, the first user may establish a first availability period that includes Monday through Friday, and establishes time periods from 8:00 am to 5:00 pm each day. This first availability period may be associated with a worker than can only work during normal business hours, for example. A second availability period could be established that includes Sunday through Saturday, and 12:00 am to 11:59 pm, indicating that a worker associated with the second availability period could work at any time and day of the week. It will be appreciated that any combination of days and time may be defined for a given availability period. Further, establishing availability periods is described below in greater detail, with respect to FIG. 24.

At step 1810, after establishing the one or more availability periods, at least one availability period is assigned to each worker. In some embodiments, the availability periods are automatically assigned, based on attributes included in the worker's profile. For example, the worker could indicate general availability during the hiring process, which may be recorded in the worker's profile. In other embodiments, a second user (e.g., a manager or supervisor) may assign availability periods to workers. For example, the second user may discuss availability with a worker, and may manually enter or adjust the worker's availability based on the discussion. The second user may assign availability periods by selecting a previously established availability period and associating it with a worker, and/or by entering availability in the worker's profile.

In some embodiments, availability periods may be selected by a worker rather than assigned by a second user. For example, a worker, having established a profile or account (e.g., during hiring or on-boarding) may log in to an account and may either define a customer availability period (e.g., by entering or indicating available days and times), and/or may select one or more previously defined availability periods. In this manner, the worker may have greater control over their scheduling, without having to involve a manager. Additionally, workers may dynamically update their availability, such as in response to fluctuations in life circumstances. For example, a worker that has recently had a child may choose to reduce their availability to spend more time at home.

At step 1812, a third user input indicating a change to at least one of a profile or an availability of a worker is received from a second user (e.g., the worker). The third user input may be received from a user device associated with a worker, for example. In some embodiments, the second user may access a limited amount of profile data, such as by logging in to an online account. For example, a worker may log in to an online portal or a mobile application to access the worker's own profile data. The worker may then edit (e.g., delete, add, modify) the profile data. In some embodiments, the second user may be limited in the profile data that can be modified. For example, the second user may be allowed to add, change, or delete availability periods or contact information, but may be prevented from editing wage information, identification numbers, assigned positions, etc.

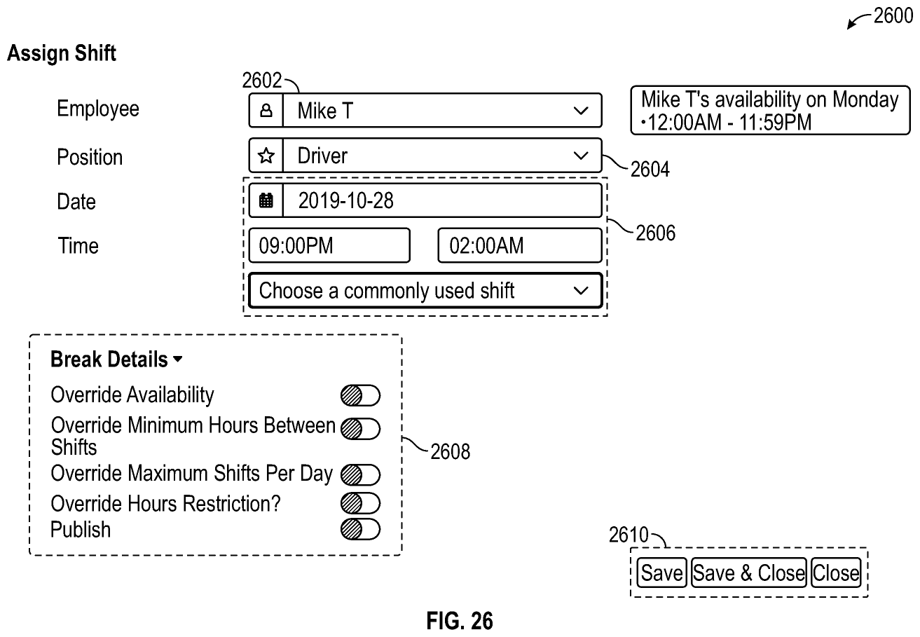

In some embodiments, the third user input includes a change to at least one of an availability of the second user (e.g., worker). For example, a worker may log in to a mobile application (e.g., from a smartphone or computer) to select a new availability period, and/or to define an availability period. In some embodiments, the third user input is an indication from the worker that the work is unable to make an assigned shift. For example, the worker may indicate that they are sick, and are unable to come in to work. Advantageously, the worker may simply enter a “sick day” through a mobile or web application without having to contact a manager or supervisor. The second user may also enter or request vacation time, which may be utilized in determining worker availability and/or generating a schedule (e.g., at step 1814). A mobile application for receiving user inputs is described in greater detail below, with respect to FIGS. 26-29.

In some embodiments, the third input is received from the first user rather than a second user. For example, a manager may choose to manually enter/assign one or more shifts. The first user may indicate a worker that they want to assign a shift to and, in response to selecting the worker, may be presented with an indication of the worker's availability. The first user may also select a position that the worker is to be scheduled for (e.g., driver, cashier, etc.). In some cases, the first user may be limited to a selection of positions that the worker is assigned to. The first user may also indicate a date, a start time, and/or an end time for the assigned shift, and/or may select a predetermined shift from a list. The first user may also chose to override certain parameters such as the worker's desired availability, an hour restriction, a number of shift restriction, etc. Manually assigning shifts is described in greater detail below with respect to FIG. 26.

At step 1814, a schedule is automatically generated for the merchant (i.e., company) based on the updated profile data of the one or more workers. As described above, the updated profile data can include at least a position and/or availability data for each of the one or more workers. Additionally, in some embodiments, the updated profile data can include various preferences entered by a manager or a worker themselves. For example, the updated profile can indicate requested time off, updated availability, etc., as entered by a worker at step 1812. In various embodiments, automatically generating a schedule includes optimizing for forecasted demand. For example, system 100 may retrieve context data associated with a business from a number of external data sources (e.g., via APIs, etc.) and may forecast a predicted demand associated with the business and may generate the schedule to meet the predicted demand. For example, system 100 may retrieve sales data, seasonal demand data, POS data, weather data (e.g., from NOAA, etc.), traffic data (e.g., from DoT, etc.), and/or the like. As another example, system 100 may determine, based on weather data, that a snowstorm is going to impact an area and may forecast increased demand for snow-related items (e.g., shovels, ice-melt, etc.) and may generate a schedule to increase staffing to meet the increased demand. As yet another example, system 100 may retrieve DoT data indicating an increase in vendor permits for an area indicating that an event may be occurring nearby and may forecast increased demand based on the event and may generate a schedule to increase staffing at a restaurant to meet the increased demand. In various embodiments, system 100 executes a machine learning model to automatically generate the schedule. For example, system 100 may execute a neural network using worker availability, time of the day, day of the week, historical trends (e.g., based on POS data, etc.), sales data, and/or the like to generate a schedule. In various embodiments, system 100 performs A/B testing to gamify schedule creation to optimize scheduling parameters such as difference in predicted vs. actual demand and/or staffing costs (e.g., favor salaried employees and prevent exempt/non-exempt employees from hitting overtime, etc.). In some embodiments, step 1814 includes generating a Gantt chart. In some embodiments, generating predicted demand includes determining competitor store hours.

In some embodiments, merchant and/or company profile data may be obtained and/or referenced when generating a schedule. The company profile data may include, in some cases, an indication of operating hours (e.g., opening and closing time for each day of the week) for the company, one or more predefined shifts (e.g., a first shift that always starts at a certain time), a desired number of workers and/or positions for each shift, etc. For example, a company may establish a profile that defines a first shift from 6:00 am to 3:00 pm, each day from Monday through Friday, and the company may also indicate that they need seven workers for this first shift. The company may also indicate the particular positions needed. For example, the company may indicate that three of the seven workers need to be drivers and two should be stockers.

When automatically generating the schedule, a system (e.g., system 100) may reference the updated profile data of each worker prior to assigning one or more workers to each shift. In this regard, the automatically generated schedule may be optimized to ensure that an adequate number of workers, with appropriate capabilities (e.g., position assignments), are scheduled for each shift. Advantageously, the schedule may be dynamically generate or updated as worker availability, or manager/company preferences, change. To continue an example from above, the schedule may accommodate for a worker that cannot make a shift (e.g., due to illness) by dynamically regenerating or updating the schedule to include one or more new, or additional workers, thereby saving time and/or money in adjusting to a number of worker's preferences and availability.

In some embodiments, system 100 may also reference a worker's capacity and/or a worker's vehicle capacity when generating the schedule. In this manner, an appropriate number or subset of workers may be scheduled to meet the needs or parameters established for a company or merchant. For example, a first merchant may need at least two delivery drivers with a vehicle capacity over 50 cubic feet. This parameter may be taken into account when generating the schedule, by determining which workers have a vehicle capacity over 50 cubic feet and ensuring that at least two of these workers are scheduled for each shift. In this manner, vehicle capacity may be useful in determining which tasks a worker may be best suited to handle.

In addition, the generated schedule can be shared instantaneously with any number of workers. For example, a new schedule may be sent to each worker upon generation, such as by emailing the schedule or a link to the schedule to each worker. In some cases, workers may access a mobile or web application (e.g., via a personal computing device, such as a smartphone) to view the schedule. In some embodiments, workers may receive a notification (e.g., a push notification, an email, a text message) when a schedule is posted and/or updated, thereby ensuring that workers are notified of scheduled shifts.

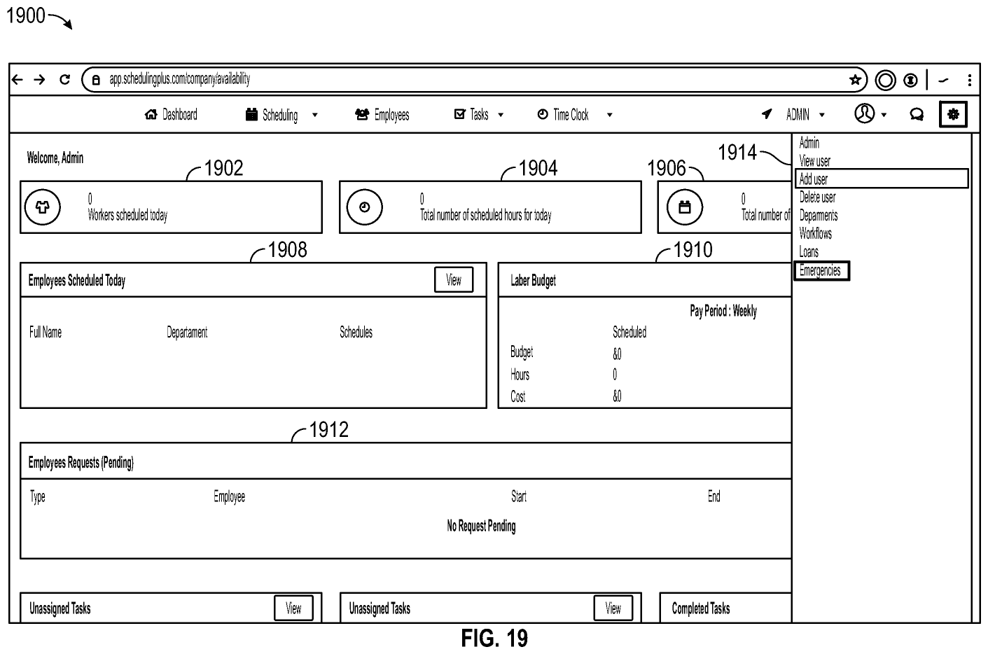

Referring now to FIG. 19, an example interface 1900 for a scheduling management tool is shown, according to some embodiments. More specifically, interface 1900 is a dashboard that presents a variety of information to a user from a single interface. In some embodiments, interface 1900 is a home screen or “landing page” first presented to a user interacting with system 100. Advantageously, a user may locate and view this variety of information at a glance and/or may interact with interface 1900 to navigate to additional interfaces and/or view additional details regarding presented data. Interface 1900 is an example user interface generated by user interface generator 120, for example, and presented via a user device, such as user device 134.

Interface 1900 is shown to include a variety of graphical elements (e.g., widgets) to present a variety of information and data. For example, interface 1900 includes a first widget 1902 that indicates a total number of workers scheduled for a current day. A second widget 1904 indicates a total number of scheduled hours for the current day, and a third widget 1906 indicates a total number of hours scheduled for the week. The data presented in each of widgets 1902-1906 may be aggregated from a schedule generated by process 1800, in some cases. For example, after generating the schedule, widgets 1902-1906 may be updated to reflect accurate workers and/or hour counts.

Interface 1900 also includes a fourth widget 1908 that indicates details regarding the workers scheduled for the current day. In this regard, fourth widget 1908 can provide additional context to the number of workers presented in first widget 1902. For example, fourth widget 1908 can include a list of scheduled workers, further indicating a name, associated department or position, and scheduled hours for each worker. A “labor budget” widget 1910 may include a daily labor budget (e.g., relating to the cost of paying workers), in hours, dollars, etc. As shown, for example, labor budget widget 1910 can list a scheduled number of hours, a budgeted labor cost (e.g., in dollars), and/or a total labor cost associated with a predefined time period. In this example, labor budget widget 1910 displays a labor budget for a weekly pay period.

A user may also view pending worker requests via an “employee request” widget 1912. Employee request widget 1912 may list pending requests for time off (e.g., due to vacation, paid time off, illness, etc.), further indicating a requesting worker's name and/or profile/position type, along with a start and end date and/or time for the request. In the example shown, a worker “Michael C” has requested time off from October 28^{th} at 11:50 am through October 28^{th} at 12:50 pm. From here, a user of interface 1900 (e.g., a manager) can review the request, view additional details about the request, and/or approve or deny the request.

It will be appreciated that the widgets (i.e., graphical elements) shown in interface 1900 are not intended to be limiting, and that other widgets may be presented. In this regard, interface 1900 may be dynamically updatable or configurable based on the preferences of a user. In some embodiments, interface 1900 may include widgets that display unassigned tasks (e.g., delivery tasks), uncompleted tasks, completed task, weather, messages, etc. The user may also choose to navigate to additional interfaces via a menu 1914. The user may select an icon and/or other graphical element of interface 1900 to be presented with menu 1914, which lists a plurality of different interfaces, menus, or pages that the user can navigate to.

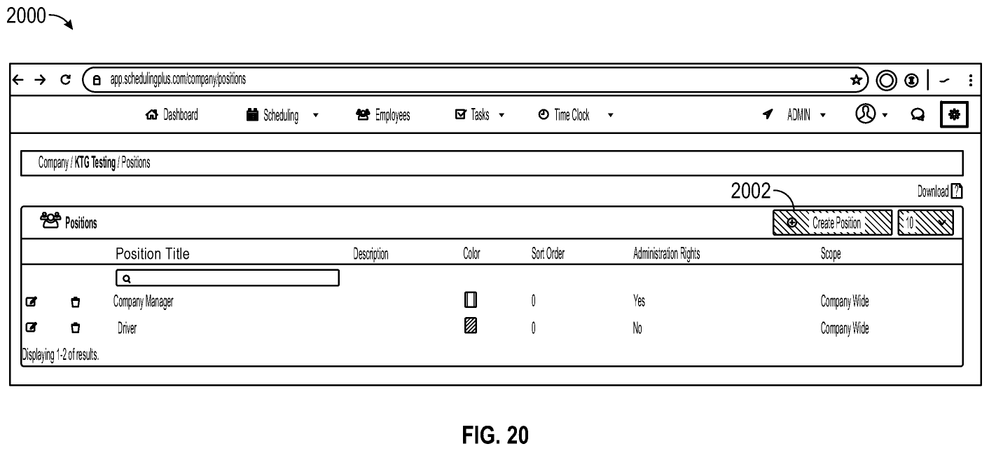

Referring now to FIGS. 20 and 21, example user interfaces for viewing and/or creating positions are shown, according to some embodiments. Referring to FIG. 20, an interface 2000 is shown. Interface 2000 may be presented in response to a user of interface 1900 selecting an indicator (e.g., a label or link) from menu 1914, for example. Interface 2000 may provide additional information regarding positions for a given company or merchant, and may also allow a user to view, add, delete, or modify positions. Interface 2000 may be presented at step 1804 of process 1800, for example, to allow a user to define one or more positions.

Interface 2000 may present a list of currently defined positions, as shown. In this example, two positions have been previously created, including a “company manager” position and a “driver” position. For each position, various additional information may be included, such as a description of the position, a color and/or a sort order assigned to the position, an indication of administration rights for each position, and/or a scope of the position. Interface 2000 may include a search bar, to allow a user to rapidly sort through, or navigate to, a particular position. For example, the user may enter at least a portion of a position name to filter the list of positions shown. To create a position, a user may select a “create position” icon 2002, which may present the user with a secondary interface shown as interface 2100 in FIG. 21.

In some embodiments, interface 2100 is presented as a pop-up or an overlay to interface 2000. For example, interface 2100 may be presented in front of interface 2000. Interface 2100 includes a number of fields that a user (e.g., manager) may populate to define a position. As described herein, each field may be a text entry box, a drop down menu, or any other suitable graphical element that allows a user to enter or select appropriate data. As shown, the user may enter a position title in a “position title” field 2102, and may enter a description of the position in a “description” field 2104. For example, the user may populate position title field 2102 with “Cashier” and description field 2104 with “Processes customer transactions at a point-of-sale terminal.”

The user may enter a scope in a “scope” field 2106. Scope may define a particular store, location, merchant, branch, etc., that the position applies to. For example, a managerial position may have a scope of “All,” indicating that the position can apply to all locations or stores associated with a company, while a driver position may be limited to a particular store. The user may define additional elements for the position via selection elements 2108, such as a color (e.g., for defining the position in a chart or in a schedule graphic), an indication of permissions to apply to the position, and whether or not the position is customer facing.

Additional fields can include a field 2110 for indicating the number of minutes, on average, that the position spends with each customer and a field 2112 for indicating a sort order. Once one or more fields of interface 2100 are populated, the user may save the position, or may close interface 2100 without saving, by selecting an icon 2114. In some embodiments, particular fields may be required in order to save (e.g., create) a position. For example, at least a position title, scope, and/or color may be required. It will be appreciated that any number of additional fields may also be presented and/or required in interface 2100, depending on implementation.

Referring now to FIG. 22, an example spreadsheet 2200 for managing workers is shown, according to some embodiments. Spreadsheet 2200 may be any sort of graph data structure for storing a plurality of data points or information. Spreadsheet 2200, for example, include a number of fields each defining a particular attribute associated with a worker. In this regard, a particular row of spreadsheet 2200 may include (i.e., store) information for a worker profile, where each column of spreadsheet 2200 is a particular data point for a worker profile. In some embodiments, spreadsheet 2200 is stored and/or maintained by database 118. For example, as worker profiles are added, spreadsheet 2200 may be updated to include the new worker's information.

In this example, spreadsheet 2200 includes columns for storing an identification number, a first name, a last name, an identification string, a time clock code (e.g., number), an email address, a meal break length, a home and/or cell phone number, a cell carrier, a compensation (e.g., salary) type, a wage, a position, etc., for each worker. In some embodiments, multiple cells for a given worker may be blank (e.g., not populated) based on the worker's profile. In some embodiment's, worker positions may be populated after defining one or more positions as described above. For example, worker positions may be entered directly into spreadsheet 2200, and/or spreadsheet 2200 may be updated as positions are assigned to workers.

In some embodiments, data for spreadsheet 2200 is retrieved from a remoter server, system, or other computing device. For example, spreadsheet 2200 may be populated based on worker data from a remote worker management database. In some embodiments, spreadsheet 2200 is maintained by a user on a local device (e.g., a personal computer) and is uploaded to system 100. In such embodiments, the user may retrieve spreadsheet 2200 from a first database prior to uploading to system 100, and/or may populate various fields of spreadsheet 2200 prior to uploading to system 100.

Referring now to FIG. 23, an example interface 2300 for viewing and/or modifying worker attributes is shown, according to some embodiments. A user may navigate to interface 2300 from any of interface 1900 and/or 2000, for example, and in particular may navigate to interface 2300 after uploading spreadsheet 2200 and/or defining a plurality of worker profiles. Interface 2300 may allow the user to access an individual worker profile to view and/or enter worker information. In particular, interface 2300 may be accessed by a worker themselves, to allow the worker to edit various information, as discussed below. In some embodiments, any changes made to a worker profile via interface 2300 may be reflected in spreadsheet 2200 (i.e., spreadsheet 2200 may be updated in response to changes).

In the example shown, a user has selected an “employment information” tab 2302 while viewing a profile for a worker named “Luke.” The user may also navigate to other tabs to view or edit basic information, login credentials, notification preferences, etc. For example, a user (e.g., a worker) may navigate to the “basic information” tab to update a home address, in the event the user moves. Employment information tab 2302 provides the user with a number of fields that can be populated with employment information. As shown, for example, the user can enter a hire and/or termination date, a maximum and/or minimum number of working hours per week, a maximum and/or minimum number of working hours per day, a salaried number of hours per week, a meal break length, and/or any other applicable information.

In some embodiments, the user may also change one or more settings from a settings menu 2304. Settings can indicate whether the worker is active, whether the worker appears on the schedule, payroll, and/or time clock, and whether the worker can clock in/out from any location, from a dashboard (e.g., interface 1900), and/or without being scheduled. For example, the user may select one or more checkboxes next to each setting to active or deactivate the associated setting.

Referring now to FIG. 24, an example interface 2400 for viewing and/or creating availability periods is shown, according to some embodiments. From interface 2400, a user (e.g., a manager) can view previously defined availability periods. For example, interface 2400 is shown to include one previously defined availability period, named “All Days, All Hours.” In this case, “All Days, All Hours” includes Sunday through Saturday, and defines availability hours from 12:00 am to 11:59 pm each day. The user may select this previously defined period to edit or delete the period, or may select a “create availability” icon 2402 to create a new availability period. In some embodiments, selecting create availability icon 2402 may present a second interface (e.g., a pop-up or overlay) that allows the user to define an availability period, including selecting days of the week and hours for each day, along with indicating a name and/or notes for the availability period. In some embodiments, the user may also set a particular availability period as a default.

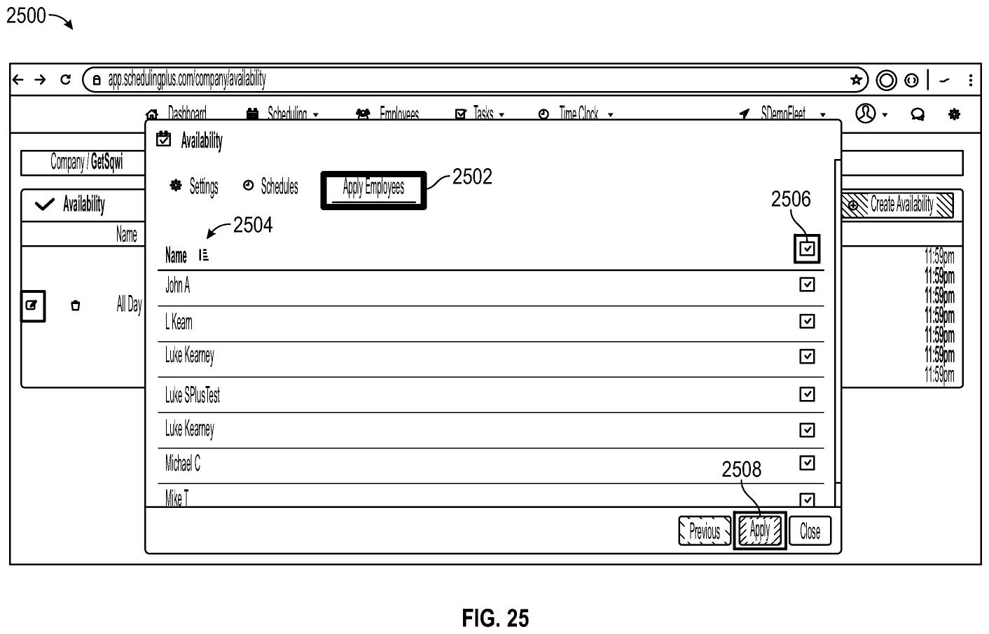

Referring now to FIG. 25, an example interface 2500 for assigning predefined availability periods to workers is shown, according to some embodiments. In some embodiments, interface 2500 may be presented when a user selects a particular availability period from interface 2400, and/or when the user edits a particular availability period. Interface 2500 provides a number of tabs 2502 that the user can select to navigate through various pages, including a settings page, a schedules page, and/or an “apply employees” page. The “apply employees” tab is shown in FIG. 25 and includes a list 2504 of workers. List 2504 may be populated based on worker profile data, for example, and/or based on spreadsheet 2200. The user may select one or more check boxes 2506 next to each worker to choose to apply the availability period to the selected worker. For example, a worker with a check in a corresponding one of check boxes 2506 will have the availability period applied to them. The user may select an “apply” icon 2508 to apply the availability period to the selected workers.

Referring now to FIG. 26, an example interface 2600 for manually assigning shifts to workers is shown, according to some embodiments. Interface 2600 may give a manager or other supervisory user manual control over the assignment of shifts. Advantageously, system 100 may account for manually applied shifts when generating a schedule. For example, a manager may manually assign certain shifts and system 100 may automatically generate a schedule incorporating the manually assigned shifts and generate additional shifts to meet the company's preferences (e.g., number and/or type of workers on shift).

To assign a shift, the user may first select a worker from an “employee” menu 2602. In this case, employee menu 2602 is shown as a drop-down menu that may list all workers with an active profile in system 100, although it will be appreciated that other graphical elements may be utilized that allow the user to define or select workers. The user may also select a position (e.g., “Driver”) from a “position” menu 2604, and may define a date, a start time, and a stop time for the shift from a “time” menu 2606. In some embodiments, upon selecting the worker, in this example “Mike T,” and a date for the shift, the user may be presented with the worker's availability for the selected date. In this case, interface 2600 indicates that Mike T is available from 12:00 am to 11:59 pm on Mondays. This availability may be determined based on the availability periods assigned to the worker using interfaces 2400 and 2500.

In some embodiments, the user may use time menu 2606 to select a predefined or commonly used shift. In such embodiments, system 100 may learn, over time, the most commonly assigned shifts for a company, which the user can select from time menu 2606. For example, the company may always include a shift from 6:00 am to 3:00 pm on Wednesdays, which the user could select from time menu 2606. The user may also select one or more elements 2608 for defining additional parameters of the shift. For example, the user may choose to override the worker's availability, or a previously defined minimum number of hours between shift, maximum number of shifts per day, or hour restriction. The user may also choose whether or not to publish the assigned shift. Upon populating one or more fields of interface 2600, the user may select one icon 2610 to either save the shift, save the shift and close interface 2600, or to close interface 2600 without saving.

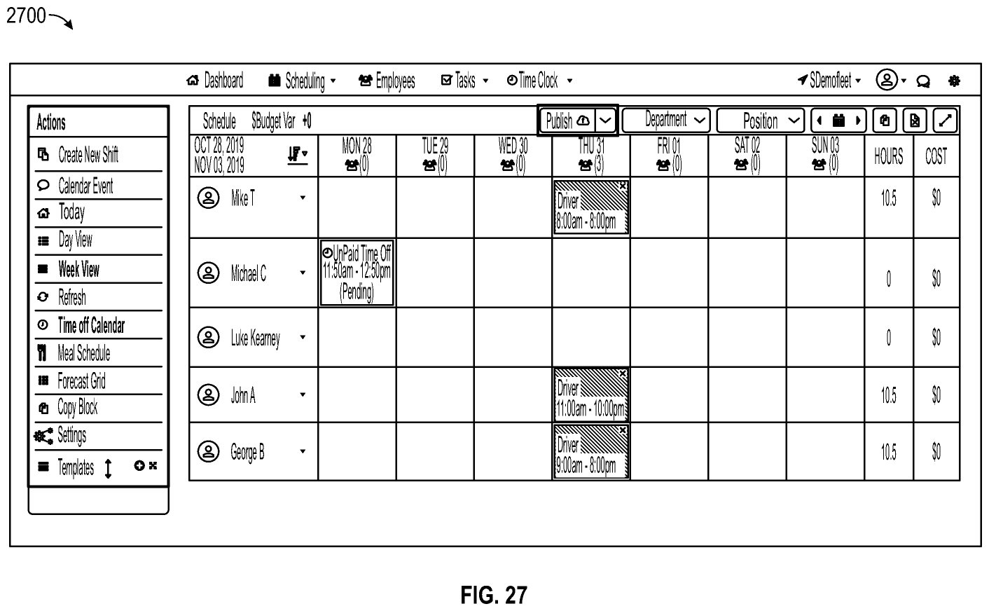

Referring now to FIG. 27, an example interface 2700 for viewing and modifying a schedule is shown, according to some embodiments. Interface 2700 may present the schedule automatically generated by system 100 using process 1800, for example. In this regard, interface 2700 may present a high-level overview of the complete schedule for a company or merchant. As shown, the schedule includes a row for each worker, and columns for each day. A user may select a particular range of dates to view, and may be presented with event blocks that indicate an assigned shift or other event for a given day. In this regard, interface 2700 is dynamic, updating as the user navigates between dates and workers.

In the example shown, the schedules for five workers are presented in interface 2700, corresponding to shifts between October 28^{th} and November 3^{rd}. For each worker, an event block is shown on a given day, if the worker is assigned a shift or if another event is scheduled for that day. Taking “Michael C,” for example, an event block corresponding to “unpaid time off” is scheduled for Monday, October 28^{th}. This event block may be presented after Michael C requests time off, as described above. Here, the event block is shown as pending, indicating that a manager or other user has not approved the time off request. In some cases, pending event blocks may be indicated based on shading or color. For example, a pending event block may be shaded a light gray, while confirmed event blocks are black.

As another example, worker “John A” is assigned a shift on Thursday, October 31^{st}. Here the assigned shift is indicated as an event block that indicates the shift and a time period for the shift. In some embodiments, a user with sufficient permissions (e.g., a manager) may be able to click, drag, and drop event blocks. For example, the user could choose to select John A's shift on October 31^{st}, and may drag and drop the shift to Michael C, thereby assigning Michael C the same shift. In some embodiments, the user may also select an event block (e.g., by double-clicking) to edit the particular event block (e.g., edit the shift). For example, the user may double-click on Michael C's time off request to view and/or approve the request.

Interface 2700 may also include a number of additional icons and menus for performing various operations on the presented schedule. For example, an “actions” menu includes a number of actions that the user can select to edit the schedule. The user can create a new shift or calendar event (e.g., a holiday), can quickly navigate between day and week views, can refresh the presented schedule to account for changes (e.g., a new time off request), can set or view meal schedules, can copy event blocks, and/or can adjust settings, etc. In this regard, interface 2700 provides a “one-stop-shop” for a user to view and modify a schedule, providing a dynamic scheduling experience. Once the user has edit or confirmed the schedule, the user may select a “publish” icon to publish the schedule, thereby making the schedule available to other users (e.g., workers).

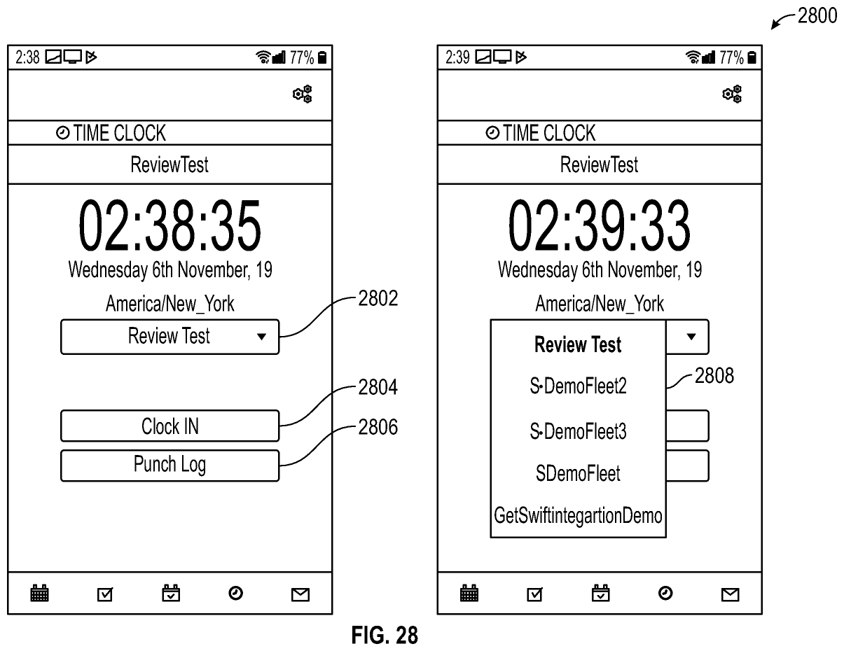

Referring now to FIGS. 28-31, example interfaces for a mobile scheduling management application are shown, according to some embodiments. In particular, the example interfaces of FIGS. 28-31 may be presented via a graphical user interface of a user's (e.g., a worker's) personal computing device (e.g., a smartphone). For example, the user may download and/or install an application for delivery and scheduling management onto the user's smartphone, and may subsequently open the application. In this regard, it will be appreciated that the interfaces shown are merely example interfaces, and that the layout and style of each interface may be altered while maintaining the functionality described below.

Turning first to FIG. 28, an interface 2800 (e.g., a home page) is shown. In some embodiment's, interface 2800 is presented after the user opens and/or logs into the application. For example, the user may first be presented with a login screen when opening the application, and may be prompted to enter login credentials (e.g., a username and password). Interface 2800 may act as a home screen for the application and/or may be presented after the user selects a “time clock” icon from the bottom of interface 2800. In this regard, the user may navigate to other interfaces by selecting other icons, to view information such as messages, tasks, etc. In some cases, the user can navigate to a graphical view of the user's schedule, for example.

Interface 2800 is shown to include a clock and an indication of the current date. A user may select a fleet or company to sign into via a drop-down menu 2808, after selecting a graphical element 2802. In this example, the user (e.g., a driver) has selected a “ReviewTest” fleet via drop-down menu 2808. The user may then select a “clock in” icon 2804 to clock in (e.g., begin a shift) for the selected fleet, and/or may select a “punch log” (i.e., clock out) icon 2806. When the user selects icon 2804 to clock in, icon 2804 may change to a “clock out” icon, in some embodiments.

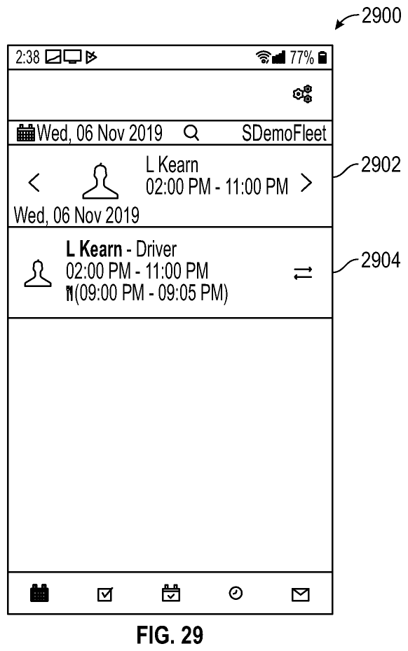

In some embodiments, in response to selecting icon 2806, the user may be presented with a second interface 2900, shown in FIG. 29. Second interface 2900 is shown as a pop-up overlay to interface 2800, that displays a log 2902 of the user's clock-in and clock-out events. For example, a user is shown to have clocked out, and then back in, at 2:39 pm, and has clocked out and back in at 2:31 pm as well. Advantageously, interface 2800 allows the worker to clock in and out of shifts on-the-go, via a mobile device, giving the worker greater flexibility and access. In some embodiments, a user's location is verified. For example, a user's location may be verified via GPS to ensure that the user is in a location associated with a clock-in.

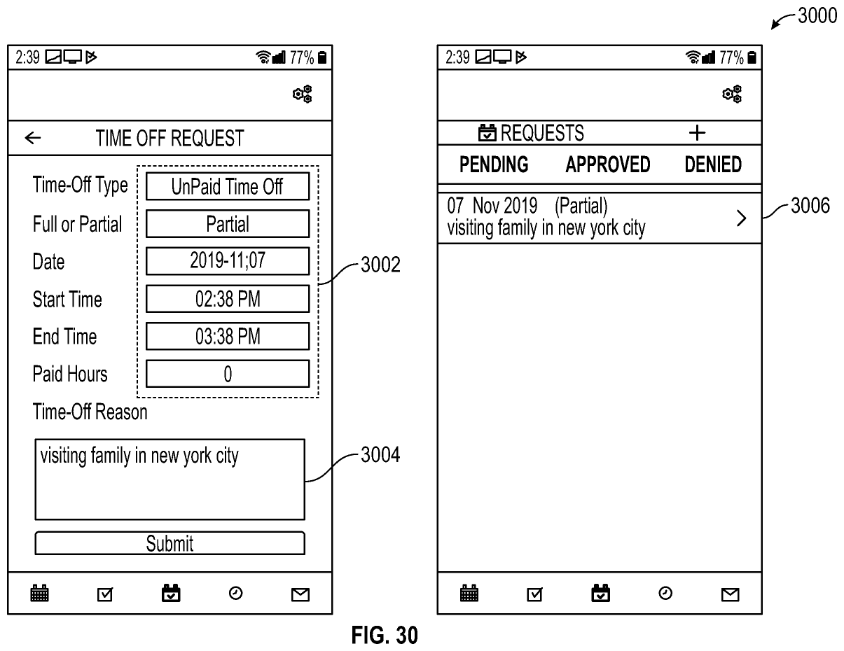

Turning to FIG. 30, the user may select a calendar icon from the bottom menu of the application to view an interface 3000, configured to display the user's shifts. In this example, interface 3000 presents shifts for a selected day (e.g., Wednesday, November 6^{th}), for a particular fleet (e.g., “SDemoFleet”). A user may select the date icon to navigate to another date. In some embodiments, interface 3000 is configured to present multiple dates at once. The user may select a particular shift and/or a particular worker via a first menu 3002. In this case, worker “L Kearn” can navigate between assigned shifts via first menu 3002. When a particular shift 3004 is presented, the user can select shift 3004 to view, confirm, and/or edit details of the shift. In this example, L Kearn has a shift from 2:00 pm to 11:00 pm assigned on Wednesday, November 6^{th}, with a five minute meal break scheduled at 9:00 pm.

Workers may also select a “time off” icon from the navigation bar of the application to enter time off requests via an interface 3100, shown in FIG. 31. In some embodiments, interface 3100 may also allow workers to enter sick days or indicate that they will miss a shift due to illness. In various embodiments, interface 3100 includes a plurality of fields 3102 that the user may populate with regards to a time-off request. For example, the user may identify a type of time off (e.g., unpaid, vacation, holiday, illness, etc.) and/or indicate a full or partial request (i.e., full day, partial day, etc.). The user may enter a date and/or a start/end time for the request. In various embodiments, a field indicating unpaid hours may be automatically populated in response. In some cases, the user may also enter a reason or comments regarding the request in a comment field 3104.

In the example shown, a worker has requested partial, unpaid time off on November 7^{th}, from 2:38 pm to 3:38 pm to visit family in New York City. After submitting this request, the request may be viewed and/or edited via a secondary menu 3106. Secondary menu 3106, in this example presents one or more pending time-off requests. The user may also select an “approved” requests tab or a “denied” requests tab, to view approved or denied requests, and/or to view additional details about these requests. For example, a denied request may be provided with an explanation for the denial by a manager, which the user could view via interface 3100.

### Integrated Declaration Generation and Acquisition

As described above, certain aspects of delivery management provided by system 100 may be integrated with scheduling management tool 116, in order to provide more robust and/or efficient declaration generation and/or acquisition. For example, integrated declaration generation and acquisition may allow users (e.g., managers) to generate specified declarations for each worker (e.g., a deliverer or driver) and ensure the declarations are completed and submitted prior to a deliverer being assigned a delivery task with minimal input (e.g., setting parameters). While these declarations are primarily described with reference to deliverers, they may be applied to other categories or roles as described herein.

Referring now to FIG. 32, a flow diagram of a process 3200 for generating and acquiring deliverer declarations is shown, according to some embodiments. Process 3200 may be implemented by system 100, for example, and more specifically may be implemented in part by the scheduling management tool 116, database 118, and/or user interface generator 120. Process 3200 may dynamically generate a declaration dependent on deliverer information (e.g., fleet assignment, vehicle type), transmit the declaration to a deliverer device (e.g., user device 134), receive a completed declaration, and/or determine if the deliverer may receive a delivery task. Advantageously, process 3200 may significantly reduce the manual generation required to generate a specified declaration for the individual deliverer and further reduce the bandwidth required to transmit the declaration as the declaration is generated to eliminate declaration questions which are not required by the organization or the fleet to which a particular deliverer is assigned.

The process 3200 may be initiated at step 3202, wherein the deliverer is assigned to one or multiple fleets. As described herein, a user (e.g., manager) can assign the deliverer to one or multiple fleets or the scheduling management tool 116 can assign the deliverer to one or more fleets. As such, process 3200 can be utilized in process 200, such that steps 3204-3212 of process 3200 can be implemented between steps 206 and 208 of process 200. This is an example configuration. Many possible configurations of process 3200 are possible.

At step 3204 a declaration is dynamically generated by the scheduling management tool 116. The declaration can include a number of questions. The questions can elicit a yes or no response, a verification, and/or a numerical entry. For example, a yes or no question could be “My age is above 21 years old.” Further, a question requiring a numerical entry could be “My body temperature in Celsius is: ______.” The questions can be generated by a user (e.g., a manager) or a series of users. For example, the series of users can include organizational managers and fleet level managers. The questions can be required on an organizational level or a fleet level (see FIG. 4).

Particular questions may be added to a declaration based on driver information. For example, a user (e.g., manager) can set that every driver in the organization must answer a particular question regardless of fleet assignment or vehicle type. Additionally or alternatively, questions can be required based on the fleet the deliverer has been assigned to. For example, a particular fleet can require that the deliverer indicate that the age of the deliverer is over 21 years due to a local ordinance requiring a minimum deliverer age of 21 years old that is not required in other regions. The user (e.g., manager) can further require particular questions based on the type of vehicle the deliverer will be using as shown in FIG. 36, according to an example embodiment. For example, the user (e.g., manager) can require a deliverer using a car to verify the use of a seatbelt, while a deliverer using a bike would not be required to verify the use of a seatbelt. The questions generated by the user or users can be added to the database 118 with the associated requirement based on organization, fleet assignment, vehicle type, etc.

Based on deliverer information (e.g., fleet assignment, vehicle type), the scheduling management tool 116 may dynamically generate a declaration for the individual deliverer at step 3204 by retrieving the generated questions from the database 118. In some embodiments, the user interface generator 120 may generate a user interface for the deliverer to respond to the declaration, as shown in FIG. 37. Advantageously, by generating the declaration based on information of the individual deliverer, the delivery management system 100 can reduce the amount of information that is transmitted to the user device 134 of the deliverer at step 3206. In some embodiments, the declaration can be transmitted to a mobile application on the user device 134. In some embodiments, the declaration can be transmitted via text or email to the mobile device by sending a link to a web based application where the deliverer can view and respond to the declaration.

At step 3208, the delivery management system 100 receives a completed declaration from the user device 134 of the deliverer. The completed declaration can be received from a mobile application from the user device 134 or a web based application. The received completed declaration can include responses to the one or more questions. The received completed declaration can include an association to the particular deliverer (e.g., deliverer identifier, deliverer name). The received completed declaration can include an association to a particular work period (e.g., shift) or a particular job (e.g., single delivery). In some embodiments, a dispatcher can complete the declaration for the deliverer. In this instance, it may be required that the dispatcher insure the veracity of the responses to the declaration questions.

Upon receiving the completed declaration, the completed declaration can be stored in the database 118 at step 3210. The completed declaration can be stored to ensure a record is kept of deliverer declarations. In some embodiments, a report can be generated on an organizational level and/or a fleet level with an overview of all deliverer answers which can be associated with a particular deliverer, a particular shift, a particular job, etc.

At step 3212, the delivery management system 100 can determine if the deliverer is able to begin working. The delivery management system 100 can determine if the provided responses to the questions of the declaration match the required response and/or are within a required range. For example, a question can ask “what is your body temperature in degrees Fahrenheit?” The question can have a preset required range for response. If the response is within the required range for the response, the deliverer can begin working. To begin working, the deliverer can be permitted to begin receiving delivery tasks, proceed to deliver an assigned delivery task, etc.

In some embodiments, at step 3212, if the response is outside of the required range for response or the response to a yes or no question does not align with the required response, the deliverer can be prohibited for working for a determined period of time (e.g., 5 minutes, 1 hour, 1 day), be reassigned to a different fleet, etc.

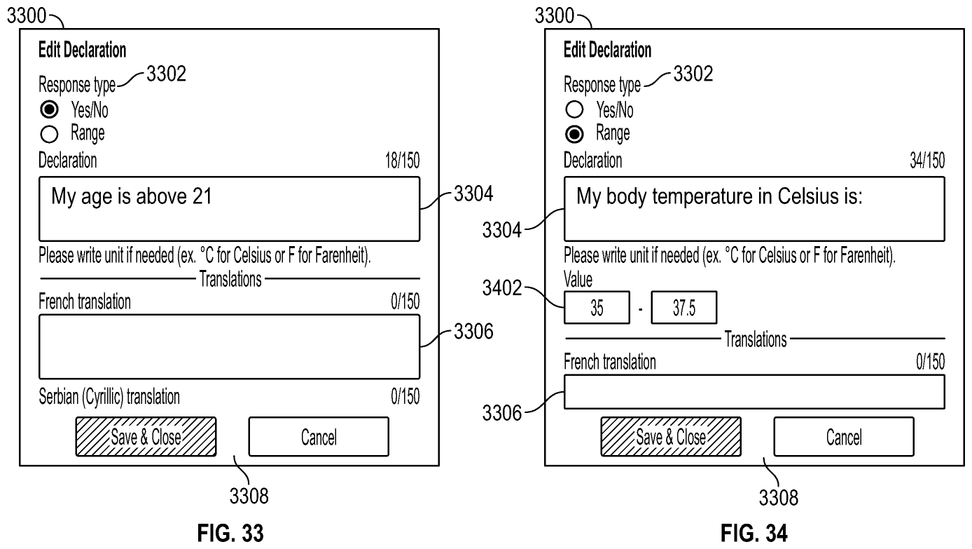

Referring now to FIGS. 33 and 34, example interfaces for generating questions for a declaration are shown, according to example embodiments. The question generation interface 3300 can include a response type input 3302, a declaration text box 3304, translation text boxes 3306, save or cancel inputs 3308, and value range inputs 3402. The question generation interface 3300 can be utilized by users (e.g., organizational managers, fleet managers) to generate questions for declarations.

The response type input 3302 can include a multiple choice input with the ability for a user to choose between a Yes/No option or a Range option as shown in FIGS. 33 and 34. In some embodiments, the response type input 3302 may be a drop down box, among other possibilities. In some embodiments, the response type input 3302 can include additional response type options (e.g., multiple choice, character input). Based on the selection of the response type, the question generation interface 3300 can be modified to elicit required information from the user. For example, in FIG. 34, the user has selected a response type of “Range” in the response type input 3302. Based on this input, the question generation interface 3300 is modified to include value range inputs 3402.

The declaration text box 3304 may be configured to provide an input for a user to enter a declaration (e.g., question). The declaration text box 3304 may include a character limit to promote efficient wording that can be easily understood and quickly read by a deliverer. In some embodiments, the declaration text box 3304 can eliminate the character limit.

The translation text boxes 3306 can include any number of possible translations. In some embodiments, the user (e.g., manager) can provide the translations based on commonly used languages among deliverers in the organization or fleet. In some embodiments, the delivery management system 100 can utilize an internal or external translation software to automatically provide translations in the translation text boxes 3306. The automatically generated translations may be revised by the user.

The value range inputs 3402 can provide the user with the ability to set upper and lower limits for a question that elicits a numerical input. For example the user can set a required body temperature in degrees Celsius to be between 35° C. and 37.5° C. as shown in FIG. 34. In some embodiments, the value range inputs 3402 may include more than a single range. For example, the user may provide two allowable ranges for a declaration stating “My body temperature is:” such that a deliverer can provide a body temperature in either degrees Fahrenheit or degrees Celsius. This is a particular example and many other configurations of multiple ranges are possible.

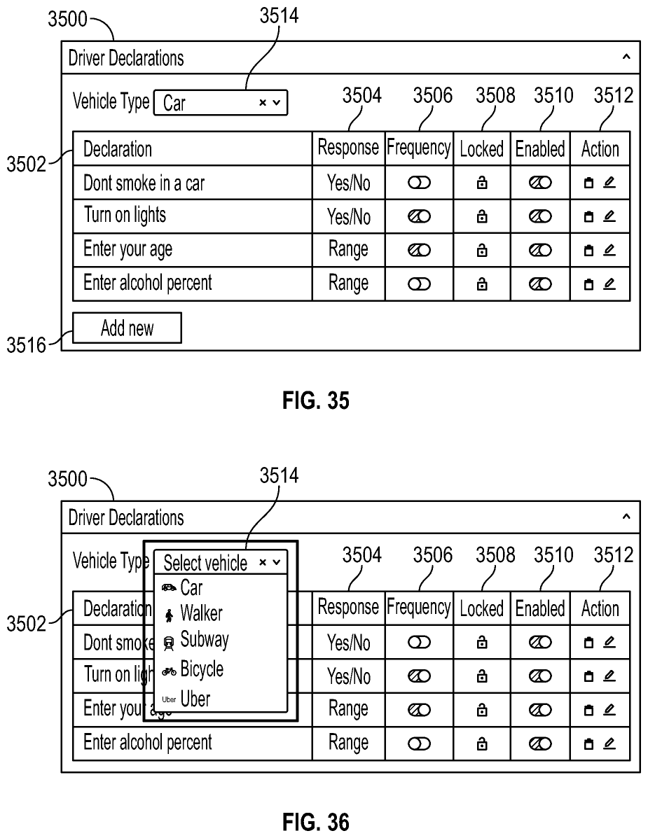

The save or cancel inputs 3308 can provide inputs for the user to save the newly generated declaration question and close, or cancel. In some embodiments, upon selecting save and close, the declaration question can be saved and added to a list of declaration questions, as shown in FIGS. 35 and 36. In some embodiments, upon selecting cancel, the generated declaration can be deleted/discarded.

Referring now to FIGS. 35 and 36, example interfaces for configuring questions of a declaration are shown, according to example embodiments. The declaration configuration interface 3500 can include a declaration listing 3502, response type listing 3504, a frequency input 3506, a lock input 3508, an enablement input 3510, an action input 3512, a vehicle type input 3514, and/or a declaration addition input 3516. The declaration configuration interface 3500 can be utilized by users (e.g., organization managers, fleet managers) to configure declarations and/or declaration parameters.

The declaration listing 3502 may provide the user with a readout of the declaration questions. In some embodiments, the declaration can include a declaration question title to provide a summarized view of the declaration question. For example, the declaration question may read “What is your current body temperature in degrees Celsius?” In this example, a declaration question title stating “Body Temperature” can be used to provide the user with a concise view of the declaration question in the declaration listing 3502. In some embodiments, the declaration listing 3502 can be shown in a grey color to indicate that the declaration cannot be edited in the declaration configuration interface 3500. In some embodiments, the declaration listing 3502 can be shown in a relatively bright color (e.g., blue) to indicate that the declaration question can be edited in the declaration configuration interface 3500. The response type listing 3504 may provide the user with a read out of the response type (e.g., Yes/No, Range).

The frequency input 3506 may provide the user with the ability to set a required frequency of particular declaration questions. The frequency input 3506 may be a slider input, as shown in FIGS. 35 and 36. In some embodiments, the frequency input 3506 may be a check box, a drop down list, etc. In some embodiments, upon the user selecting the frequency input 3506 a pop-up can request the user to provide a desired frequency of the declaration question (e.g., once per shift, once per job, once per hour). In some embodiments, the frequency input 3506 can require (e.g., when not selected, etc.) that the deliverer respond to the declaration question prior to each shift. In some embodiments, when the frequency input 3506 is selected, the deliverer can be required to respond to the declaration question prior to each job.

The lock input 3508 can be used to prevent the modification of the declaration question, the frequency, and/or enablement. In some embodiments, an organization level manager can prevent a fleet level manager from modifying the declaration question or the parameters (e.g., frequency, enablement). In some embodiments, only an organization level manager can lock and/or unlock a declaration question. In this instance, the lock input 3508 of the organization level manager can be of a different color than the lock input 3508 of the fleet level manager to signify the ability, or inability to modify the locked status, respectively.

The enablement input 3510 can provide a user the ability to enable or disable a declaration question from being added to a declaration sent to a deliverer. The enablement input 3510 may be a slider, as shown in FIGS. 35 and 36. In some embodiments, the enablement input 3510 may be a check box, drop-down menu, etc. In some embodiments, the enablement input 3510 can be disabled based on the lock status of the declaration question. For example, an organization manager can lock and enable a declaration question. In this example, a fleet manager may be prevented from disabling, deleting, or editing the declaration question. In another example, the organization manager can lock and/or disable a declaration question. In this instance, a fleet manager can enable the declaration question. Essentially, a fleet manager cannot disable, delete, or edit a declaration question that has been locked and enabled by an organization manager, but a fleet manager can add, or enable a declaration question that has been locked and disabled by an organization manager.

The action input 3512 can provide a user the ability to delete or edit a declaration question. In some embodiments, responsive to a user selecting a delete icon, shown as a trash bin in FIGS. 35 and 36, a pop-up can be generated to verify that the user wishes to delete the declaration question. In some embodiments, responsive to a user selecting an edit icon, shown as a pencil in FIGS. 35 and 36, the user can be directed to the question generation interface 3300, wherein the user can modify the declaration questions. In some embodiments, as described herein, a user can be prohibited from selecting the edit icon or the delete icon.

The vehicle type input 3514 can provide a user the ability to view, modify, delete, and/or add declaration questions and parameters for each of the different vehicle types. The vehicle type input 3514 can be a drop down list, as shown in FIG. 36. In some embodiments, the vehicle type input 3514 may be a check box, among other possible configurations. The vehicle type input 3514 can include the options of car, walker, subway, bicycle, and ridesharing. It should be understood that other vehicle options exist and are within the scope of the present disclosure. For example, the listing of vehicle options can include bus, shuttle, taxi, etc. Responsive to a selection of vehicle type using the vehicle type input 3514, the list of declaration questions can be updated to show the declaration questions specific to each vehicle type.

The declaration addition input 3516 can provide the user the ability to add a new declaration question. The declaration addition input 3516 may be a button as shown in FIG. 35, among other possible configurations. Responsive to a selection of the declaration addition input 3516 by a user, the user can be directed to the question generation interface 3300, wherein the user can generate a new declaration question.

Referring now to FIG. 37, an example interface for entering responses to questions of a declaration is shown, according to an example embodiment. The declaration response interface 3700 can be provided to a deliverer via the user device 134. The declaration response interface 3700 can be accessed through a mobile application on the user device 134 and/or a web based application accessed via the user device 134. The declaration response interface 3700 can include declaration questions 3702, yes/no response inputs 3704, range response inputs 3706, terms and agreements 3708, and/or submission input 3710.

The declaration questions 3702 can be the declaration questions determined by the scheduling management tool 116 based on the deliverer information (e.g., fleet assignment, vehicle type). For each declaration question 3702 there can be a corresponding response input (e.g., yes/no response inputs 3704, range response inputs 3706).

The yes/no response inputs 3704 can provide an input for the deliverer to input yes or no to the corresponding declaration question 3702. The yes/no response input 3704 can be a button, as shown in FIG. 37, wherein the selection of the button can indicate an affirmative response to the declaration question 3702. In some embodiments, the yes/no response inputs 3704 can be toggle inputs, drop down menus, check boxes, etc.

The range response inputs 3706 can provide an input for the user to provide a numerical response to the corresponding declaration question 3702. The range response inputs 3706 can be a text box, as shown in FIG. 37. In some embodiments, range response inputs 3706 can include a drop down menu with prelisted ranges, a check box with prelisted ranges, etc.

The terms and agreements 3708 can include particular terms and agreements as set for the particular job. The terms and agreements 3708 can include a listing of possible repercussions if information is determined to be falsified in the declaration (e.g., fine, firing, suspension). The submission input 3710 can provide an input selectable by the user to transmit the completed declaration to the delivery management system 100. The submission input 3710 may be a button, as shown in FIG. 37, among other possible configurations. In some embodiments, if not all response inputs are responded to, the deliverer can be provided a warning responsive to the deliverer selecting the submission input 3710.

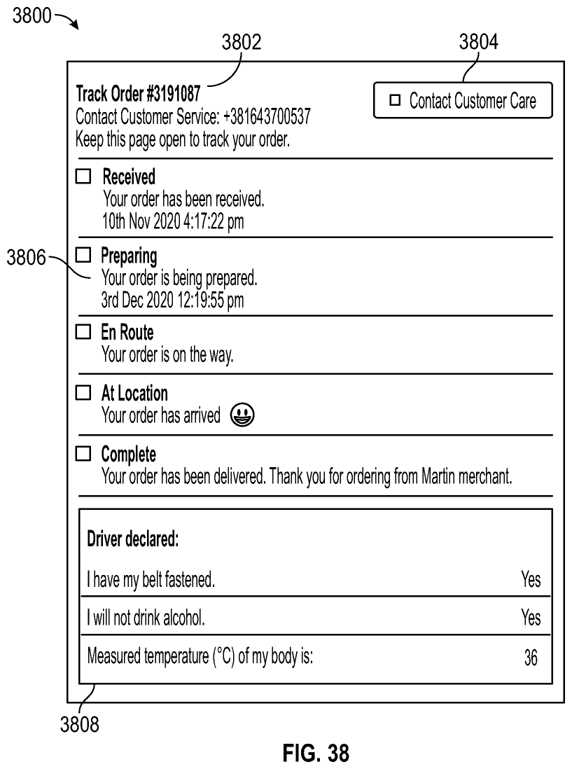

Referring now to FIG. 38, an example interface for tracking a delivery is shown, according to an example embodiment. The delivery tracking interface 3800 may be provided to a customer via a customer mobile application of a user device 134 and/or a web based application accessed via a user device 134. The delivery tracking interface 3800 can provide a customer with the ability to track a delivery. The delivery tracking interface 3800 may provide a customer with the ability to review a declaration completed by the deliverer of the order. The delivery tracking interface 3800 can include an order number indicator 3802, a customer contact icon 3804, a progress tracker 3806, and/or a driver declaration 3808.

The order number indicator 3802 can display the tracking number of the order as generated by the delivery management system 100. The customer contact icon 3804 can direct the customer to a contact page for the delivery service and/or the originating business. The contact page can include contact information (e.g., phone number, email address, physical address). The customer contact icon 3804 can be a button icon as shown in FIG. 38, among other possible configurations.

The progress tracker 3806 can provide customers with updates on orders and delivery. The progress tracker 3806 can include a number of sub-steps. For example, the progress tracker 3806 can include received, preparing, en-route, at location, and complete. The sub-steps can be darkened upon completion, as shown in FIG. 38, wherein the received and preparing steps have been completed. Upon completion of each sub-step, the delivery tracking interface 3800 can provide a time and date at which the sub-step was completed. This is an example configuration, many other sub-steps, and functionalities of the progress tracker 3806 are possible.

The driver declaration 3808 can provide the customer with the declaration as completed by the deliverer. In some embodiments, the driver declaration 3808 can be removed based on an input from a user (e.g., organization manager).

Advanced Scheduling with Open Shifts

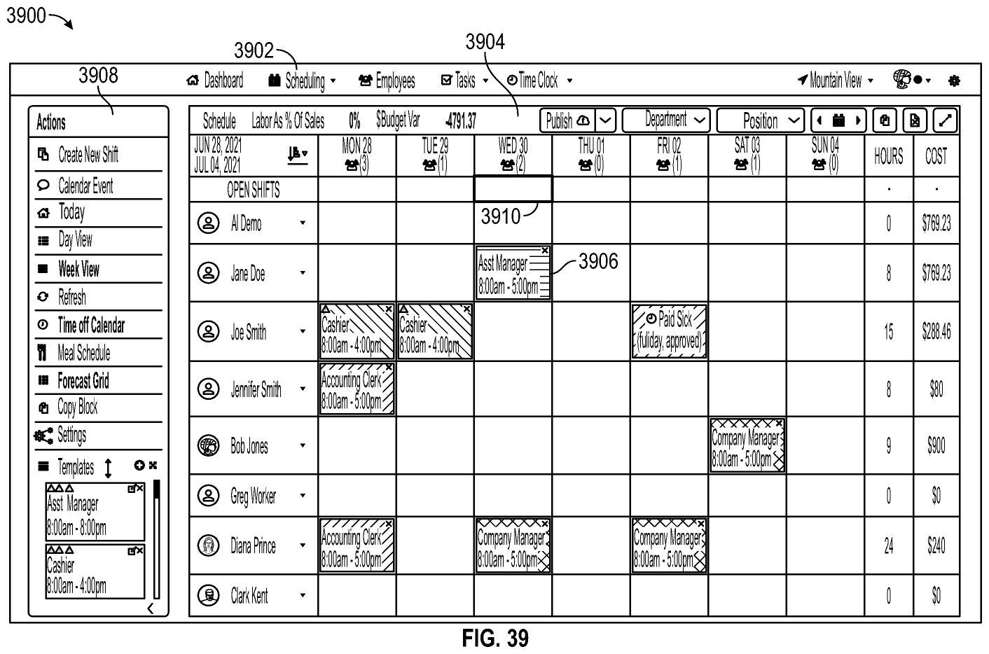

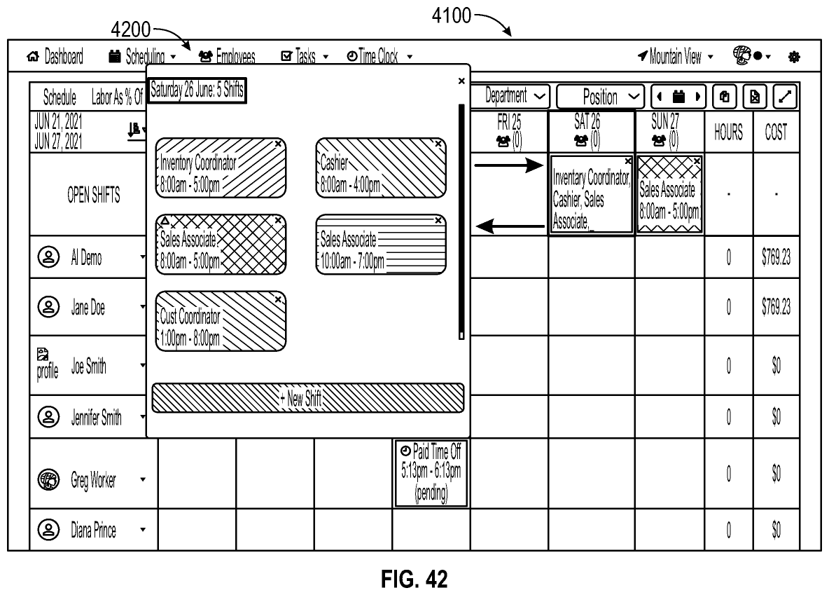

Referring generally to FIGS. 39-55, example interfaces for generating, manipulating, and/or assigning open shifts are shown, according to various embodiments. An open shift is a block of time (i.e., a time period) that is not assigned to a particular worker (e.g., a driver). In other words, an open shift is a period of time that is available for assignment to a worker or for a worker to select. As an example, a first worker may take vacation over a normally assigned shift, thereby creating an open shift that may ideally be filled by another worker. Advantageously, system 100 may provide user interfaces, such as those described below, which allow a worker to self-schedule by identifying and selecting open shifts, thereby saving a manager or other user time that would otherwise be spent assigning workers to shifts. In some embodiments, open shifts are available for all eligible workers to select. In some embodiments, open shift can be automatically assigned or a manager can choose to moderate which workers can select open shifts.

Any of the example interfaces described herein may be generated by user interface generator 120, for example, as described in detail above. More generally, system 100 may be configured to perform any of the functions and/or generate any of the interfaces described herein, although it will be appreciated that in some other embodiments, other systems, devices, etc. can perform the functions described below. For example, a remote computing system (e.g., a server) may perform certain functions and may communicate with system 100. All such implementations are contemplated herein.

Turning first to FIG. 39, an example interface 3900 is shown for managing schedules for multiple workers, according to some embodiments. In some cases, interface 3900 may be a landing page (i.e., home page) for a manager or other user that is permitted to view and alter worker schedules. In some embodiments, interface 3900 is presented in response to a user (e.g., a manager) logging into an account managed by system 100. In such embodiments, the account may include a plurality of permissions that enable the user to view and manage worker schedules. In some embodiments, interface 3900 is presented in response to a user selecting a “Scheduling” menu 3902. In such embodiments, selecting scheduling menu 3902 may cause a drop-down menu or other similar graphical element to appear that allows the user to select various scheduling options, including a “Manage Schedules” option for viewing interface 3900. In other embodiments, interface 3900 is presented in response to the user selecting a menu option from one of the other interfaces described above. For example, interface 3900 may be presented in response to a user selection from menu 1914.

After choosing the “Manage Schedules” option from scheduling menu 3902, interface 3900 may be populated with a schedule 3904 that indicates scheduled shifts and other scheduling elements (e.g., days off, sick days, etc.) for a plurality of employees. As shown, assigned shifts are represented as tiles indicating a position associated with the shift (e.g., manager, cashier, driver, etc.) and a start/stop time for the shift. Using tile 3906 as an example, a worker named Jane Doe is assigned a shift as an Assistant Manager from 8:00 am to 5:00 pm on Wednesday, June 30^{th}. As another example, Joe Smith is shown as working two shifts as a cashier on Monday, June 28^{th} and Tuesday, June 29^{th}, and is shown to have scheduled sick leave on Friday, July 2^{nd}. Interface 3900 may also indicate open shifts, which are displayed along the top row of schedule 3904 in this example.

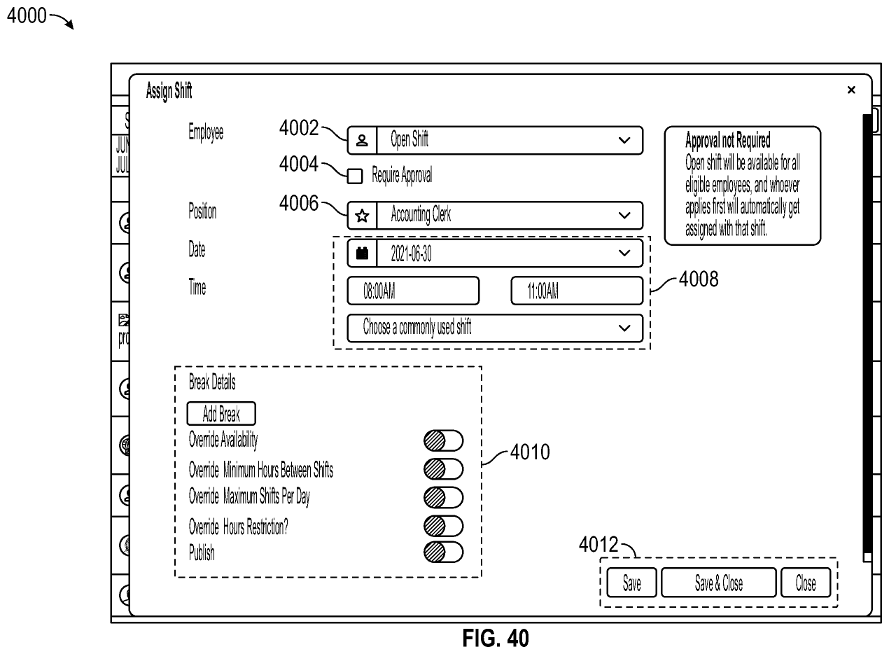

To generate an open shift, a user can select the “Create New Shift” option from “Actions” menu 3908. With additional reference to FIG. 40, selecting the “Create New Shift” option may cause a shift assignment interface 4000 to be presented. In some embodiments, such as in the example shown, shift assignment interface 4000 is presented as a pop-up window or an overlay to interface 3900. However, in other embodiments, shift assignment interface 4000 may be presented as a separate interface or the functionality of shift assignment interface 4000 may be included in interface 3900. In any case, shift assignment interface 4000 may allow the user (e.g., a manager) to assign shifts to workers. In this manner, shift assignment interface 4000 may be similar to or the same as interface 2600 described above.

In particular, a user may select a previously defined worker from an “Employee” menu 4002, which may be a drop down menu or other similar graphical element. To specifically create an open shift, the selected worker may be “Open Shift.” The user may then select “Approval” check box 4004 if they wish to require manager approval for requested/selected shifts. In some embodiments, open shifts may default to no approval (e.g., if approval check box 4004 is not selected), thereby allowing any worker who requests/selects the shift to automatically be assigned the open shift. In some such embodiments, the open shift is assigned on a first-come-first-serve basis. In other words, the first worker to select the open shift is automatically assigned. If approval check box 4004 is selected, eligible workers may only request an open shift pending manager approval.

In addition to defining worker and approval requirements, the user may also define a position associated with the open shift via a “Position” menu 4006. More specifically, the user may select a predefined position or role, as described in detail above, from position menu 4006. In this example, the open shift is for an accounting clerk position. The user may also define a date, start time, and stop time via “Date/Time” menus 4008. Additional shift details can be selected via menu 4010. For example, the user may add a scheduled break, may override worker availability or hours restrictions, etc. Finally, the user may save, save and close, or close (e.g., without saving) the new opened shift via icons 4012. Once shift assignment interface 4000 is fully populated and the open shift is saved, closing shift assignment interface 4000 may cause a modified version of interface 3900 to be presented that indicates the open shift as a tile (e.g., similar to tile 3906) within the “Open Shifts” row. For example, the example open shift created in shift assignment interface 4000 may be displayed as a tile within block 3910 of the “Open Shifts” row.

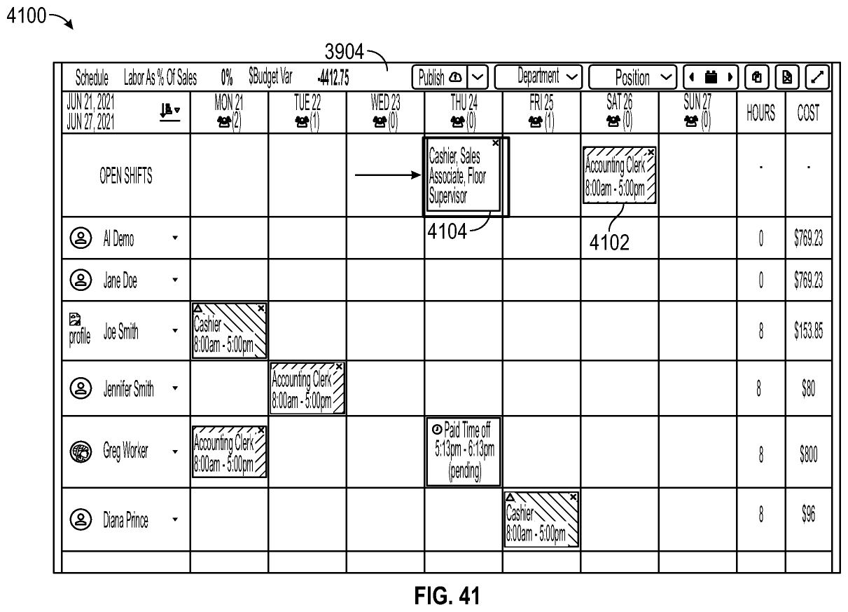

Referring now to FIGS. 41-46, example interfaces for viewing and organizing open shifts are shown, according to some embodiments. Turning first to FIG. 41, an example interface 4100 is shown that includes a copy of schedule 3904 that is updated to include a plurality of open shifts. Interface 4100 may be generated and presented, for example, in response to a user generating one or more open shifts using the processes described above with respect to FIGS. 39 and 40. As shown, interface 4100 includes a first open shift tile 4102 for an accounting clerk on Saturday, June 26^{th}. In some embodiments, open shift tile 4102 is color-coded or otherwise differentiated (e.g., shade, pattern, size, etc.) from the other shift tiles based on the position type (e.g., accounting clerk, cashier, driver, manager, etc.) or based on any other parameter. In this example, open shift tile 4102 is colored red based on the position type to match the color of other shift tiles for accounting clerks.

In some embodiments, a user may create multiple open shifts on a given day or for a particular time period. In such embodiments, the multiple open shifts may be represented by a single shift tile, shown as open shifts tile 4104, which may also be color-coded or otherwise differentiated (e.g., via shade, pattern, size, etc.) from the other shift tiles. In this example, open shifts tile 4104 is a neutral-colored tile (e.g., grey) which can, in some embodiments, also indicate the position types associated with the open shift (e.g., cashier, sales associated, floor supervisor).

In some embodiments, selecting an open shift tile that includes multiple shifts (i.e., selecting open shifts tile 4104), such as by double-clicking the open shift tile, causes a “multiple open shifts” interface 4200 to be presented. In some such embodiments, multiple open shifts interface 4200 is presented as a pop-up or an overlay to interface 4100, or multiple open shifts interface 4200 may be presented as an individual interface. From multiple open shifts interface 4200, the user can view all of the open shifts on a given day. In this example, Saturday, June 26^{th} has five open shifts for an inventory coordinator, a cashier, two sales associates, and a customer coordinator. The user may be able to select any of the open shifts to view more information or, if the user has sufficient permissions, to edit or otherwise modify the associated open shift. For example, the user can select the open cashier shift to change a start/end time for the shift, or to change other shift information. In some embodiments, a user can add new open shifts to the selected day by selecting a “New Shift” icon from multiple open shifts interface 4200.

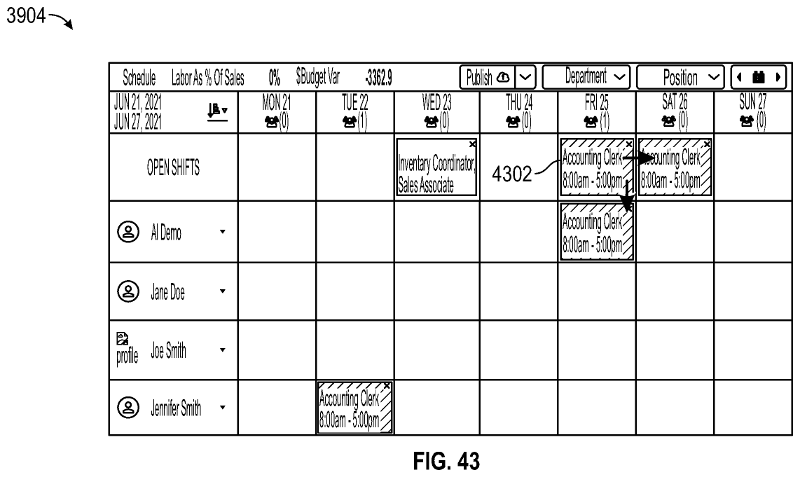

Advantageously, the interfaces described herein may allow a user to quickly and easily copy, move, or otherwise manipulate shift tiles to build schedules. In some embodiments, a user may select a “Copy Block” option from actions menu 3908 in order to copy previously generated shift tiles (i.e., blocks) to other days or workers. As shown in FIG. 43, for example, a user has copied tile 4302 to two additional spaces. In particular, tile 4302 has been copied as an open shift on Saturday, June 26^{th} and has been copied as an assigned shift to worker Al Demo on Friday, June 25^{th}. More generally, in some embodiments, the “Copy Block” function allows the user to copy single or multiple open shifts to other cells in the “Open Shifts” row of schedule 3904, to copy a regular (i.e., assigned) shift to the “Open Shifts” row, and/or to copy (i.e., assign) an open shift to a particular worker.

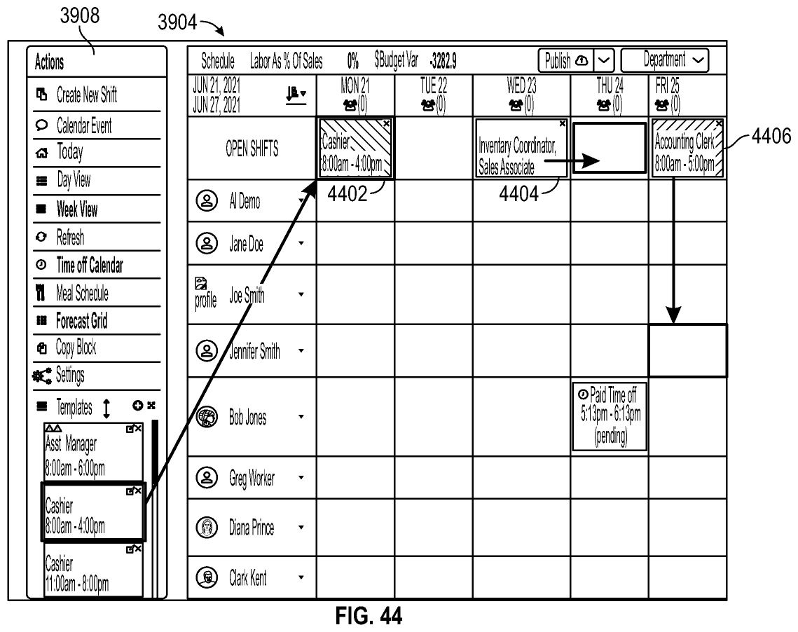

Turning now to FIG. 44, the user may also be able to easily organize and manage schedules by drag-and-drop shift tiles. For example, the user may move shift tiles between users to reassign the corresponding shift. In some embodiments, a user can select a pre-generated shift template tile 4402 from a “Templates” section of actions menu 3908, and can drag the selected tile 4402 to an available block in schedule 3904. In the example shown, tile 4402 is dragged and dropped in an “Open Shifts” block on Monday, June 21^{st}, thereby establishing an open shift on that date. As described herein, pre-generated shift templates can be generated in a similar manner to other shifts, as described above. For example, a user may define a start and end time for a shift, along with a position and other shift parameters (e.g., hours overrides, breaks, etc.), without assigning the shift to a particular worker and/or without setting a particular day for the shift. In this regard, shift templates may be easily applied (e.g., by dragging-and-dropping) to open blocks in schedule 3904 as shown. In some embodiments, actions menu 3908 also includes an icon that can be selected for defining shift templates.

In some embodiments, the user can drag-and-drop tiles within the same row of schedule 3904. For example, in FIG. 44 the user has selected multiple open shift tile 4404 and has dragged tile 4404 to an open block on the following day. In some embodiments, the user can drag-and-drop open shift tiles from the “Open Shifts” row to the schedules of individual workers. For example, the user has selected an open “Accounting Clerk” tile 4406 and has dropped tile 4406 in the schedule of Jennifer Smith, thereby assigning that shift to Jennifer. Likewise, shifts associated with particular workers can be dragged-and-dropped in the “Open Shifts” row to un-assign the shift from the particular worker.

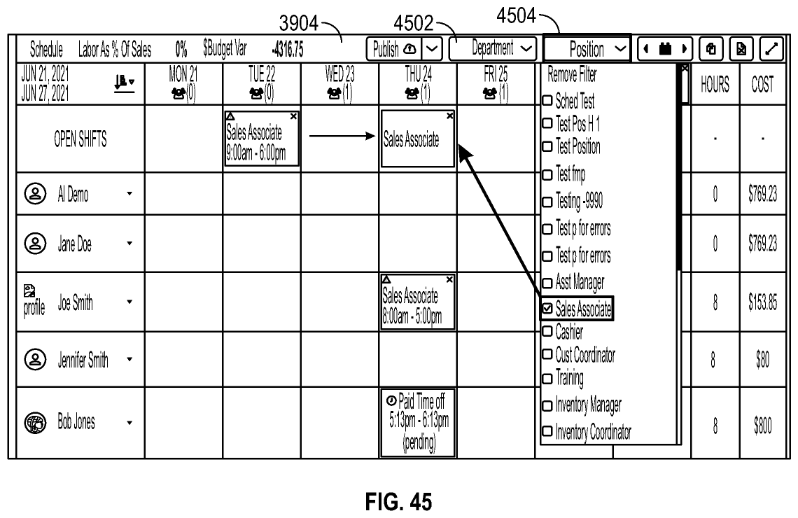

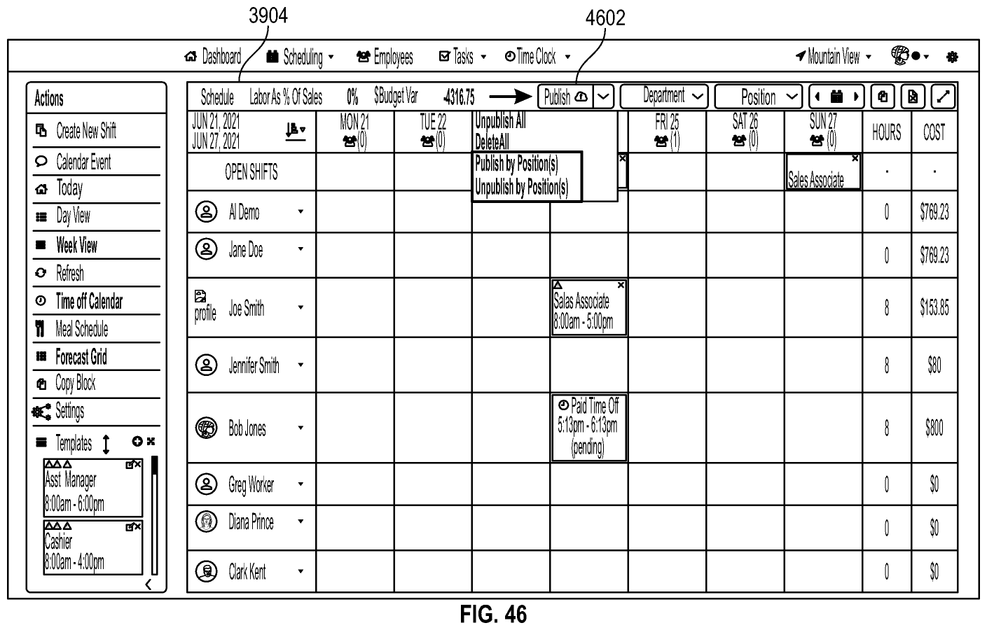

In some embodiments, a user can filter the tiles shown in schedule 3904 by selecting a “Department” menu 4502, a “Position” menu 4504, or by identifying another filtering parameter (not shown). As shown in FIG. 45, the user has selected menu 4504, in this case a drop-down menu, and has chosen to view only shift tiles associated with a “Sales Associate” position. In response, schedule 3904 may be filtered to remove any shift tiles that are not associated with sales associate positions. In some embodiments, the user can also choose to publish and/or unpublish selected shifts via a “Publish” menu 4602 (e.g., shown in FIG. 46). Publishing a shift may make the shift visible to all users of system 100, including workers, who may not otherwise have sufficient permissions to view certain shift details. For example, a first worker may not be able to view the schedule of a second worker if the second worker's shifts are not published; however, a manager may be able to view all of the assigned shifts and/or may be able to publish certain shifts (e.g., the manager may publish all shifts for a one or two-week period). In some embodiments, menu 4602 allows the user to publish or unpublish all shift associated with a particular position.

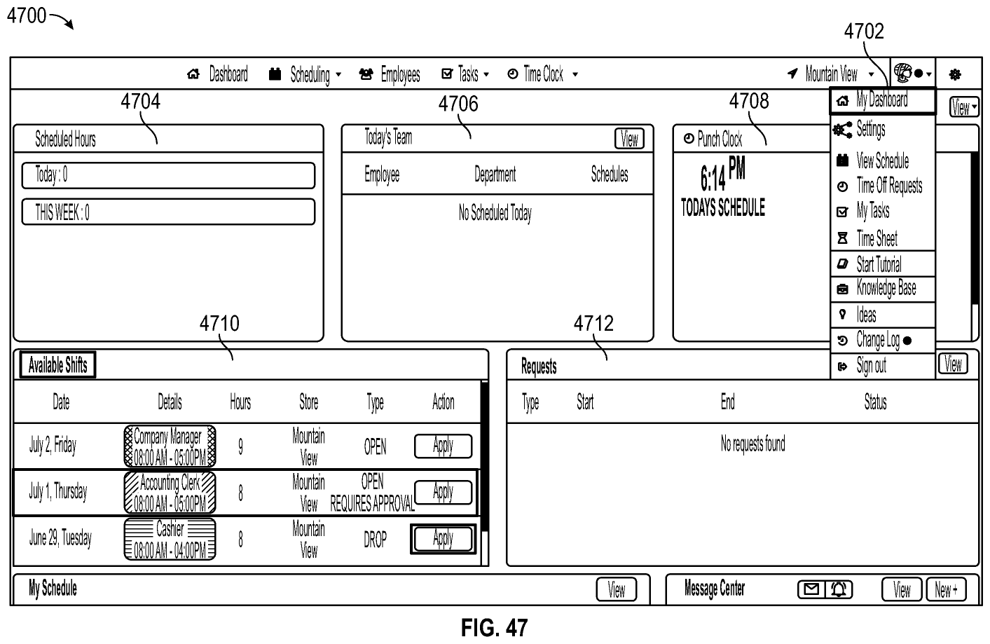

Referring now to FIGS. 47-50B, example interfaces for requesting (i.e., applying to) open shifts are shown, according to some embodiments. In particular, a worker or other user may request or apply to available open shifts. In some cases, workers may only apply for open shifts that have been published by a manager, as described above. In some embodiments, workers may sign up, such as when establishing an account as described above, to receive email, SMS, or push notifications when open shifts are available (e.g., published). The workers may access the open shifts via a mobile or web-based application, or by another method, in order to apply for or request an open shift. Additional details of the open shift request process are described in greater detail below.

Turning first to FIG. 47, an example interface 4700 is shown for viewing and requesting open shifts. In some embodiments, interface 4700 is a web-based interface (e.g., presented in a web browser) that can be accessed from any Internet-enabled device, such as a personal computer. In some embodiments, interface 4700 is generated by user interface generator 120 and displayed via user device 134. In any case, interface 4700 may be a landing page or “dashboard” for a particular worker or other user (e.g., a manager) to manage assigned shifts and request additional shifts. In some embodiments, a user can navigate to interface 4700 from another interface by selecting a “My Dashboard” option from menu 4702.

Interface 4700 is shown to include a number of graphical elements for managing a schedule and/or shifts for an individual user (e.g., a worker). A “Scheduled Hours” menu 4702 may indicate a number of hours that the user is scheduled to work the current day or over the current week. In some embodiments, the schedule hours are determined based on the user's assigned shifts. For example, a user with a single shift from 9:00 am to 5:00 pm may be scheduled for eight hours. The user may also be able to view other workers with overlapping shifts or workers that have shifts on the same day as the user via a “Team” menu 4706. In team menu 4706, the user may view scheduled workers, their corresponding departments, and/or the hours that each worker is scheduled for that day.

A punch clock 4708 may indicate the current time and may allow a user to clock-in and/or clock-out of a shift. For example, punch clock 4708 may include “Clock In” and/or “Clock Out” buttons (not shown) that a user can select to record the start and/or end of their shift, and/or to record breaks. An “Available Shifts” menu 4710 can display any open shifts that were previously generated by a manager, as described above. In this example, three open shifts are shown, along with details of each shift. The highlighted shift, for example, is 8:00 am to 4:00 pm on Thursday, July 1^{st} for an accounting clerk. Also indicated are the total number of hours for the shift (e.g., “8”), a store identifier (e.g., “Mountain View”), and/or a shift type (e.g., “Open—Requires Approval”). The user may apply for an open shift by selecting an “Apply” button in shifts menu 4710.

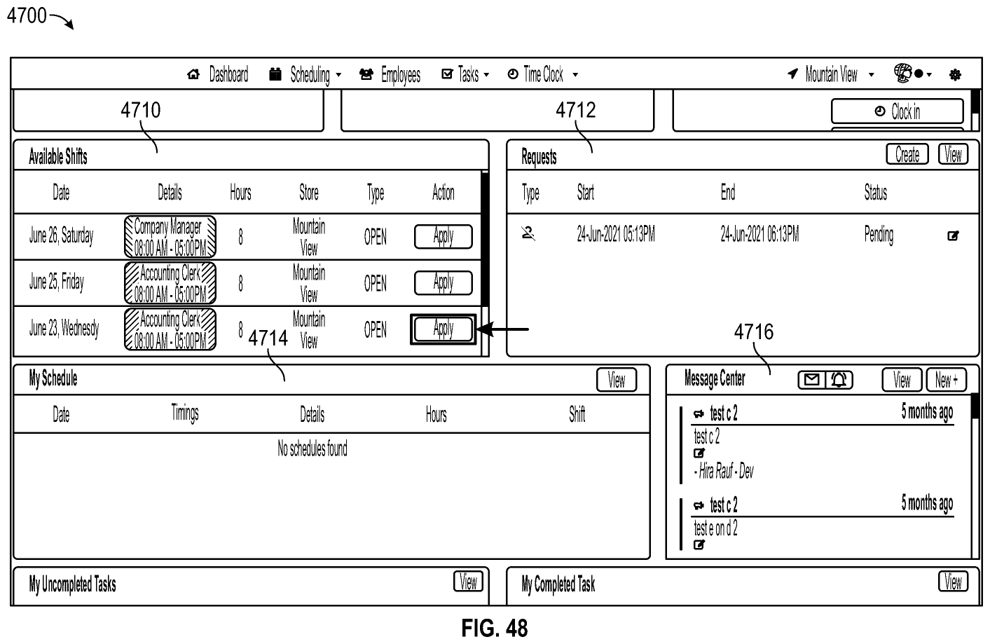

In some embodiments, a manager can require approval for open shift requests, as described above with respect to FIG. 40. In such embodiments, multiple workers may apply for the same open shift, pending review and approval by the manager. Accordingly, after selecting an application button in shifts menu 4710, a requested open shift may be added to a “Requests” menu for the user, as shown in FIG. 48. Menu 4712 may present a type, start and end time, and/or status of various requests. In some embodiment, menu 4712 may also allow the user to create other requests, such as requests for time off due to vacation, sickness, etc. In some embodiments, in addition to or in place of adding a request to menu 4712, the selected “Apply” button may change color, pattern, shade, etc., to differentiate the select button from the other unselected buttons. For example, after applying to an open shift, the associated “Apply” button may change to a red color and may display “Cancel,” allowing the user to cancel the request to take the open shift.

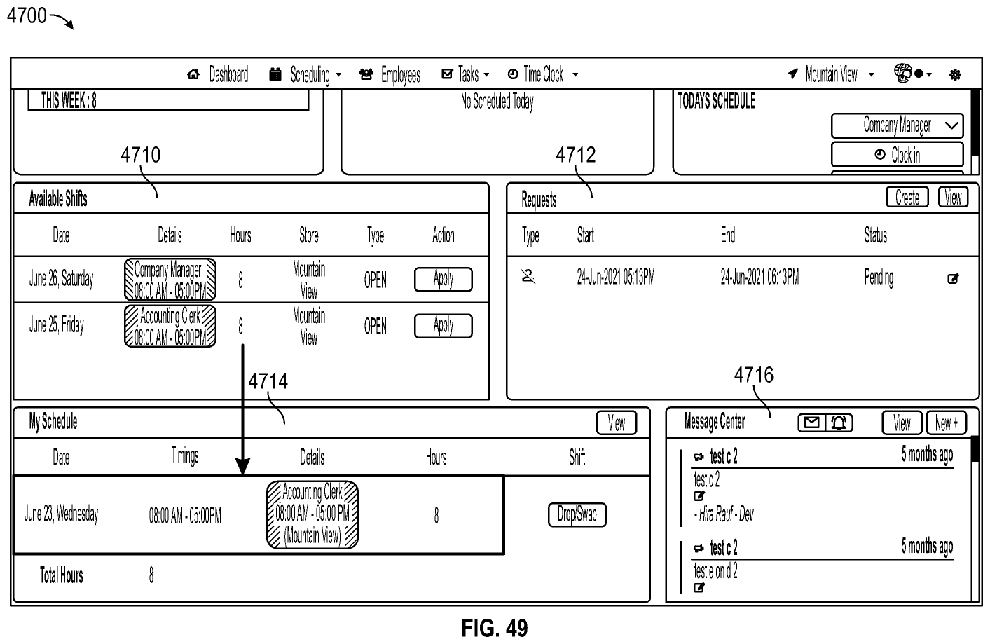

In cases where a manager does not require approval for open shift requests or after a manager has approved of a request, the selected open shift may be added to a user's schedule, as shown in FIG. 49. In this example, an accounting clerk shift was selected from shifts menu 4710 and is subsequently populated in a “My Schedule” menu 4714. Once assigned to the requesting user, the user may drop and/or swap the shift, if needed. For example, the user may determine that they are busy during the shift time and may choose to drop the shift. In this case, the shift may once again become an open shift, thereby allowing other workers to request the open shift. In some embodiments, a manager may be alerted when a worker drops a shift so that the manager can reassign the shift. Swapping the shift may allow the user to switch the selected shift with another open shift and/or with a shift of another user. In some embodiments, the user may also be able to send and receive messages (e.g., relating to shifts) via a messaging center 4716.

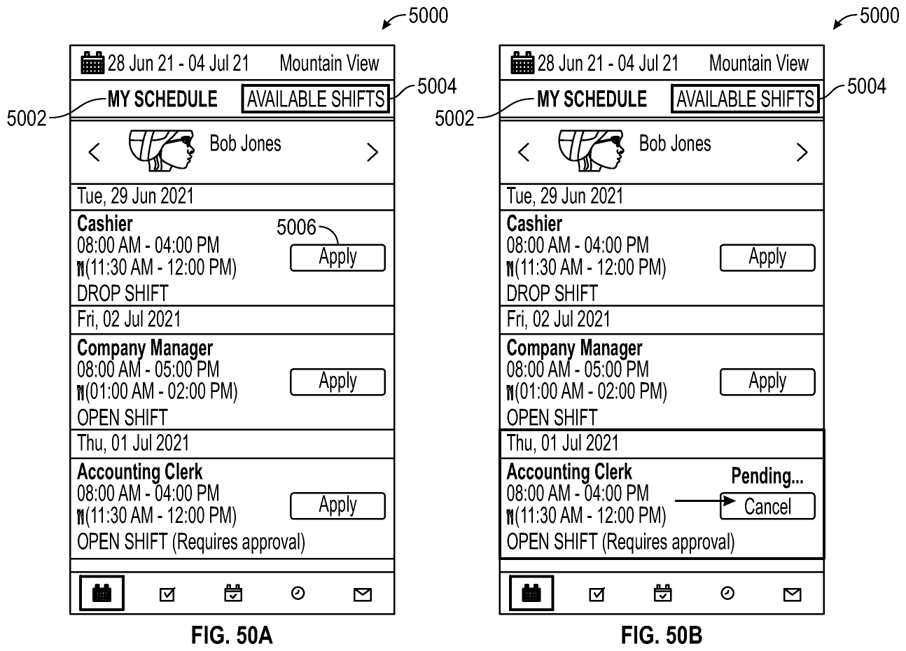

Turning now to FIGS. 50A and 5B, another example interface 5000 is shown for applying to open shifts via a mobile application. In other words, interface 5000 may be presented via a user's mobile device, such as a smartphone, allowing the user to view and apply for open shifts on-the-go. Additionally, the mobile application associated with interface 5000 may allow the user to receive push notifications for open shifts, for example. In some embodiments, a user may select a “My Schedule” tab 5002 from interface 5000 in order to view and/or modify their currently assigned shifts, as described above with respect to FIGS. 28-31.

Selecting an “Available Shifts” tab 5004 can cause interface 5000 to present open shifts. In this example, the user is presented with three open shifts (e.g., cashier, company manager, accounting clerk) for different dates and times. For example, the open cashier position is on Tuesday, June 29^{th} from 8:00 am to 4:00 pm with a half hour lunch break. The user may apply to an open shift by selecting an application button 5006. If a selected shift is not subject to manager approval, the shift may be automatically added to the user's schedule. However, if manager approval is required, application button 5006 may be replaced with a “Cancel” button for canceling the request and the request may be indicated as pending, as shown in FIG. 50B. In some embodiments, if a manager denies a request, the associated open shift may be removed from interface 5000.

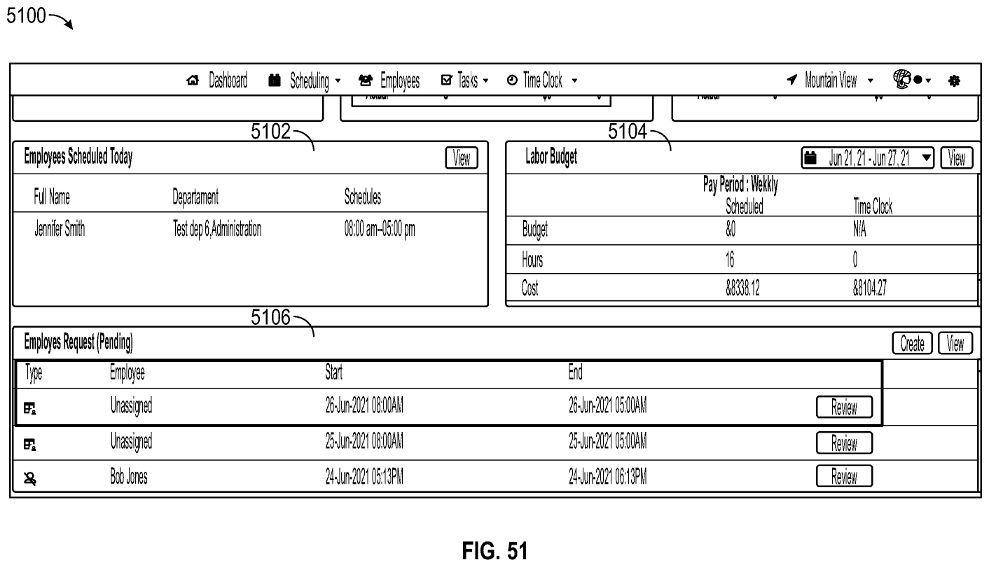

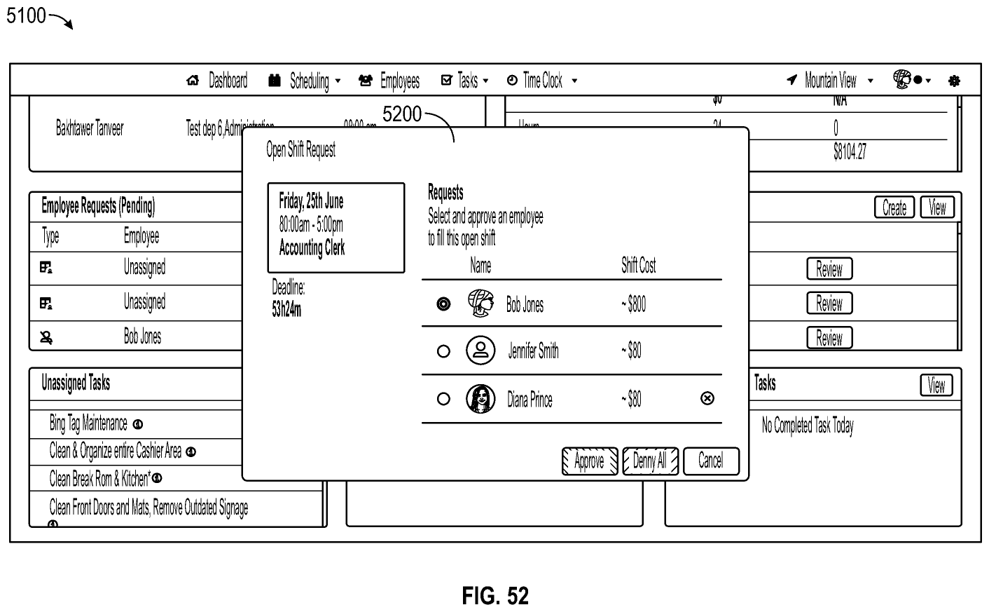

Referring now to FIGS. 51 and 52, example interfaces for managing shift requests are shown, according to some embodiments. Turning first to FIG. 51, an example interface 5100 is shown, which may be a dashboard for a manager to review pending shift requests, along with other scheduling information. As shown, interface 5100 may include a “Schedule” menu 5102 for viewing workers that are scheduled for the current day. Schedule menu 5102 may include an indication of each worker's department and scheduled start and end times. A “Labor Budget” menu 5104 may allow the user to view budget information (e.g., budget, cost, scheduled hours) for a business over a defined time period, such as a week.

Requests for open shifts may be presented in a “Pending Requests” menu 5106. Each request entry may indicate a request type, an assigned worker (if applicable), a start and end time/date for the shift, and a review button that allows the user (e.g., a manager) to review the request in detail. In some embodiments, requests menu 5106 may also indicate unassigned open shifts (e.g., shifts without a request). Selecting a review button for a shift may cause a pop-up window or overlay to be presented over interface 5100. As shown in FIG. 52, an example interface 5200 may be presented that includes details about the selected open shift. Interface 5200 may indicate a date, time, and/or position associated with the open shift, along with an acceptance deadline for filling the open shift. Additionally or alternatively, if workers have applied for the open shift, interface 5200 may include a list of eligible workers. In some embodiments, interface 5200 may include a shift cost associated with each worker. Shift cost may be calculated based on the worker's hourly salary, for example, multiplied by the number of hours for the open shift. In this example, Bob Jones is significantly more expensive that the other available worker; however, Bob may be a better fit for the position. In any case, the user may select a worker to assign the open shift to and may approve of the open shift request, and/or may deny all of the worker's requests. In some embodiments, the user may be able to deny specific workers by hovering over the worker's row on interface 5200 and selecting an icon (e.g., an x button).

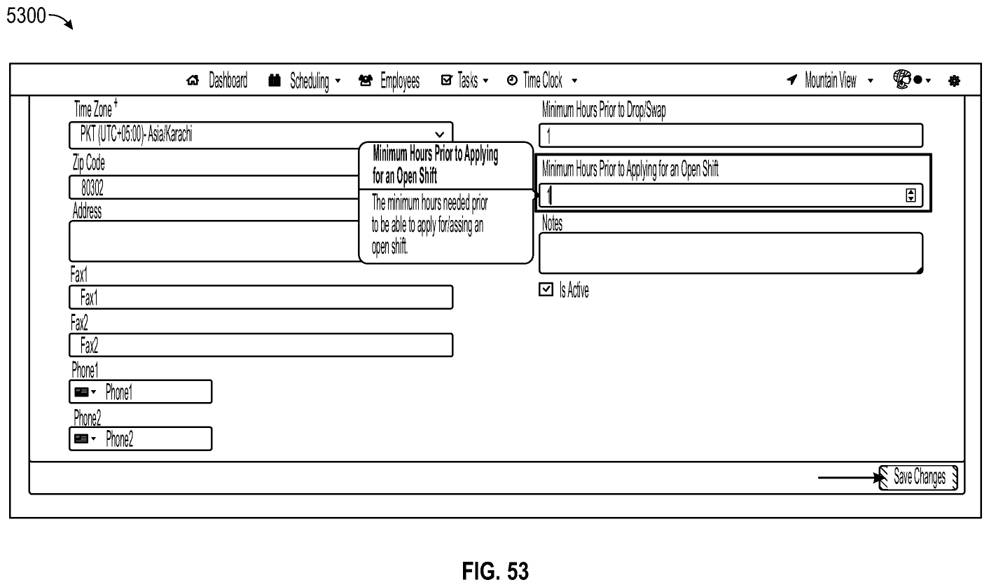

Referring now to FIG. 53, an example interface 5300 for establishing acceptance deadlines for open shifts are shown, according to some embodiments. An acceptance deadline may be a deadline or a period of time that workers have to apply for an open shift and/or that the manager has to select a particular worker for the shift. In some embodiments, an acceptance deadline is a number of hours before a shift start time in which the open shift will be available for workers to apply. Interface 5300 may be associated with a business profile or settings page, which defines general information for the business such as address, zip code, phone and fax numbers, etc.; however, as shown, interface 5300 may also include a field for defining a minimum number of hours prior to a shift start time that users (e.g., workers) can drop, swap, and/or apply for shifts.

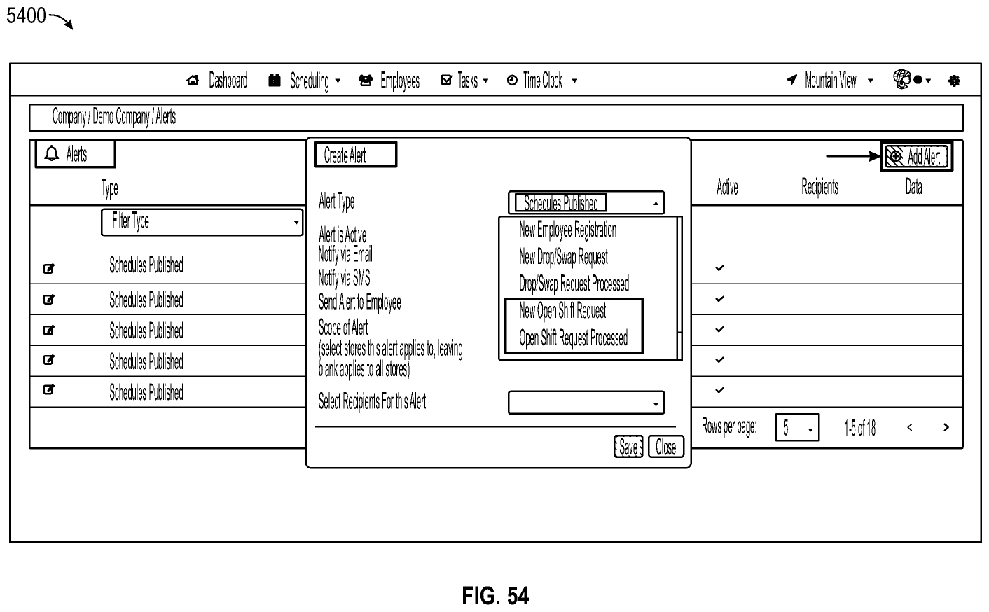

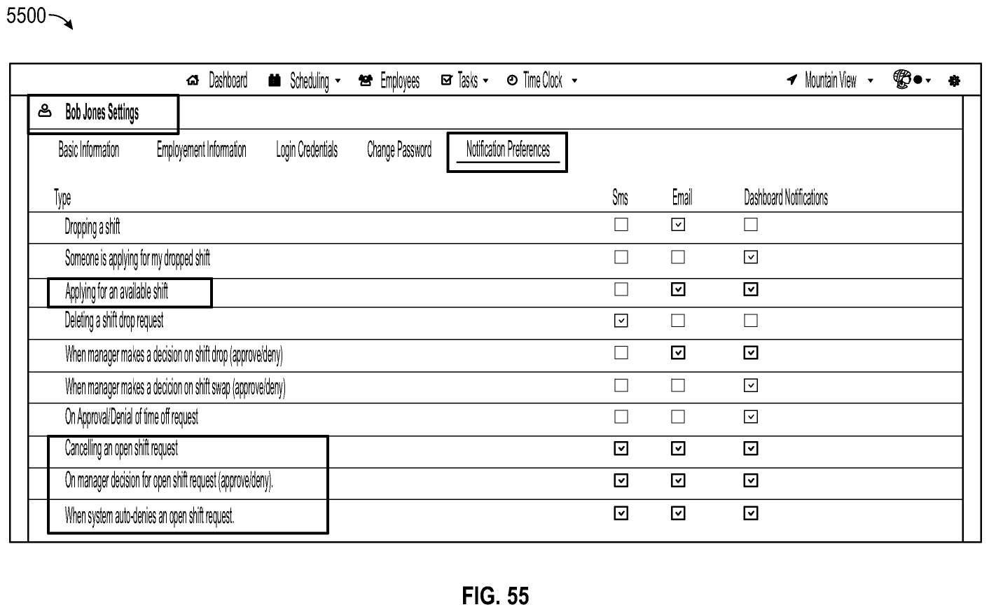

Referring now to FIGS. 54 and 55, example interfaces for generating open shift notifications are shown, according to some embodiments. In particular, FIG. 54 shows an example interface 5400 for establishing open shift alerts for a manager while FIG. 55 shows an example interface 5500 for establishing open shift alerts for a worker. Turning first to FIG. 54, interface 5400 may be presented as a pop-up window or overlay over an alerts page, which the manager may use for establishing different schedule-related alerts. A manager may establish a new alert by first selecting an alert type from a drop down menu. As shown, alerts can be generated for new employee registrations, drop/swap requests, and/or open shift requests, among others. For a new open shift request alert, recipients will be sent an email, text message, and/or push notification when someone applies for an open shift that is associated with a shift inside the scope of the alert. For an open shift request processed alert, recipients will be sent an email, text message, and/or push notification when a manager approves/denies a shift request.

To establish a new open shift request alert or an alert when an open shift request is processed, the user may select one of these two options from the menu. The user may then select check boxes and/or radio buttons to define whether the alert is issued via email, SMS, both, and/or by another method. The user may also choose to send a corresponding alert to associated workers (e.g., the workers that request the open shifts) and may select specific recipients for the alert, if needed. Additionally, the user may define a scope of the alert. The scope of the alert may be a store or multiple stores that the alert is applicable to.

Turning now to FIG. 55, interface 5500 for setting notification preferences for an individual user (e.g., Bob Jones) is shown, according to an example embodiment. In this example, Bob may select various checkboxes or similar graphical elements to choose whether to receive SMS, email, or push (i.e., dashboard) notifications for various alert types. For example, Bob has selected to receive email and push notifications when applying for an available shift and has chosen to receive alerts via all available communications paths when canceling an open shift request, when a manager approves/denies a request, or when a request is auto-denied.

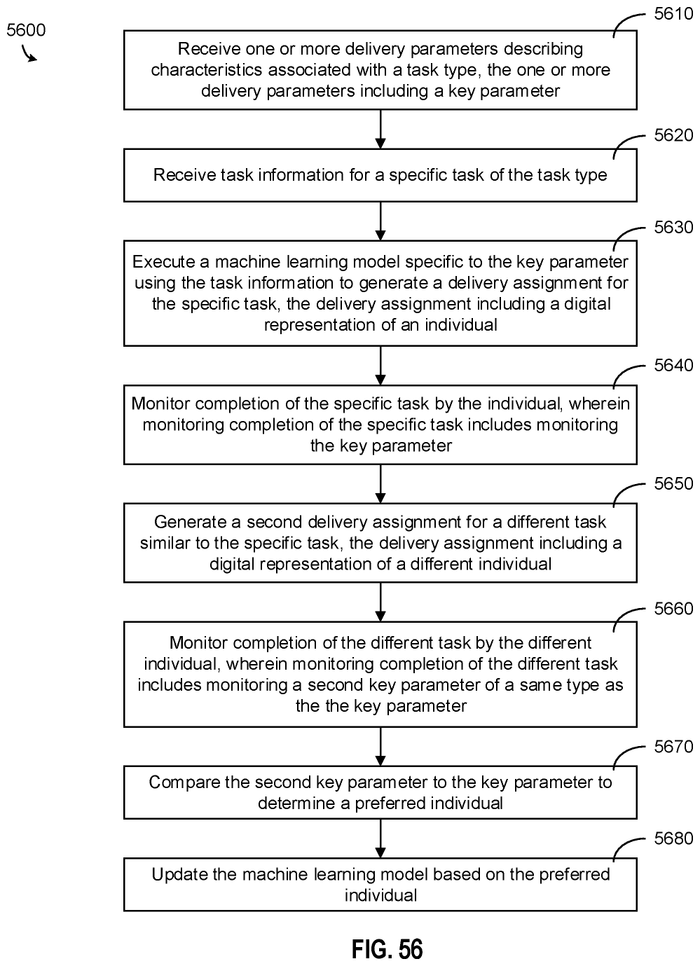

Turning now to FIG. 56, method 5600 for assigning a deliverer to a delivery is shown, according to an exemplary embodiment. In various embodiments, system 100 performs method 5600. At step 5610, system 100 may receive one or more delivery parameters describing characteristics associated with a task type. In various embodiments, the one or more delivery parameters include a key parameter. For example, the one or more delivery parameters may include a transportation time, a package size, a fragility of a package, and/or the like. As an additional example, the key parameter may include a travel time (e.g., how long is the package in transit), a total time (e.g., how long before the package arrives at a destination, etc.), and/or the like. In various embodiments, the task type may describe a category of tasks. For example, the task type may be a food delivery, a parcel delivery, an organ delivery, and/or the like. As another example, the task type may be an ice cream delivery, a hot food delivery, a soup delivery, and/or the like. Additionally or alternatively, the task type may include a description of the origin of the task. For example, the task type may include a task originating from a specific business.

At step 5620, system 100 may receive task information for a specific task of the task type. For example, system 100 may receive a delivery task for a delivery of a food item from a pickup location to a drop-off location during a specific time period. In some embodiments, step 5620 includes retrieving information associated with a location of the specific task from an external source. For example, system 100 may query a third party API to retrieve information such as a road conditions, weather conditions, and/or the like. In various embodiments, step 5620 includes updating the task information based on the information retrieved from the external source. For example, system 100 may update a delivery route of the task information based on Department of Transportation (DoT) API data indicating that a road on a previous route is under construction to reroute the delivery through smoother roads that will prevent produce from being bruised in transit.

At step 5630, system 100 may execute a machine learning model specific to the key parameter using the task information to generate a delivery assignment for the specific task. In various embodiments, the delivery assignment includes a digital representation of an individual. For example, system 100 may assign one or more individuals to one or more deliveries using the machine learning model. In various embodiments, step 5630 includes optimizing the assignment of individuals to deliveries based on requirements of each delivery (e.g., the task information) and characteristics of each individual (e.g., a cargo capacity of a vehicle of an individual, a geographic knowledge of an individual, a delivery history of an individual, a customer satisfaction rating of an individual, an availability of an individual, etc.).

In some embodiments, generating the delivery assignment includes retrieving a plurality of delivery characteristics associated with a plurality of deliverers. For example, system 100 may query a database including a plurality of digital representations of deliverer and may retrieve deliverer characteristics such as vehicle type, delivery history, customer satisfaction rating, compensation, timeliness, speed, availability, skill-set, and/or the like corresponding to a deliverer. In various embodiments, step 5630 includes generating a deliverer description for each deliverer. The deliverer description may be a weighted function that describes how well-suited a deliverer is to a specific delivery assignment based on the characteristics of the deliverer and the parameters of the delivery (e.g., does the deliverer have experience navigating in a neighborhood that the delivery location is located in, etc.). In various embodiments, generating the deliverer description includes weighting one or more of a plurality of deliverer characteristics based on delivery parameters associated with a specific delivery assignment. For example, system 100 may generate a weighted function (e.g., y=ax+by+cz, etc.) that reflects the importance of various delivery parameters and may compute the weighted function using each deliverer's characteristics (e.g., where the deliverer characteristics are values in a range, where the deliverer characteristics are discrete values such as binary, etc.). In various embodiments, step 5630 includes selecting an identifier of a deliverer based on the scores for each of the plurality of deliverers. For example, system 100 may select a deliverer having the highest score as computed from the deliverer description.

At step 5640, system 100 may monitor completion of the specific task by the individual, wherein monitoring completion of the specific task includes monitoring the key parameter. For example, system 100 may track a delivery driver via GPS as the delivery driver completes a delivery. In some embodiments, system 100 receives sensor data and uses the sensor data to monitor the key parameter. For example, system 100 may receive sensor data from a vibration sensor (e.g., deployed within a vehicle of the deliverer, etc.) or a timer function and use the sensor data to determine a key parameter such as “amount of vibration.” In some embodiments, step 5640 includes normalizing the key parameter against other values of the key parameter for similar delivery assignments. For example, system 100 may normalize a delivery time onto a scale of 1-100 to place the delivery time in comparison with delivery times for similar delivery assignments.

In various embodiments, system 100 updates the machine learning model by A/B testing the machine learning model to control a key parameter such as delivery time. For example, at step 5650, system 100 may generate a second delivery assignment for a different task similar to the specific task. In various embodiments, the delivery assignment includes a digital representation of a different individual. For example, system 100 may identify two similar tasks and may perform an A/B test using the two similar tasks by assigning a first individual having a first set of deliverer characteristics to the first task and a second individual having a second set of deliverer characteristics that are similar to the first set of deliverer characteristics, except for a single deliverer characteristic, to determine which set of deliverer characteristics to use for that type of task in the future.

At step 5660, system 100 may monitor completion of the different task by the different individual. For example, system 100 may monitor a delivery of a package using geolocation data from a user device of a deliverer performing the delivery. In various embodiments, monitoring the completion of the different task includes monitoring a second key parameter of a same type as the key parameter. For example, system 100 may monitor a delivery time associated with a first delivery and may monitor delivery time associated with a second delivery. In various embodiments, system 100 isolates the effects of individual variables using A/B testing to determine the optimal assignment of deliverers to delivery tasks.

At step 5670, system 100 may compare the second key parameter to the key parameter to determine a preferred individual. For example, system 100 may compare a delivery time for a first task completed by a first individual to a delivery time for a second task completed by a second individual to determine which individual had the faster delivery time. In various embodiments, step 5670 includes determining preferred deliverer characteristics based on the comparison (e.g., by selecting the characteristics associated with the deliverer that performed better on the comparison of the key parameter, etc.).

At step 5680, system 100 may update the machine learning model based on the preferred individual. For example, system 100 may update one or more weights associated with a neural network to bias the neural network towards the preferred individual for future deliveries having similar delivery parameters. In various embodiments, step 5680 includes executing an A/B test to analyze the delivery assignment. For example, system 100 may identify two similar delivery assignments and may assign different deliverers to the two delivery assignments and may compare a delivery time associated with each of the two delivery assignments to delivery which delivery assignment performed best (e.g., had the lowest delivery time, etc.). Additionally or alternatively, the A/B test may analyze other parameters. For example, the A/B test may analyze a deliverer vehicle type, deliverer route, and/or the like. In various embodiments, system 100 updates the machine learning model based on the A/B test. For example, system 100 may compare a first key parameter (e.g., delivery time, etc.) from a first delivery to a second key parameter (e.g., delivery time, etc.) from a second delivery to determine a preferred deliverer (e.g., the deliverer that performed the best, etc.) and may update the machine learning model to favor deliverers having similar characteristics as the preferred deliverer for similar delivery assignments in the future.

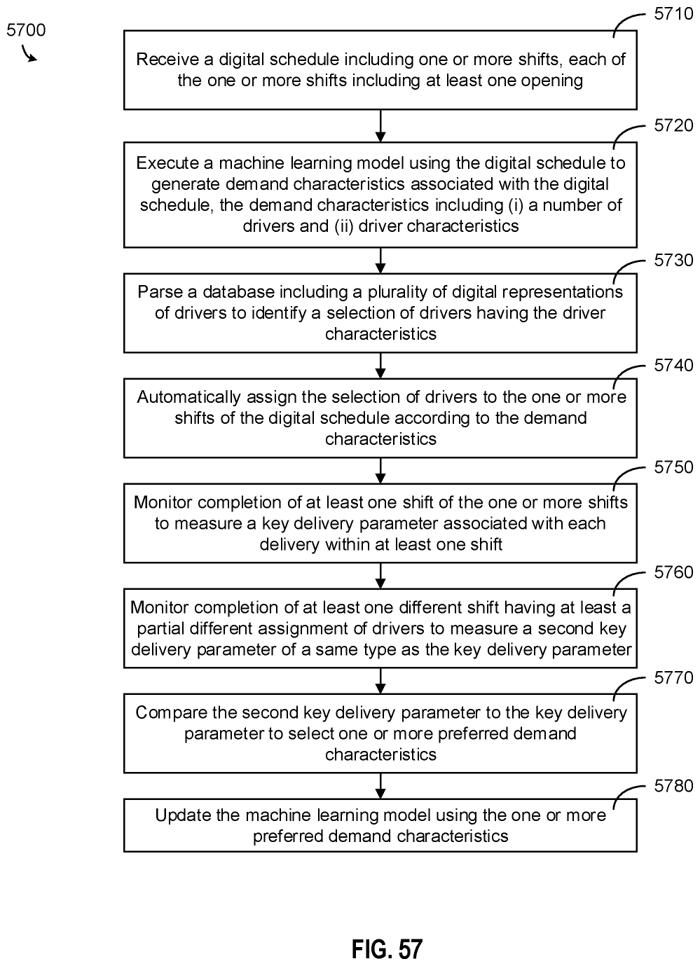

Turning now to FIG. 57, method 5700 for generating a schedule is shown, according to an exemplary embodiment. In various embodiments, system 100 performs method 5700. At step 5710, system 100 may receive a digital schedule including one or more shifts. In various embodiments, each of the one or more shifts includes at least one opening (e.g., a slot in the schedule that a worker can fit into, an unclaimed shift, etc.). For example, system 100 may receive a digital schedule for allocating a number of delivery drivers to service delivery requests from a number of businesses over the course of a week. As another example, system 100 may receive a digital schedule for a hardware store having a number of different roles (e.g., stocker, salesperson, checkout clerk, etc.).

At step 5720, system 100 may execute a machine learning model using the digital schedule to generate demand characteristics associated with the digital schedule. The demand characteristics may include a number of drivers, driver characteristics, a number of worker hours, an amount of workers of each specific role, an amount of inventory to have in stock, and/or the like. In various embodiments, the machine learning model is trained on historical data associated with the digital schedule. For example, the machine learning model may be trained on the last five years of digital schedule data and/or the result of the last five year of digital scheduling (e.g., was demand met, were deliveries successful, POS data associated with deliveries in the digital schedule, etc.). In various embodiments, the demand characteristics are specific to particular time periods. For example, the demand characteristics may indicate a first level of demand during a first portion of a day and indicate a second level of demand during a second portion of a day.

At step 5730, system 100 may parse a database including a plurality of digital representations of drivers to identify a selection of drivers having the driver characteristics. For example, system 100 may parse the database to identify a driver having a cargo van large enough to satisfy a driver characteristic specifying a minimum cargo space. As another example, system 100 may parse the database to identify a driver that is available during a time period associated with the digital schedule.

At step 5740, system 100 may automatically assign the selection of drivers to the one or more shifts of the digital schedule according to the demand characteristics. For example, the demand characteristics may indicate that there will be a surge in demand around 10 AM requiring at least 10 drivers and system 100 may assign 10 drivers meeting the required driver characteristics and having availability during the 10 AM period.

At step 5750, system 100 may monitor completion of at least one shift of the one or more shifts to measure a key delivery parameter associated with each delivery within at least one shift. For example, system 100 may determine a delivery time (e.g., an amount of time it takes to deliver a package, etc.) for each delivery within a shift and may determine an average delivery time based on the delivery time for each delivery.

At step 5760, system 100 may monitor completion of at least one different shift having at least a partial different assignment of drivers to measure a second key delivery parameter of a same type as the key delivery parameter. For example, system 100 may A/B test the assignment of drivers by generating different schedule having at least a partial different assignment of drivers and may monitor completion of both schedules to determine which performed better based on the key delivery parameter (e.g., delivery time, etc.).

At step 5770, system 100 may compare the second key delivery parameter to the key delivery parameter to select one or more preferred demand characteristics. For example, system 100 may determine that a second schedule performed better than a first schedule during a first portion of the day and performed worse than the first schedule during a second portion of the day and may determine that the demand characteristics (e.g., number of drivers, makeup of fleet, types of vehicles, etc.) from the second schedule during the first portion of the day should be used in the future.

At step 5780, system 100 may update the machine learning model using the one or more preferred demand characteristics. In various embodiments, step 5780 includes executing an A/B test to analyze demand characteristics. For example, system 100 may generate two different schedules based on different demand predictions and may determine which schedule performs the best (e.g., based on key parameters such as delivery time, etc.) and my update the model to bias the model towards the more successful demand prediction for similar situations in the future. In various embodiments, executing the A/B test includes monitoring a key delivery parameter associated with completion of at least one other shift of a second digital schedule that is different than the first digital schedule. In various embodiments, step 5780 includes comparing the key delivery parameter associated with completion of the at least one other shift of the second digital schedule to the key delivery parameter associated with each delivery to select one or more preferred demand characteristic from the demand characteristics. In various embodiments, step 5780 includes updating the machine learning model using the one or more preferred demand characteristics.

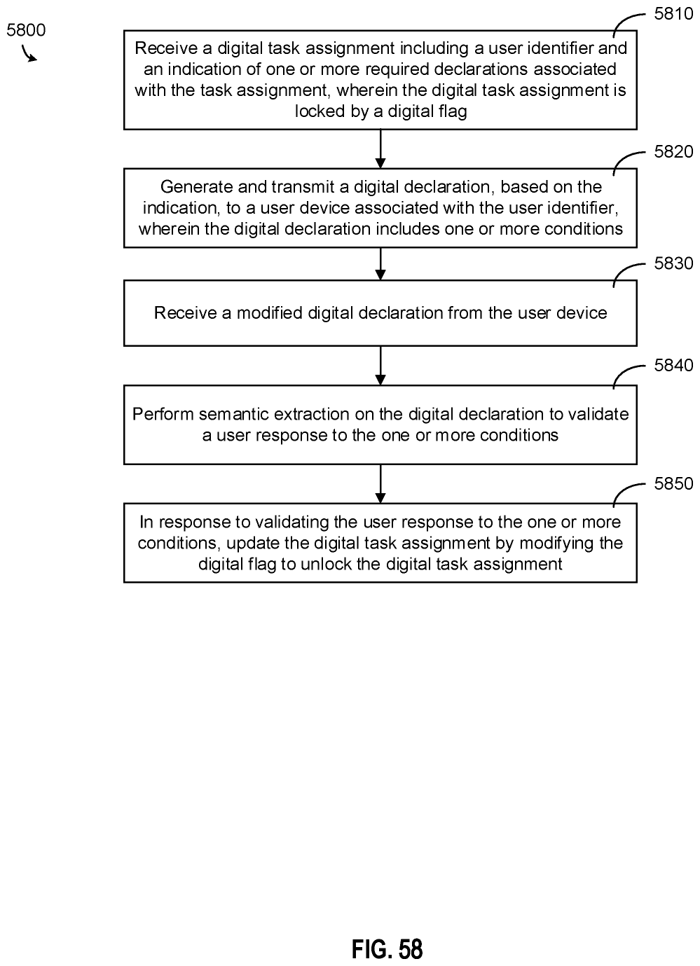

Turning now to FIG. 58, method 5800 for generating a digital declaration and unlocking a digital task is shown, according to an exemplary embodiment. In various embodiments, system 100 performs method 5800. At step 5810, system 100 may receive a digital task assignment including a user identifier and an indication of one or more required declarations associated with the task assignment. In various embodiments, the digital task assignment is locked by a digital flag. For example, system 100 may prevent a user from completing the digital task assignment until the required declarations have been reviewed and signed by the user. In some embodiments, the digital flag includes a metadata flag such as a binary value.

At step 5820, system 100 may generate and transmit a digital declaration, based on the indication, to a user device associated with the user identifier. In various embodiments, the digital declaration includes one or more conditions. For example, the digital declaration may include a requirement that a user uses a seatbelt while driving, a requirement that a user has a valid driver's license, and/or the like. In various embodiments, the user may review, sign, and/or document the one or more conditions using the user device. For example, the user may digital sign the digital declaration using the user device. In various embodiments, step 5820 includes causing the user device to display a GUI configured to display terms associated with the one or more conditions and/or facilitate a user to submit a user input associated with each of the one or more conditions (e.g., a signature, etc.).

At step 5830, system 100 may receive a modified digital declaration from the user device. For example, system 100 may receive a signed version of the digital declaration.

At step 5840, system 100 may analyze the digital declaration to validate a user response to the one or more conditions. For example, system 100 may perform semantic extraction on the digital declaration to verify a signature of the user. As another example, system 100 may receive sensor input (e.g., from a seatbelt sensor, etc.) and may validate a requirement to wear a seatbelt using the sensor input. In various embodiments, step 5840 includes comparing sensor measurements to a value associated with the one or more conditions to verify compliance with the one or more conditions. For example, system 100 may compare a binary seatbelt indicator value to a value associated with compliance of a seatbelt requirement to determine whether the user is in compliance with the seatbelt requirement. As another example, system 100 may compare a blood-alcohol-content (BAC) of a user from a breathalyzer to determine whether the BAC is in a range that indicates compliance with a BAC requirement. In various embodiments, step 5840 includes parsing the digital declaration to identify a digital signature associated with the one or more conditions and/or writing to a database to record the digital signature associated with the one or more conditions. For example, system 100 may generate a record including each worker's declarations and any digital task assignment associated with the declarations.

At step 5850, system 100 may update the digital task assignment by modifying the digital flag to unlock the digital task assignment. In various embodiments, step 5850 is performed in response to validating the user response to the one or more conditions. For example, system 100 may verify a user signature indicating the user's verification that they are using a seatbelt and may unlock a delivery task to allow the user to begin/complete the delivery task. In some embodiments, step 5850 includes updating a binary value. In some embodiments, system 100 is configured to update one or more other digital task assignments associated with the user and the one or more declarations based on the user's compliance with the one or more conditions. For example, a user may have ten delivery assignments having identical declaration requirements and system 100 may generate a digital declaration for all ten delivery assignments and may update all ten declarations and/or all ten delivery assignments (e.g., by unlocking the delivery assignments, etc.) based on a user submitting a single declaration that covers each of the ten declarations.

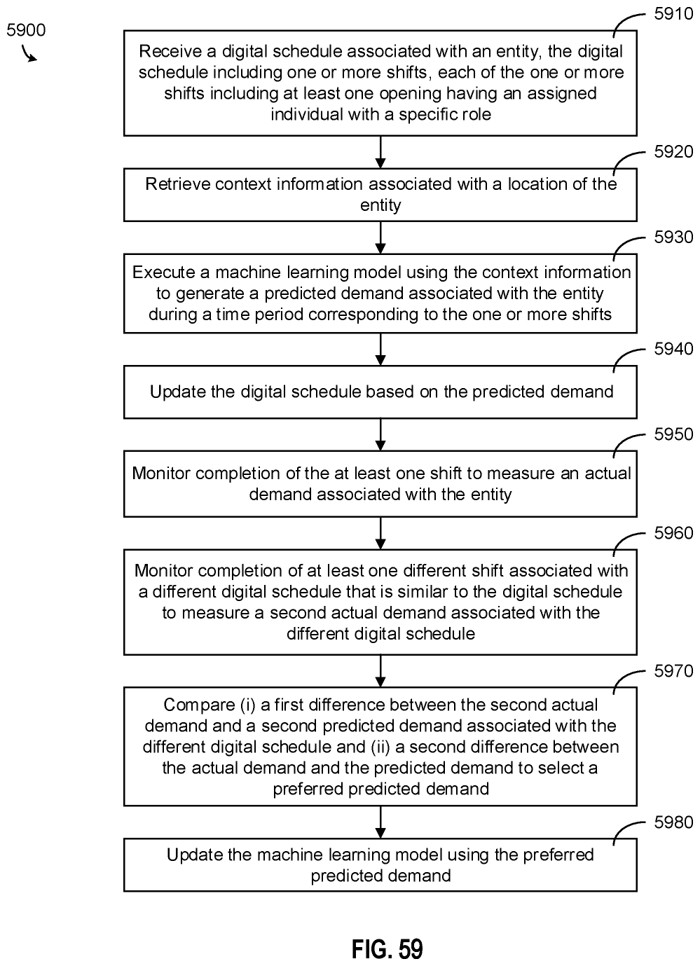

Turning now to FIG. 59, method 5900 for generating a digital schedule is shown, according to an exemplary embodiment. In various embodiments, system 100 performs method 5900. At step 5910, system 100 may receive a digital schedule associated with an entity. For example, the digital schedule may be a shift schedule for employees of a hardware store. In various embodiments, the digital schedule includes one or more shifts. Each of the one or more shifts may include at least one opening having an assigned individual with a specific role. For example, a first shift may include a first individual assigned a “stocker” role and a second individual assigned a “checkout clerk” role. In some embodiments, the digital schedule includes one or more open shifts having at least one opening that is unassigned (e.g., no worker has been slotted for that shift opening, etc.).

At step 5920, system 100 may retrieve context information associated with a location of the entity. For example, system 100 may retrieve POS data associated with a specific restaurant. In various embodiments, the context information is retrieved from a third party data source.

At step 5930, system 100 may execute a machine learning model using the context information to generate a predicted demand associated with the entity during a time period corresponding to the one or more shifts. For example, the machine learning model may generate an hour-by-hour demand prediction describing predicted demand for a hardware store based on context information such as POS data for nearby stores, traffic data in the area, weather data, and/or the like. In various embodiments, the predicted demand includes a number of worker hours required, a number of each specific type of role utilized by the entity, a total number of workers required, an amount of stock to have on hand, and/or the like. In various embodiments, the machine learning model is trained using historical data. For example, system 100 may train the machine learning model using historical context information associated with the entity. As another example, system 100 may train the machine learning model with historical POS data for a hardware store. The context information may include transportation data (e.g., DoT data, etc.), weather data, POS data, and/or the like. In various embodiments, system 100 retrieves the context information from a third party using an API.

At step 5940, system 100 may update the digital schedule based on the predicted demand. For example, if the predicted demand indicates that more workers will be needed than were originally included in the digital schedule, system 100 may update the digital schedule to add additional workers (e.g., specific to each role, etc.) to meet the increased demand. As another example, if the predicted demand indicates that fewer workers will be needed than were originally included in the digital schedule, system 100 may update the digital schedule to remove workers to meet the decreased demand. In various embodiments, step 5940 includes assigning an available individual to an unassigned opening according to a specific role associated with the unassigned opening and a skill-set of the available individual. For example, an unassigned opening may require an individual that is available from 10 AM to 2 PM on Saturday and is capable of lifting more than 50 lbs. and system 100 may assign an individual meeting these criteria.

In some embodiments, step 5940 includes generating an employee score for an individual based on weighting parameters of a skill-set of the individual based on characteristics of the specific role (e.g., must be able to lift 50 lbs., etc.). For example, system 100 may generate a weighted function (e.g., an employee score, etc.) based on the characteristics of the role and may execute the function using values associated with each characteristic corresponding to the individual based on the skill-set of the individual (e.g., a skill-set may indicate that a user is capable of lifting 120 lbs., etc.). In some embodiments, system 100 may compare the employee score from a plurality of individuals to determine which individual has the highest score. In various embodiments, system 100 may select the individual having the highest score to fill the unassigned opening.

At step 5950, system 100 may monitor completion of the at least one shift to measure an actual demand associated with the entity. For example, system 100 may monitor an average wait time associated with customers in line at checkout during the at least one shift to generate a measure of actual demand (e.g., as indicated by average wait time, etc.). As another example, system 100 may monitor scheduling requests for additional workers (e.g., as submitted manually by a manager, etc.) to determine whether additional workers were needed to complete the at least one shift beyond what was originally scheduled. In various embodiments, monitoring completion of the at least one shifts includes detecting additional workers added to the at least one shift by a user.

At step 5960, system 100 may monitor completion of at least one different shift associated with a different digital schedule that is similar to the digital schedule to measure a second actual demand associated with the different digital schedule. For example, system 100 may perform an A/B test by generating a first schedule and a second schedule based on different predicted demands (e.g., by scheduling a different amount of workers, etc.) and my monitor completion of the first and second schedule to determine which schedule more accurately matched the actual demand. In various embodiments, system 100 generates schedules to closely meet predicted demand without overstaffing an entity to avoid unnecessary human-resource expenses.

At step 5970, system 100 may compare a difference between the predicted demand and the actual demand in the schedules of the A/B test. For example, system 100 may compare (i) a first difference between the second actual demand and a second predicted demand associated with the different digital schedule and (ii) a second difference between the actual demand and the predicted demand to select a preferred predicted demand. In various embodiments, the preferred predicted demand includes one or more time periods. For example, a first schedule may perform better than a second schedule during a first time period and may perform worse than the second schedule during a second time period and the preferred predicted demand may select the predicted demand from the first schedule for the first time period and the predicted demand from the second schedule for the second time period.

At step 5980, system 100 may update the machine learning model using the preferred predicted demand. For example, system 100 may perform backpropagation on a neural network using the preferred predicted demand (e.g., for one or more time periods, etc.) to adjust weights within the neural network to improve a forecasting accuracy of the neural network. In various embodiments, step 5980 includes updating the machine learning model based on an A/B test. For example, system 100 may execute an A/B test to analyze the predicted demand generated by the machine learning model and system 100 may update the machine learning model based on whichever test configuration from the A/B test performed best. In various embodiments, executing the A/B test includes monitoring actual demand associated with a second predicted demand associated with a different time period corresponding to a different one or more shifts. For example, system 100 may perform an A/B test across shifts and may determine which shift featured the most accurate predicted demand. In some embodiments, performing the A/B test includes comparing an accuracy of a demand prediction associated with each test of the A/B test. For example, system 100 may compare (i) a first difference between (a) the actual demand corresponding to the different one or more shifts and (b) the second predicted demand to (ii) a second difference between (a) the actual demand corresponding to the completion of the at least one shift and (b) the predicted demand associated with the time period to select a preferred predicted demand. In various embodiments, system 100 updates the machine learning model based on the preferred predicted demand.

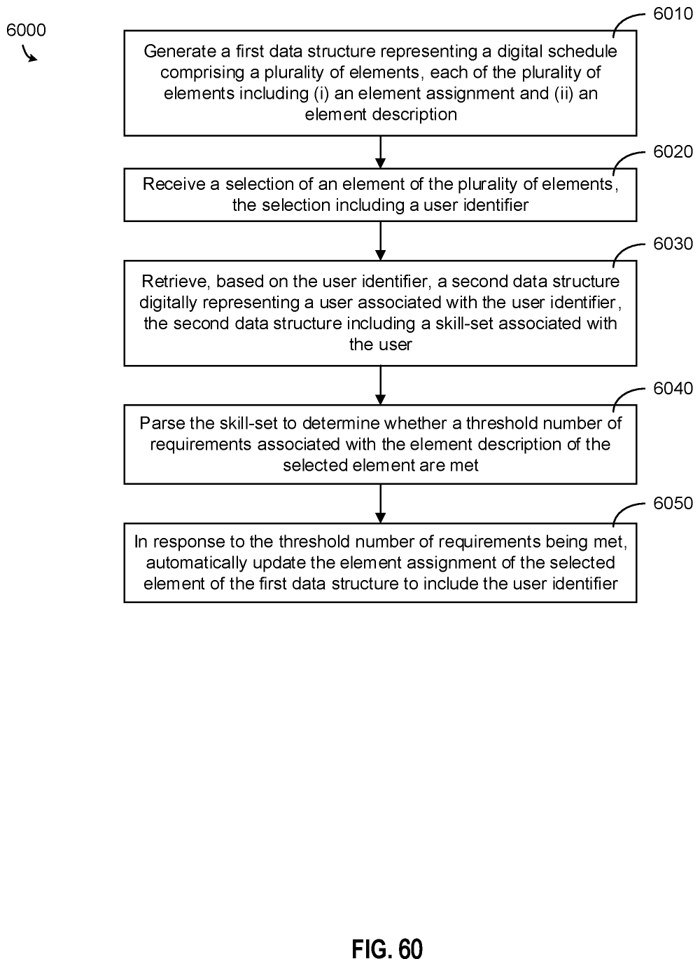

Turning now to FIG. 60, method 6000 for generating a digital schedule is shown, according to an exemplary embodiment. In various embodiments, system 100 performs method 6000. At step 6010, system 100 may generate a first data structure representing a digital schedule comprising a plurality of elements. In some embodiments, the first data structure includes a Gantt chart. In various embodiments, each of the plurality of elements includes (i) an element assignment and (ii) an element description. For example, each element may represent a shift opening for an employee and the element assignment may include an assigned employee, and the element description may include a time associated with the shift, the type of role the opening is for, specific requirements associated with the shift, and/or the like. In various embodiments, the element description includes a position type, a start time, an end time, and/or a date for the first shift. Additionally or alternatively, the element description may include a link to an external data source (e.g., a third party data structure, etc.) storing one or more requirements associated with a shift type of the selected element. In various embodiments, system 100 may retrieve the one or more requirements from the external data source using the link. In some embodiments, system 100 may monitor the external data source to detect a change in the one or more requirements associated with the shift type of the selected element. In various embodiments, in response to detecting a change, system 100 may transmit a notification to the user computer device (e.g., indicating the change, etc.).

At step 6020, system 100 may receive a selection of an element of the plurality of elements. For example, system 100 may receive, via a user device, a selection of a specific opening on the digital schedule. In various embodiments, the selection includes a user identifier. For example, a user may sign up for a specific opening in the schedule using a user device and the user device may transmit a user identifier of the user associated with the user device to system 100.

At step 6030, system 100 may retrieve, based on the user identifier, a second data structure digitally representing a user associated with the user identifier. For example, system 100 may query a human-resources database to retrieve information associated with the user. In various embodiments, the second data structure includes a skill-set associated with the user. For example, the skill-set may indicate that a user is skilled in particular software, has sales experience, and/or is capable of lifting heavy packages.

At step 6040, system 100 may parse the skill-set to determine whether a threshold number of requirements associated with the element description of the selected element are met. For example, system 100 identify that the selected element requires a user to be able to lift 100 lbs. and have sales experience and system 100 may determine whether the individual meets these criteria based on the skill-set associated with the individual. In various embodiments, step 6040 includes comparing a skill of the skill-set to each requirement of the number of requirements. In various embodiments, the threshold number of requirements includes a first subset of mandatory requirements and a second subset of optional requirements. For example, an opening in a shift may require that an individual be able to lift 100 lbs. and may indicate that user's with sales experience are preferred (but not required) for the opening. In various embodiments, determining whether the threshold number of requirements are met includes satisfying the first subset of mandatory requirements.

At step 6050, system 100 may automatically update the element assignment of the selected element of the first data structure to include the user identifier. For example, system 100 may assign the user to an opening in a schedule based on determining that the individual meets the criteria for the opening. In various embodiments, step 6050 is performed in response to determining that the threshold number of requirements are met. In various embodiments, updating the element assignment includes embedding a link to the second data structure in the selected element of the first data structure. For example, system 100 may embed a link to a user profile in an opening for a shift in the digital schedule. In some embodiments, step 6050 includes generating a digital flag associated with the selected element of the first data structure. For example, system 100 may generate a digital flag indicating that the assignment of the individual to the opening requires manager approval (e.g., is pending).

In various embodiments, system 100 may transmit to the user computing device a subset of the first data structure associated with the selected element. For example, system 100 may transmit a calendar placeholder to the user device. In various embodiments, system 100 transmits the subset of the first data structure in response to automatically updating the element assignment. For example, in response to a user signing up for an opening in the digital schedule, system 100 may transit a calendar reminder via at least one of text message, email, and/or push notification to the user (e.g., via the user device, etc.).

### Configuration of Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or movable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the assembly as shown in the various exemplary embodiments is illustrative only. Additionally, any element disclosed in one embodiment may be incorporated or utilized with any other embodiment disclosed herein. It should be appreciated that elements of the various embodiments may be incorporated or utilized with any of the other embodiments disclosed herein.

What is claimed is:

1. A method of generating a schedule for a company, the method comprising:
generating a first shift based on a first user input that defines one or more attributes of the first shift, wherein the first shift is an open shift that can be requested by a plurality of workers;
presenting, via a graphical user interface, the schedule for the company, the schedule including the first shift;
receiving, from a user device of a first worker of the plurality of workers, a request to claim the first shift;
automatically assigning the first shift to the first worker responsive to at least one attribute of a profile of the first worker matching the one or more attributes of the first shift; and
presenting, via the graphical user interface, a modified version of the schedule indicating that the first shift is assigned to the first worker.

2. The method of claim 1, wherein the one or more attributes of the first shift include a position type, a start time, an end time, and a date for the first shift.

3. The method of claim 1, wherein the one or more attributes of the first shift include a requirement for manager approval, the method further comprising:
transmitting, to a user device associated with a manager, an indication of the request; and
receiving, from the user device associated with the manager, an approval or a rejection of the request, wherein the first shift is automatically assigned to the first worker if the manager approves the request.

4. The method of claim 1, wherein the schedule comprises a plurality of additional shifts, the method further comprising:
receiving a second user input selecting the first shift or one of the plurality of additional shifts from the schedule and moving the selected first shift or the one of the plurality of additional shifts to an open time period on the schedule; and
dynamically updating the schedule based on the second user input.

5. The method of claim 1, further comprising:
receiving, from the user device of the first worker, a second user input defining alert preferences for the first worker, the alert preferences including at least a preference for receiving alerts when open shifts are published to the schedule; and
transmitting, to the user device of the first worker, an alert responsive to generating the first shift.

6. The method of claim 5, wherein transmitting the alert includes transmitting at least one of a text message, an email, or a push notification.

7. The method of claim 1, further comprising receiving a second user input defining an acceptance deadline for the first shift, the acceptance deadline indicating a period of time prior to a start time of the first shift where requests to claim the first shift are allowed.

8. The method of claim 1, wherein the first shift is visually differentiated on the graphical user interface from one or more additional shifts within the schedule.

9. The method of claim 8, wherein the first shift is presented within the schedule as a tile and wherein at least one of a color, a pattern, a shade, or a shape of the tile for the first shift is modified responsive to the first shift being assigned to the first worker.

10. The method of claim 1, further comprising:
receiving, from a user device associated with a second worker of the plurality of workers, a second request to claim the first shift; and
receiving, from a user device associated with a manager, a selection of one of the first worker or the second worker, wherein the first shift is assigned to the first worker or the second worker based on the selection.

11. One or more non-transitory computer-readable storage media having instructions stored thereon that, when executed by one or more processors, cause the one or more processors to:
receive a digital schedule associated with an entity, the digital schedule including one or more shifts, each of the one or more shifts including at least one opening having an assigned individual with a specific role;
retrieve, from one or more application programming interfaces (API), context information associated with a location of the entity;
execute a machine learning model using the context information to generate a predicted demand associated with the entity during a time period corresponding to the one or more shifts;
update the digital schedule based on the predicted demand, wherein updating the digital schedule includes (i) adding or deleting an opening associated with at least one shift of the one or more shifts and (ii) modifying the assigned individual associated with the opening based on (i) the specific role and (ii) a skill-set of an individual associated with the modification;
monitor completion of the at least one shift to measure an actual demand associated with the entity; and
update the machine learning model based on the actual demand.

12. The one or more non-transitory computer-readable storage media of claim 11, wherein updating the machine learning model includes:
executing an A/B test to analyze the predicted demand generated by the machine learning model, wherein executing the A/B test includes monitoring actual demand associated with a second predicted demand associated with a different time period corresponding to a different one or more shifts;
comparing (i) a first difference between (a) the actual demand corresponding to the different one or more shifts and (b) the second predicted demand to (ii) a second difference between (a) the actual demand corresponding to the completion of the at least one shift and (b) the predicted demand associated with the time period to select a preferred predicted demand; and
updating the machine learning model using the preferred predicted demand.

13. The one or more non-transitory computer-readable storage media of claim 11, wherein the digital schedule further includes one or more open shifts, each of the one or more open shifts including at least one opening that is unassigned.

14. The one or more non-transitory computer-readable storage media of claim 13, wherein updating the digital schedule includes assigning an available individual to the at least one opening that is unassigned according to a specific role associated with the at least one opening this is unassigned and a skill-set of the available individual.

15. The one or more non-transitory computer-readable storage media of claim 12, wherein monitoring completion of the at least one shift includes detecting additional workers added to the at least one shift by a user.

16. The one or more non-transitory computer-readable storage media of claim 12, wherein modifying the assigned individual associated with the opening includes:
generating an employee score for the individual associated with the modification based on weighting parameters of the skill-set using characteristics of the specific role;
comparing the employee score for the individual associated with the modification to a plurality of employee scores associated with other employees; and
selecting the individual associated with the modification for the opening based on the comparison.

17. The one or more non-transitory computer-readable storage media of claim 12, wherein the instructions further cause the one or more processors to train the machine learning model using historical context information associated with the entity, the historical context information including point-of-sale (POS) data from the entity.

18. The one or more non-transitory computer-readable storage media of claim 12, wherein the predicted demand includes a number of worker-hours associated with each of the one or more shifts and a role of a plurality of roles.

19. The one or more non-transitory computer-readable storage media of claim 12, wherein the context information includes at least one of (i) transportation data, (ii) weather data, or (iii) point-of-sale (POS) data from a third party.

20. The one or more non-transitory computer-readable storage media of claim 12, wherein updating the machine learning model includes performing backpropagation on a neural network.
